(19) United States
(12) Patent Application Publication
(10) Pub. No.: US 2026/0054364 A1
(43) Pub. Date: Feb. 26, 2026

(54) POWER TOOL

(71) Applicant: Nanjing Chervon Industry Co., Ltd., Nanjing (CN)

(72) Inventors: Zhongquan Xu, Nanjing (CN); Lunlun Zhang, Nanjing (CN); Xiangqing Fu, Nanjing (CN); Qian Xu, Nanjing (CN); Yanqing Xu, Nanjing (CN); Wenjing Lu, Nanjing (CN); Rong Wang, Nanjing (CN); Xuefeng Qiu, Nanjing (CN); Yi Zhang, Nanjing (CN); Tengyue Li, Nanjing (CN); Bing Liu, Nanjing (CN); Hailong Wang, Nanjing (CN); Yang Zhou, Nanjing (CN); Hao Gao, Nanjing (CN)

(21) Appl. No.: 19/373,916

(22) Filed: Oct. 30, 2025

Related U.S. Application Data
(63) Continuation-in-part of application No. 19/022,126, filed on Jan. 15, 2025.
Application No. 19/022,126 is a continuation of application No. PCT/CN2023/116382, filed on Sep. 1, 2023.
Application No. PCT/CN2023/116382 is a continuation of application No. PCT/CN2024/113909, filed on Aug. 22, 2024.

(30) Foreign Application Priority Data
Sep. 21, 2022 (CN) 202211146803.9
Jul. 14, 2023 (CN) 202310868955.8
Jul. 14, 2023 (CN) 202310871018.8
Jul. 14, 2023 (CN) 202321854207.6
Jul. 14, 2023 (CN) 202321870645.1
Sep. 1, 2023 (CN) 202311129086.3
Dec. 25, 2023 (CN) 202311803786.6
Dec. 25, 2023 (CN) 202311809661.4
Aug. 16, 2024 (CN) 202411126105.1
Aug. 16, 2024 (CN) 202411126175.7
Aug. 16, 2024 (CN) 202411132432.8
Aug. 16, 2024 (CN) 202421987031.6
Aug. 16, 2024 (CN) 202422000293.5
Aug. 16, 2024 (CN) 202422000835.9
Nov. 1, 2024 (CN) 202411553974.2
Nov. 1, 2024 (CN) 202411556544.6
Nov. 1, 2024 (CN) 202411556771.9
Nov. 1, 2024 (CN) 202422667676.8

(51) Int. Cl. B25F 5/00; H02K 7/00; H02K 11/33

(52) U.S. Cl. CPC B25F 5/001; H02K 7/003; H02K 11/33; B25F 5/008

(57) ABSTRACT

A power tool includes an electric motor assembly disposed at least partially in a housing and including a first electric motor, a second electric motor, and a connector, where limit values of efficiency of the electric motor assembly constitute a total efficiency interval, and efficiency values of the electric motor assembly greater than or equal to 70% constitute a first efficiency interval, where the ratio of the first efficiency interval to the total efficiency interval is greater than or equal to 0.5.

### RELATED APPLICATION INFORMATION

This application is a continuation-in-part of U.S. application Ser. No. 19/022,126, filed Jan. 15, 2025, which application is a continuation of International Application Number PCT/CN2023/116382, filed on Sep. 1, 2023, through which this application also claims the benefit under 35 U.S.C. § 119 (a) of Chinese Patent Application No. 202211146803.9, filed on Sep. 21, 2022, Chinese Patent Application No. 202310871018.8, filed on Jul. 14, 2023, Chinese Patent Application No. 202321854207.6, filed on Jul. 14, 2023, Chinese Patent Application No. 202321870645.1, filed on Jul. 14, 2023, and Chinese Patent Application No. 202310868955.8, filed Jul. 14, 2023, which applications are incorporated herein by reference in their entireties.

Through U.S. application Ser. No. 19/022,126, this application also claims the benefit of International Application Number PCT/CN2024/113909, filed on Aug. 22, 2024, through which this application also claims the benefit under 35 U.S.C. § 119 (a) of Chinese Patent Application No. 202311129086.3, filed on Sep. 1, 2023, Chinese Patent Application No. 202311809661.4, filed on Dec. 25, 2023, Chinese Patent Application No. 202311803786.6, filed on Dec. 25, 2023, Chinese Patent Application No. 202422000835.9, filed on Aug. 16, 2024, Chinese Patent Application No. 202421987031.6, filed on Aug. 16, 2024, Chinese Patent Application No. 202411126105.1, filed on Aug. 16, 2024, Chinese Patent Application No. 202411132432.8, filed on Aug. 16, 2024, Chinese Patent Application No. 202422000293.5, filed on Aug. 16, 2024, and Chinese Patent Application No. 202411126175.7, filed on Aug. 16, 2024, which applications are incorporated herein by reference in their entireties.

Through U.S. application Ser. No. 19/022,126, this application also claims the benefit of Chinese Patent Application No. 202411556771.9, filed on Nov. 1, 2024, Chinese Patent Application No. 202411553974.2, filed on Nov. 1, 2024, Chinese Patent Application No. 202411556544.6, filed on Nov. 1, 2024, and Chinese Patent Application No. 202422667676.8, filed on Nov. 1, 2024.

Each of these applications is incorporated herein by reference in its entirety.

### TECHNICAL FIELD

The present application relates to a power tool.

### BACKGROUND

When a power tool in the related art is working, an output mechanism can usually work under a light load condition and a heavy load condition. In order that the power tool can output relatively large torque to adapt to the heavy load condition, the power tool is usually provided with an electric motor with very large power and output torque. The electric motor with large power can drive the output mechanism to drive a relatively large load. However, when the power tool is under the light load condition, the electric motor with large power has a relatively large power consumption, causing a serious waste. Therefore, under the light load condition, the electric motor has a degraded working state, affecting a service life of the power tool.

This part provides background information related to the present application, and the background information is not necessarily the existing art.

### SUMMARY

In a first aspect, an example of the present application provides a power tool. The power tool includes a housing; an output mechanism for driving a function element that implements a set function; and an electric motor assembly disposed at least partially in the housing and including a first electric motor for outputting first torque and a first rotational speed; a second electric motor for outputting second torque and a second rotational speed; and a connector selectively allowing power transmission between the first electric motor and the second electric motor so that the electric motor assembly switches between multiple working states. The output mechanism is connected to at least one of the first electric motor, the second electric motor, and the connector. Limit values of efficiency of the electric motor assembly constitute a total efficiency interval, and efficiency values of the electric motor assembly greater than or equal to 70% constitute a first efficiency interval, where the ratio of the first efficiency interval to the total efficiency interval is greater than or equal to 0.5.

In some examples, efficiency values of the electric motor assembly greater than or equal to 50% constitute a second efficiency interval, and the ratio of the first efficiency interval to the second efficiency interval is greater than or equal to 0.4.

In some examples, the connector includes a one-way transmission assembly, the one-way transmission assembly connects two of the output mechanism, the first electric motor, and the second electric motor, the one-way transmission assembly allows the first electric motor and/or the second electric motor to drive the output mechanism, and the one-way transmission assembly prevents the output mechanism from driving the first electric motor or the second electric motor.

In some examples, the connector includes a clutch assembly, the clutch assembly includes a driving member formed on or connected to one of the first electric motor and the second electric motor and a driven member formed on or connected to the other of the first electric motor and the second electric motor, and the driving member is selectively connected to the driven member.

In some examples, the connector includes a clutch assembly, the clutch assembly includes a first clutch connected to one of the first electric motor and the second electric motor and a second clutch connected to the other of the first electric motor and the second electric motor, and the first clutch is selectively connected to the second clutch.

In some examples, the connector includes a differential assembly that allows the first electric motor and the second electric motor to simultaneously output power to the output mechanism at different rotational speeds.

In some examples, a transmission assembly for connecting the electric motor assembly to the output mechanism is further included.

In some examples, a controller is further included, which is configured to control the ratio of output torque of the first electric motor to output torque of the second electric motor according to a first set parameter.

In some examples, a detection mechanism is further included, which is configured to detect the first set parameter, where the first set parameter includes a load parameter of the output mechanism.

In a second aspect, an example of the present application provides a power tool. The power tool includes a housing; an output mechanism for driving a function element that implements a set function; and an electric motor assembly disposed at least partially in the housing and including a first electric motor for outputting first torque and a first rotational speed; a second electric motor for outputting second torque and a second rotational speed; and a connector selectively allowing power transmission between the first electric motor and the second electric motor. The output mechanism is connected to at least one of the first electric motor, the second electric motor, and the connector. When output torque of the first electric motor is greater than or equal to a first torque value and less than or equal to a fourth torque value, working efficiency of the first electric motor is greater than or equal to 70%. When output torque of the second electric motor is greater than or equal to a fifth torque value and less than or equal to an eighth torque value, working efficiency of the second electric motor is greater than or equal to 70%. The first torque value is less than the fifth torque value and the fourth torque value is less than the eighth torque value. When output torque of the electric motor assembly is greater than or equal to the first torque value and less than or equal to the eighth torque value, working efficiency of the electric motor assembly is greater than or equal to 70%.

In some examples, when the output torque of the first electric motor is greater than or equal to a second torque value and less than or equal to a third torque value, the working efficiency of the first electric motor is greater than or equal to 75%; when the output torque of the second electric motor is greater than or equal to a sixth torque value and less than or equal to a seventh torque value, the working efficiency of the second electric motor is greater than or equal to 75%; the second torque value is less than the sixth torque value and the third torque value is less than the seventh torque value; and when the output torque of the electric motor assembly is greater than or equal to the second torque value and less than or equal to the seventh torque value, the working efficiency of the electric motor assembly is greater than or equal to 75%.

In a third aspect, an example of the present application provides a power tool. The power tool includes a housing; an output mechanism for driving a function element that implements a set function; and an electric motor assembly disposed at least partially in the housing and including a first electric motor for outputting first torque and a first rotational speed; a second electric motor for outputting second torque and a second rotational speed; and a connector selectively allowing power transmission between the first electric motor and the second electric motor. The output mechanism is connected to at least one of the first electric motor, the second electric motor, and the connector. When working efficiency of the first electric motor is greater than or equal to 70%, output torque of the first electric motor is within a first output torque interval. When working efficiency of the second electric motor is greater than or equal to 70%, output torque of the second electric motor is within a second output torque interval. When working efficiency of the electric motor assembly is greater than or equal to 70%, output torque of the electric motor assembly is within a third output torque interval, where the third output torque interval covers at least the first output torque interval and the second output torque interval.

In a fourth aspect, an example of the present application provides a power tool. The power tool includes a housing; an output mechanism for driving a function element that implements a set function; a power supply mounting portion for mounting a direct current power supply; and an electric motor assembly disposed at least partially in the housing and including a first electric motor for outputting first torque and a first rotational speed and driving the output mechanism; and a second electric motor for outputting second torque and a second rotational speed and driving the output mechanism. The direct current power supply supplies power to the first electric motor and the second electric motor; and the nominal voltage of the power tool is greater than or equal to 18 V.

In some examples, the first electric motor and the second electric motor are each a brushless motor.

In some examples, the direct current power supply includes a battery pack.

In some examples, the battery pack supplies power to various power tools.

In some examples, the nominal voltage of the power tool is greater than or equal to 18 V and less than or equal to 56 V.

In some examples, the nominal voltage of the power tool is greater than 56 V and less than or equal to 120 V.

In some examples, the power supply mounting portion is disposed at least partially on the housing.

In a fifth aspect, an example of the present application provides a power tool. The power tool includes a housing; an output mechanism for driving a function element that implements a set function, where the output mechanism is disposed at least partially in the housing; a power supply mounting portion for mounting a direct current power supply; and an electric motor assembly used for driving the output mechanism and including a first electric motor for outputting first torque and a first rotational speed and a second electric motor for outputting second torque and a second rotational speed, where the first electric motor and the second electric motor are configured to have at least one different structural parameter.

In some examples, the first electric motor and the second electric motor have different outer diameters.

In some examples, the ratio of the outer diameter of the first electric motor to the outer diameter of the second electric motor is greater than or equal to 0.4.

In some examples, the first electric motor and the second electric motor have different stack lengths.

In some examples, the ratio of the stack length of the first electric motor to the stack length of the second electric motor is greater than or equal to 0.3.

In some examples, the structural parameter includes the outer diameter of a stator core, the inner diameter of the stator core, the outer diameter of a rotor core, the inner diameter of the rotor core, the thickness of a rotor pole, the thickness of a stator pole, the length of an air gap, the length of a core, the number of pairs of stator poles, an arc corresponding to the stator pole, the number of pairs of rotor poles, and an arc corresponding to the rotor pole.

In a sixth aspect, an example of the present application provides a power tool. The power tool includes a housing; an output mechanism for driving a function element that implements a set function; an electric motor assembly disposed at least partially in the housing and including a first electric motor for outputting first torque and a first rotational speed, a second electric motor for outputting second torque and a second rotational speed, and a connector selectively allowing power transmission between the first electric motor and the second electric motor, where the output mechanism is connected to at least one of the first electric motor, the second electric motor, and the connector; a power supply for supplying power to the first electric motor and the second electric motor; and a controller for controlling the electric motor assembly. The controller is configured to determine, according to a load parameter of the output mechanism and a load distribution coefficient of the electric motor assembly, at least one of an output parameter value of the first electric motor and an output parameter value of the second electric motor or the ratio of an output parameter of the first electric motor to an output parameter of the second electric motor.

In some examples, a detection assembly is further included, which is configured to detect the load parameter of the output mechanism.

In some examples, a required parameter of the electric motor assembly is determined according to the load parameter of the output mechanism, where the required parameter includes at least one of required torque, a required rotational speed, and required power.

In some examples, the output parameter includes at least one of output torque, an output rotational speed, and output power.

In some examples, the load distribution coefficient enables total efficiency of the electric motor assembly to be greater than or equal to efficiency of the first electric motor or the second electric motor in response to the same load of the output mechanism.

In some examples, the load distribution coefficient enables the ratio of an efficiency interval of the electric motor assembly greater than or equal to 70% to a total efficiency interval of the electric motor assembly to be greater than or equal to 0.5.

In some examples, the controller is configured to, when both the first electric motor and the second electric motor are started, control one of the first electric motor and the second electric motor through a first parameter set and control the other of the first electric motor and the second electric motor through a second parameter set, where the first parameter set and the second parameter set have at least one different parameter.

In some examples, the controller is configured to, when determining that both the first electric motor and the second electric motor are started and a required parameter of the electric motor assembly is less than a second preset value, switch the electric motor assembly to startup of the first electric motor or the second electric motor.

In some examples, the controller is configured to, when determining that the first electric motor or the second electric motor in the electric motor assembly is started and a required parameter of the electric motor assembly is greater than a first preset value, switch the electric motor assembly to startup of both the first electric motor and the second electric motor.

In a seventh aspect, an example of the present application provides a power tool. The power tool includes a housing; an output mechanism for driving a function element that implements a set function; an electric motor assembly disposed at least partially in the housing and including a first electric motor for outputting first torque and a first rotational speed, a second electric motor for outputting second torque and a second rotational speed, and a connector selectively allowing power transmission between the first electric motor and the second electric motor, where the output mechanism is connected to at least one of the first electric motor, the second electric motor, and the connector; a power supply for supplying power to the first electric motor and the second electric motor; and a controller for controlling the electric motor assembly. The controller is configured to configure an output parameter of the first electric motor and an output parameter of the second electric motor according to a load parameter of the output mechanism such that the ratio of an efficiency interval of the electric motor assembly greater than or equal to 70% to a total efficiency interval of the electric motor assembly is greater than or equal to 0.5.

In an eighth aspect, an example of the present application provides a power tool. The power tool includes a housing; an output mechanism for driving a function element that implements a set function; an electric motor disposed at least partially in the housing and including a rotor assembly formed with or connected to a rotor shaft rotating around a first axis and a stator assembly disposed coaxially with the rotor assembly and including a first stator and a second stator; and a controller electrically connected to the first stator and the second stator and used for controlling the electric motor. The controller is configured to make the first stator energized and the second stator de-energized so that the electric motor is in a first working state; make the first stator de-energized and the second stator energized so that the electric motor is in a second working state; and make the first stator energized and the second stator energized so that the electric motor is in a third working state. Limit values of efficiency of the electric motor in all working states constitute a total efficiency interval, and efficiency values of the electric motor greater than or equal to 70% constitute a first efficiency interval, where the ratio of the first efficiency interval to the total efficiency interval is greater than or equal to 0.5.

In some examples, the stator assembly is disposed with the first axis as a central axis.

In some examples, the first stator and the second stator are coaxially sleeved.

In some examples, the first stator and the second stator are coaxially arranged along a direction of the first axis.

In some examples, the first stator and the second stator are spaced apart along a direction of the first axis.

In some examples, output torque of the electric motor in the third working state is greater than output torque of the electric motor in the first working state, and the output torque of the electric motor in the third working state is greater than output torque of the electric motor in the second working state.

In some examples, the rotor assembly includes a first rotor and a second rotor, the first rotor mates with the first stator, the second rotor mates with the second stator, and the second rotor is formed with or connected to the first rotor.

A power tool includes a housing; an output mechanism for driving a function element that implements a set function; and an electric motor disposed at least partially in the housing and including a rotor assembly and a stator assembly including a first stator and a second stator. The first stator and the second stator are arranged along an axial direction.

In some examples, the rotor assembly is formed with or connected to a rotor shaft rotating around a first axis; and the stator assembly and the rotor assembly are each arranged with the first axis as a central axis.

In some examples, the electric motor further includes a controller electrically connected to the first stator and the second stator and used for controlling the electric motor, where the controller is configured to make the first stator energized and the second stator de-energized so that the electric motor is in a first working state; make the first stator de-energized and the second stator energized so that the electric motor is in a second working state; and make the first stator energized and the second stator energized so that the electric motor is in a third working state.

In a ninth aspect, an example of the present application provides a power tool. The power tool includes a housing; an output mechanism for driving a function element that implements a set function; a power supply mounting portion disposed at least partially on the housing and used for mounting a direct current power supply; and an electric motor disposed at least partially in the housing. The electric motor includes a rotor rotating around a first axis; and a stator including a ring yoke portion and multiple tooth portions formed on or connected to the ring yoke portion; first windings wound around the multiple tooth portions and configured to generate a first magnetic field; and second windings wound around the multiple tooth portions and configured to generate a second magnetic field. The power supply selectively supplies power to the first windings and the second windings. A first winding and a second winding are arranged along a radial direction of the first axis.

In some examples, the direct current power supply includes at least one battery pack.

In some examples, the nominal voltage of the power tool is greater than or equal to 18 V.

In some examples, the nominal voltage of the power tool is greater than or equal to 36 V and less than or equal to 56 V.

In some examples, the nominal voltage of the power tool is greater than 56 V and less than or equal to 120 V.

In some examples, the electric motor further includes a controller electrically connected to the first windings and the second windings and controlling energized states of the first windings and the second windings. The controller is configured to make the first windings energized and the second windings de-energized so that the electric motor is in a first working state; make the first windings de-energized and the second windings energized so that the electric motor is in a second working state; and make the first windings energized and the second windings energized so that the electric motor is in a third working state.

In some examples, the electric motor further includes a detection assembly for detecting energized and de-energized states of the first windings and the second windings.

In some examples, the number of turns of the first winding is different from the number of turns of the second winding.

In some examples, the wire diameter of the first winding is different from the wire diameter of the second winding.

In some examples, the multiple tooth portions protrude from the inner side of the ring yoke portion.

In some examples, a power tool comprises: an output shaft configured to output torque and rotating about an output axis; a first electric motor comprising a first drive shaft rotating about a first axis; a second electric motor comprising a second drive shaft rotating about a second axis, wherein the first drive shaft and the second drive shaft are arranged along a radial direction of the first drive shaft; a power transmission mechanism for transmitting power of at least one of the first electric motor and the second electric motor to the output shaft, wherein torque of the first drive shaft and torque of the second drive shaft are outputted through the output shaft; and a body housing comprising an accommodation housing configured to accommodate the first electric motor and the second electric motor. When orthographic projections are observed along an extension direction of the output shaft, along a direction of a line connecting an orthographic projection of the first axis and an orthographic projection of the second axis, an outer dimension Lc of the accommodation housing is greater than an outer diameter dimension D of any one of the first electric motor and the second electric motor. The body housing further comprises a first marker structure corresponding to the first electric motor and a second marker structure corresponding to the second electric motor, wherein the first marker structure is configured to indicate that the power tool is provided with the first electric motor, and the second marker structure is configured to indicate that the power tool is provided with the second electric motor.

In some examples, the first drive shaft is parallel to the second drive shaft.

In some examples, the first electric motor at least partially overlaps the second electric motor in the direction of the output axis.

In some examples, the accommodation housing comprises a first accommodation portion for accommodating the first electric motor and a second accommodation portion for accommodating the second electric motor, wherein the first accommodation portion supports at least a first bearing portion on a side of the first electric motor facing away from the output shaft, and the second accommodation portion supports at least a second bearing portion on a side of the second electric motor facing away from the output shaft.

In some examples, the power tool further comprises: a first housing, wherein the accommodation housing is formed on or connected to the first housing, and the first housing is formed with or connected to a grip for holding; and a guard assembly configured to accommodate at least part of a cutting part driven by the output shaft, wherein the guard assembly and the accommodation housing are basically located on two sides of the first housing.

In some examples, the power transmission mechanism is accommodated in the first housing and is located outside the accommodation housing.

In some examples, the power tool further comprises: a direct current power supply for supplying power to the first electric motor and the second electric motor, wherein a nominal voltage of the direct current power supply is greater than or equal to 18 V.

In some examples, the direct current power supply comprises at least one battery pack.

In some examples, the first electric motor comprises a first stator, a first rotor, and coil windings disposed on the first stator, and the first drive shaft is formed on or connected to the first rotor; the second electric motor comprises a second stator, a second rotor, and coil windings disposed on the second stator, and the second drive shaft is formed on or connected to the second rotor.

In some examples, the first electric motor and the second electric motor are configured to be different in at least one first parameter, wherein the at least one first parameter comprises a maximum output rotational speed, maximum output torque, an outer diameter of a stator core, an inner diameter of the stator core, an outer diameter of a rotor core, an inner diameter of the rotor core, a thickness of a rotor pole, a thickness of a stator pole, a length of an air gap, a length of a core, a number of pairs of stator poles, an arc corresponding to the stator pole, a number of pairs of rotor poles, and an arc corresponding to the rotor pole.

In some examples, the first marker structure and the second marker structure are formed on or connected to an outer wall surface of the body housing.

In some examples, the first marker structure and the second marker structure are configured to be independent double-cylinder structures.

In some examples, the first marker structure comprises a first display portion, the second marker structure comprises a second display portion, and the first display portion and the second display portion are disposed at easily visible positions on the body housing, respectively.

In some examples, the first display portion comprises a light emitter, and the light emitter indicates at least an on state and an off state of the first electric motor.

In some examples, the first display portion comprises an icon representing the first electric motor, the second display portion comprises an icon representing the second electric motor, and the first display portion and the second display portion are each provided with an adhesive backing layer.

In some examples, a power tool comprises: an output shaft configured to output torque and rotating about an output axis; a first electric motor comprising a first drive shaft rotating about a first axis; a second electric motor comprising a second drive shaft rotating about a second axis, wherein the first drive shaft and the second drive shaft are arranged along a radial direction of the first drive shaft; a power transmission mechanism for transmitting power of at least one of the first electric motor and the second electric motor to the output shaft, wherein torque of the first drive shaft and torque of the second drive shaft are outputted through the output shaft; and an accommodation housing configured to accommodate the first electric motor and the second electric motor, wherein when orthographic projections are observed along an extension direction of the output shaft, along a direction of a line connecting an orthographic projection of the first axis and an orthographic projection of the second axis, a ratio of an outer dimension Lc of the accommodation housing to an outer diameter dimension D of any one of the first electric motor and the second electric motor is greater than or equal to 1.1.

In some examples, a power tool comprises: an output shaft configured to output torque and rotating about an output axis; a first electric motor comprising a first drive shaft rotating about a first axis; a second electric motor comprising a second drive shaft rotating about a second axis, wherein the first drive shaft and the second drive shaft are arranged along a radial direction of the first drive shaft; a power transmission mechanism for transmitting power of at least one of the first electric motor and the second electric motor to the output shaft, wherein torque of the first drive shaft and torque of the second drive shaft are outputted through the output shaft; and a body housing comprising an accommodation housing configured to accommodate the first electric motor and the second electric motor. The body housing comprises a first marker structure corresponding to the first electric motor and a second marker structure corresponding to the second electric motor, wherein the first marker structure and the second marker structure are formed on or connected to an outer wall surface of the body housing, the first marker structure is configured to indicate that the power tool is provided with the first electric motor, and the second marker structure is configured to indicate that the power tool is provided with the second electric motor.

In some examples, the first marker structure and the second marker structure are disposed on an outer wall of the accommodation housing configured to accommodate the first electric motor and the second electric motor, the first marker structure is configured to comprise a shape similar to a partial outline of the first electric motor, and the second marker structure is configured to comprise a shape similar to a partial outline of the second electric motor.

In some examples, the first marker structure comprises a display screen, and the display screen indicates an operation state of the first electric motor.

In some examples, the second marker structure comprises at least one of a light emitter or a display screen configured to indicate an operation state of the second electric motor.

In an example, a power tool comprises: an output shaft configured to output torque and rotating about an output axis; a first electric motor comprising a first drive shaft rotating about a first axis; a second electric motor comprising a second drive shaft rotating about a second axis; and a power transmission mechanism for transmitting power of at least one of the first electric motor and the second electric motor to the output shaft, wherein torque of the first drive shaft and torque of the second drive shaft are outputted through the output shaft. The power transmission mechanism comprises: a transmission assembly disposed between the output shaft and at least one of the first electric motor and the second electric motor, wherein the transmission assembly comprises at least a deceleration mechanism; and a clutch assembly disposed between the first electric motor and the second electric motor, wherein the clutch assembly is configured to allow or not allow at least one of the first drive shaft or the second drive shaft to drive the output shaft under a preset condition.

In some examples, the transmission assembly is configured to connect at least one of the first drive shaft and the second drive shaft to the clutch assembly.

In some examples, the transmission assembly comprises a first gearset for connecting the first electric motor to the output shaft, and the first gearset provides at least one reduction ratio.

In some examples, the transmission assembly comprises a second gearset for connecting the second electric motor to the output shaft, and the second gearset provides at least one reduction ratio.

In some examples, the clutch assembly comprises a one-way transmission member, wherein the one-way transmission member is operable to connect rotation of the first electric motor to rotation of the second electric motor in a first direction of rotation and disconnect the rotation of the first electric motor from the rotation of the second electric motor in a second direction of rotation.

In some examples, the clutch assembly connects the second gearset to the output shaft.

In some examples, the clutch assembly comprises a third gear, the first gearset comprises a first driven gear, the third gear meshes with the first driven gear, and a gear ratio of the third gear and the first driven gear is basically 1.

In some examples, the clutch assembly comprises an idler shaft that rotates about a clutch axis, the second gearset comprises a second driven gear disposed on the idler shaft, and when a rotational speed of the idler shaft is greater than a rotational speed of the output shaft, the clutch assembly drives the output shaft to rotate at the rotational speed of the idler shaft.

In some examples, a non-thrust bearing is disposed at a first end of the idler shaft, and an elastic member is disposed at an end of the non-thrust bearing.

In some examples, at least one of the first gearset and the second gearset comprises a helical gear.

In an example, a power tool comprises: an output shaft configured to output torque and rotating about an output axis; a first electric motor comprising a first drive shaft rotating about a first axis; a second electric motor comprising a second drive shaft rotating about a second axis; and a power transmission mechanism for transmitting power of at least one of the first electric motor and the second electric motor to the output shaft, wherein torque of the first drive shaft and torque of the second drive shaft are outputted through the output shaft. The power transmission mechanism comprises: a transmission assembly disposed between the output shaft and at least one of the first electric motor and the second electric motor, wherein the transmission assembly comprises at least a deceleration mechanism. When following orthographic projections are observed along an extension direction of the output shaft, a projection of the first axis and a projection of the second axis are located above a projection of the output axis.

In some examples, when the following orthographic projections are observed along a direction of the output axis, an included angle α between a line connecting the projection of the first axis and the projection of the output axis and a line connecting the projection of the second axis and the projection of the output axis is greater than or equal to 45° and less than or equal to 180°.

In an example, a cutting tool comprises: an output shaft on which a cutting part is mounted, wherein the cutting part rotates about an output axis; an electric motor assembly, wherein the electric motor assembly comprises a first electric motor comprising a first drive shaft rotating about a first axis and a second electric motor comprising a second drive shaft rotating about a second axis; and a first fan supported by at least one of the first drive shaft, the second drive shaft, and the output shaft; a power transmission mechanism for transmitting power of at least one of the first electric motor and the second electric motor in the electric motor assembly to the output shaft; a body housing for accommodating the electric motor assembly and the power transmission mechanism, wherein an airflow port is formed on the body housing; and a control circuit board comprising a controller configured to control the electric motor assembly, wherein the control circuit board is disposed in the body housing. When the first fan rotates, a heat dissipation air path is generated, and the heat dissipation air path flows through at least the control circuit board and the electric motor assembly.

In some examples, the first fan is supported by the first drive shaft and driven by the first electric motor to rotate and generate cooling airflow. The cutting tool further comprises a second fan supported by the second drive shaft and driven by the second electric motor to rotate and generate cooling airflow, wherein when the second fan rotates, a heat dissipation air path is generated, and the heat dissipation air path flows through at least the control circuit board and the electric motor assembly.

In some examples, the airflow port comprises a first air inlet and a first air outlet, and the cooling airflow enters the body housing from the first air inlet and flows out of the body housing from the first air outlet.

In some examples, the airflow port further comprises a second air outlet, the cooling airflow flows out of the body housing from at least one of the first air outlet and the second air outlet, and the first air outlet and the second air outlet have different air discharge directions.

In some examples, the body housing comprises a first housing and an accommodation housing, wherein the first housing is formed with or connected to the accommodation housing, the accommodation housing is configured to accommodate the first electric motor and the second electric motor, the control circuit board is disposed in the first housing, and the first air inlet allows the cooling airflow to enter the accommodation housing from the first housing.

In some examples, the first air outlet connects the accommodation housing with the first housing.

In some examples, the cutting tool further comprises a base plate movably connected to the body housing, wherein the base plate is formed with a base plate bottom surface in contact with a workpiece, and the second air outlet is disposed on the base plate and discharges air toward a side of the base plate.

In some examples, the heat dissipation air path comprises a first heat dissipation air path and a second heat dissipation air path, wherein the first heat dissipation air path is configured such that when at least one of the first electric motor or the second electric motor is operating, the cooling airflow enters from the first air inlet and flows through the control circuit board and the electric motor assembly, and then most of the cooling airflow flows out from the first air outlet; and the second heat dissipation air path is configured such that when at least one of the first electric motor or the second electric motor is operating, the cooling airflow enters from the first air inlet and flows through the control circuit board and the electric motor assembly, and then most of the cooling airflow flows out from the second air outlet.

In some examples, the cutting tool further comprises a circuit board housing configured to accommodate the control circuit board, wherein the circuit board housing comprises a heat dissipation plate connected to the control circuit board and capable of transferring heat generated by the control circuit board, and the circuit board housing is disposed outside the electric motor assembly in a radial direction of the electric motor assembly.

In some examples, the cutting tool further comprises a fixed guard configured to at least partially surround the cutting part, wherein an extension direction of the control circuit board is parallel to an extension direction of the cutting part, and the control circuit board conducts heat with the fixed guard.

In some examples, at least one control circuit board is provided, and the circuit board housing is capable of accommodating the at least one control circuit board.

In some examples, the cutting tool further comprises a power supply, wherein the power supply comprises at least one battery pack configured to provide a source of energy for the electric motor assembly, the at least one battery pack is disposed between the electric motor assembly and a grip for holding, and the body housing is provided with a semi-open battery accommodation compartment which is recessed inward.

In some examples, when any one of the first fan and the second fan rotates, the heat dissipation air path is generated, and the heat dissipation air path flows through at least the at least one battery pack, the control circuit board, and the electric motor assembly.

In some examples, the airflow port comprises a second air inlet and a first air outlet, and the cooling airflow enters the battery accommodation compartment and the body housing from the second air inlet and flows out of the body housing from the first air outlet.

In some examples, the cutting tool further comprises a circuit board housing configured to accommodate the control circuit board, wherein the circuit board housing comprises a heat dissipation plate connected to the control circuit board and capable of transferring heat generated by the control circuit board, and the circuit board housing is disposed between the electric motor assembly and the battery accommodation compartment.

In some examples, a circular saw comprises: an output shaft on which a cutting part is mounted, wherein the cutting part rotates about an output axis; a first electric motor comprising a first drive shaft rotating about a first axis; a second electric motor comprising a second drive shaft rotating about a second axis; a power transmission mechanism for transmitting power of at least one of the first electric motor and the second electric motor to the output shaft; a power supply comprising at least one battery pack configured to provide a source of energy for the first electric motor and the second electric motor; a body housing at least partially accommodating the first electric motor, the second electric motor, and the power transmission mechanism, wherein the body housing comprises a first housing, and the first housing is formed with or connected to a grip for holding; and a base plate movably connected to the body housing, wherein the base plate is formed with a base plate bottom surface in contact with a workpiece. Along a direction perpendicular to an extension direction of the cutting part, an orthographic projection of a center of gravity of the circular saw is located between a rear edge of the base plate and the output axis.

In some examples, the projection of the center of gravity of the circular saw is close to the output axis and is located on a rear side of the output axis.

In some examples, the cutting part extends in a cutting plane; the grip is basically symmetrically disposed about a first plane; and along a direction perpendicular to the base plate, a projection of the center of gravity of the circular saw is located between the cutting plane and a right edge of the base plate or basically on the first plane.

In some examples, a distance between the projection of the center of gravity of the circular saw and the first plane is less than a distance between the center of gravity of the circular saw and the cutting plane.

In some examples, a ratio of a distance W1 between the projection of the center of gravity of the circular saw and the first plane to a distance W2 between the cutting plane and the first plane is less than or equal to 1/3.

In some examples, the first electric motor, the second electric motor, the at least one battery pack, and the grip are disposed on a same side of the cutting part, the at least one battery pack is at least partially disposed behind the first electric motor and the second electric motor, and the at least one battery pack is at least partially disposed in front of the grip.

In some examples, the first housing is formed with or connected to an accommodation housing, and the accommodation housing is configured to accommodate the first electric motor and the second electric motor.

In some examples, the base plate is formed with a hole extending along a first direction so that the cutting part is capable of passing through the base plate; and along the first direction, a ratio of an outer edge dimension L3 of the accommodation housing to an outer edge dimension La of the body housing is greater than or equal to 0.2 and less than or equal to 0.4.

In some examples, along a direction of the output axis, a ratio of an outer edge dimension H1 of the accommodation housing to an outer edge dimension Ha of the body housing is greater than or equal to 0.15 and less than or equal to 0.4.

In some examples, the cutting part has an outer diameter greater than 6 inches.

In some examples, a circular saw comprises: an output shaft on which a cutting part is mounted, wherein the cutting part rotates about an output axis; a first electric motor comprising a first drive shaft rotating about a first axis; a second electric motor comprising a second drive shaft rotating about a second axis; a power transmission mechanism for transmitting power of at least one of the first electric motor and the second electric motor to the output shaft; a power supply comprising at least one battery pack configured to provide a source of energy for the first electric motor and the second electric motor; a body housing at least partially accommodating the first electric motor, the second electric motor, and the power transmission mechanism; and a base plate movably connected to the body housing, wherein the base plate is formed with a base plate bottom surface in contact with a workpiece. When following orthographic projections are observed along a direction perpendicular to the base plate bottom surface, projections of the first drive shaft and the second drive shaft have two endpoints that are farthest apart along a direction of the output axis, a width interval W is defined between two straight lines on a projection plane each of which passes through a respective one of the two endpoints and is perpendicular to the output axis, and a projection of a center of gravity of the circular saw is set within the width interval W.

In some examples, a circular saw comprises: an output shaft on which a cutting part is mounted, wherein the cutting part rotates about an output axis; a first electric motor comprising a first drive shaft rotating about a first axis; a second electric motor comprising a second drive shaft rotating about a second axis, wherein the second drive shaft and the first drive shaft are arranged coaxially, and the first electric motor and the second electric motor are mechanically coupled; a power transmission mechanism for transmitting power of at least one of the first electric motor and the second electric motor to the output shaft; and a power supply comprising at least one battery pack configured to provide a source of energy for the first electric motor and the second electric motor. A diameter of the first electric motor is less than or equal to 70 mm, and a diameter of the second electric motor is less than or equal to 70 mm.

In some examples, the first electric motor is an outrunner, and the second electric motor is an outrunner.

In some examples, the first drive shaft rotates synchronously with the second drive shaft.

In some examples, the first electric motor comprises a first stator and a first rotor, and the first drive shaft is formed on or connected to the first rotor; the second electric motor comprises a second stator and a second rotor, and the second drive shaft is formed on or connected to the second rotor.

In some examples, the circular saw further comprises an electric motor fixing portion, wherein the electric motor fixing portion is connected to the first stator and the second stator separately.

In some examples, the electric motor fixing portion is provided with an accommodation channel configured to at least partially accommodate the first drive shaft and the second drive shaft.

In some examples, the accommodation channel at least partially overlaps the first stator along a direction of the first axis, and the accommodation channel at least partially overlaps the second stator along the direction of the first axis.

In some examples, along a direction of the output axis, a projection of the first axis and a projection of the second axis are located above a projection of the output axis.

In some examples, the power transmission mechanism comprises a transmission assembly, and the transmission assembly comprises at least a deceleration mechanism.

In some examples, the circular saw further comprises a base plate formed with a base plate bottom surface in contact with a workpiece. When following orthographic projections are observed along a direction perpendicular to the base plate bottom surface, projections of the first drive shaft and the second drive shaft have two endpoints that are farthest apart along the direction of the output axis, a width interval W is defined between two straight lines on a projection plane each of which passes through a respective one of the two endpoints and is perpendicular to the output axis, and a projection of a center of gravity of the circular saw is set within the width interval W.

In some examples, a power tool comprises: a functional piece; an electric motor assembly comprising a first electric motor and a second electric motor, wherein at least one of the first electric motor and the second electric motor drives the functional piece to operate; and a power supply device connected to the electric motor assembly and supplying power to at least the electric motor assembly. A transmission relationship exists between the first electric motor and the second electric motor, and when the first electric motor rotates, the first electric motor drives the second electric motor to rotate; the power tool further comprises a controller connected to the electric motor assembly, and the controller is configured to control, based on a back electromotive force of the second electric motor after the first electric motor is started, the second electric motor to start.

In some examples, the second electric motor is a sensorless brushless motor.

In some examples, the controller is configured to, when receiving a signal for starting the power tool, control the first electric motor to start.

In some examples, the controller is configured to, after the first electric motor is started for a first preset duration, control, based on the back electromotive force of the second electric motor, the second electric motor to start.

In some examples, the first preset duration is greater than or equal to 0.1 s and less than or equal to 2 s.

In some examples, the controller is configured to, after the first electric motor is started and a rotational speed of the first electric motor reaches a first rotational speed threshold, control, based on the back electromotive force of the second electric motor, the second electric motor to start.

In some examples, the first rotational speed threshold is greater than or equal to 10 RPM or greater than or equal to 10% of a no-load rotational speed of the first electric motor.

In some examples, the controller is configured to determine a position of a rotor of the second electric motor based on an extreme value of the back electromotive force of the second electric motor or based on a relative relationship between the back electromotive force and zero-point potential of the second electric motor and control the second electric motor to start.

In some examples, the controller comprises a first controller and a second controller, wherein the first controller is connected to the first electric motor, the second controller is connected to the second electric motor, the first controller is configured to, when receiving a signal for starting the power tool, control the first electric motor to start, and the second controller is configured to control, based on the back electromotive force of the second electric motor after the first electric motor is started, the second electric motor to start.

In some examples, a control method for a power tool comprises: starting a first electric motor of the power tool; and controlling, by a controller of the power tool, based on a back electromotive force of a second electric motor of the power tool after the first electric motor is started, the second electric motor to start. A transmission relationship exists between the first electric motor and the second electric motor, and when the first electric motor rotates, the first electric motor drives the second electric motor to rotate.

In some examples, a power tool comprises: a functional piece; an electric motor assembly comprising a first electric motor and a second electric motor, wherein at least one of the first electric motor and the second electric motor drives the functional piece to operate; and a power supply device connected to the electric motor assembly and supplying power to at least the electric motor assembly. The first electric motor and the second electric motor drive a same output shaft. The power tool further comprises a controller connected to the electric motor assembly, and the controller is configured to control the first electric motor to shut down when a first electric motor parameter of the first electric motor exceeds a first protection threshold and control the second electric motor to shut down when a second electric motor parameter of the second electric motor exceeds a second protection threshold after the first electric motor parameter exceeds the first protection threshold, wherein the first protection threshold is not equal to the second protection threshold.

In some examples, the first electric motor parameter comprises a first locked-rotor parameter of the first electric motor, and the first protection threshold comprises a first locked-rotor threshold; the second electric motor parameter comprises a second locked-rotor parameter of the second electric motor, and the second protection threshold comprises a second locked-rotor threshold.

In some examples, the first electric motor parameter comprises a first overcurrent parameter of the first electric motor, and the first protection threshold comprises a first overcurrent threshold; the second electric motor parameter comprises a second overcurrent parameter of the second electric motor, and the second protection threshold comprises a second overcurrent threshold.

In some examples, the first locked-rotor parameter is a first commutation duration of the first electric motor, and the first locked-rotor threshold is a first duration threshold; the second locked-rotor parameter is a second commutation duration of the second electric motor, and the second locked-rotor threshold is a second duration threshold. The controller is configured to control the first electric motor to shut down when the first commutation duration exceeds the first duration threshold and control the second electric motor to shut down when the second commutation duration exceeds the second duration threshold after the first commutation duration exceeds the first duration threshold, wherein the first duration threshold is not equal to the second duration threshold.

In some examples, in a case where a rotational speed ratio of the first electric motor and the second electric motor is n:1, a ratio of the first duration threshold to the second duration threshold is not equal to 1:n.

In some examples, the first overcurrent parameter is a first current of the first electric motor, and the first overcurrent threshold is a first current threshold; the second overcurrent parameter is a second current of the second electric motor, and the second overcurrent threshold is a second current threshold; the controller is configured to control the first electric motor to shut down when the first current exceeds the first current threshold and control the second electric motor to shut down when the second current exceeds the second current threshold after the first current exceeds the first current threshold, wherein the first current threshold is not equal to the second current threshold.

In some examples, in a case where a torque ratio of the first electric motor and the second electric motor is n:1, a ratio of the first current threshold to the second current threshold is not equal to n:1.

In some examples, the first overcurrent parameter is a calculation value of one or more of first output torque, a first current, and first demagnetization time of the first electric motor, and the second overcurrent parameter is a calculation value of one or more of second output torque, a second current, and second demagnetization time of the second electric motor.

In some examples, in a case where a ratio of the first electric motor parameter to the second electric motor parameter is n:1, a ratio of the first protection threshold to the second protection threshold is not equal to n:1.

In some examples, the power tool further comprises a driving device, wherein the driving device comprises a first driver circuit and a second driver circuit, the first driver circuit is connected between the power supply device and the first electric motor, and the second driver circuit is connected between the power supply device and the second electric motor.

In some examples, the first protection threshold has different values in a case where a capacity or a voltage of the power supply device has different values; and/or the second protection threshold has different values in the case where the capacity or the voltage of the power supply device has different values.

In some examples, the first protection threshold and/or the second protection threshold are dynamic thresholds and a corresponding relationship exists between values of the dynamic thresholds and a current current or voltage of the electric motor assembly.

In some examples, the controller comprises a first controller and a second controller, the first controller is connected to the first electric motor through the first driver circuit, the second controller is connected to the second electric motor through the second driver circuit, the first controller is configured to control the first electric motor to shut down when the first electric motor parameter of the first electric motor exceeds the first protection threshold, and the second controller is configured to control the second electric motor to shut down when the second electric motor parameter of the second electric motor exceeds the second protection threshold after the first electric motor parameter exceeds the first protection threshold, wherein the first protection threshold is not equal to the second protection threshold.

In some examples, a power tool comprises: a functional piece; an electric motor assembly comprising a first electric motor and a second electric motor, wherein at least one of the first electric motor and the second electric motor drives the functional piece to operate; and a power supply device connected to the electric motor assembly and supplying power to at least the electric motor assembly. The first electric motor and the second electric motor drive a same output shaft. The power tool further comprises a controller connected to the electric motor assembly, wherein the controller is configured to control the first electric motor to shut down when a first electric motor parameter of the first electric motor exceeds a first protection threshold and control the second electric motor to shut down after the first electric motor parameter exceeds the first protection threshold for a second preset duration.

In some examples, a control method for a power tool comprises: controlling, by a controller of the power tool, a first electric motor to shut down when a first electric motor parameter of the first electric motor of the power tool exceeds a first protection threshold; and controlling, by the controller, a second electric motor to shut down when a second electric motor parameter of the second electric motor of the power tool exceeds a second protection threshold after the first electric motor parameter exceeds the first protection threshold, wherein the first protection threshold is not equal to the second protection threshold, and the first electric motor and the second electric motor drive a same output shaft.

### BRIEF DESCRIPTION OF THE DRAWINGS

FIG. 1 is a structural view of an example of the present application.

FIG. 2 is a view showing examples of power tools to which an electric motor assembly of the present application is applicable.

FIG. 3 is a schematic view showing the structure of a first electric motor which is an outrunner according to an example of the present application.

FIG. 4 is an exploded view showing the structure of an electric motor assembly according to an example of the present application.

FIG. 5 is a sectional view of an electric motor assembly according to an example of the present application.

FIG. 6 is a sectional view of an electric motor assembly provided with a motor shield according to an example of the present application.

FIG. 7 is a schematic view showing the structure of a first electric motor which is an inrunner according to an example of the present application.

FIG. 8 is a structural view of a second electric motor assembly according to an example of the present application.

FIG. 9 is a structural view of a third electric motor assembly according to an example of the present application.

FIG. 10 is a sectional view showing the structure of a third electric motor assembly according to an example of the present application.

FIG. 11 is a sectional view showing the structure of a fourth electric motor assembly according to an example of the present application.

FIG. 12 is a circuit schematic of an example of the present application.

FIG. 13 is a flowchart of a control method of the present application.

FIG. 14 is a graph showing motor efficiency and motor output torque of a first electric motor, a second electric motor, and an electric motor assembly of the present application.

FIG. 15 is a graph showing motor efficiency and motor output torque of an electric motor assembly of the present application.

FIG. 16 is a structural view of an electric motor according to a second example of the present application.

FIG. 17 is a cross-sectional view showing the structure of an electric motor which is an inrunner according to a second example of the present application.

FIGS. 18A and 18B are sectional views of FIG. 16, which mainly show different structures of a rotor assembly.

FIG. 19 is a circuit schematic of an example of the present application.

FIG. 20 is a structural view of an electric motor according to a third example of the FIG. 21 is a perspective view illustrating the structure of a circular saw according to an example of the present application.

FIG. 22 is a view illustrating the structure of a circular saw in a first state according to an example of the present application.

FIG. 23 is a view illustrating the structure of a circular saw in a second state according to an example of the present application.

FIG. 24 is a view illustrating the structure of a circular saw according to an example of the present application from another perspective and illustrating related components of an electric motor assembly.

FIG. 25 is a view illustrating the structures of some components of a circular saw according to an example of the present application from a third perspective with components related to a cutting part removed.

FIG. 26 is a partial sectional view taken along A-A in FIG. 25.

FIG. 27 is an exploded view of some components of a circular saw according to an example of the present application.

FIG. 28 is a half section view of an electric motor assembly and an accommodation housing of a circular saw according to an example of the present application.

FIG. 29 is a perspective view illustrating the structure of a circular saw according to another example of the present application.

FIG. 30 is a perspective view illustrating the structure of a third example of a circular saw according to an example of the present application.

FIG. 31 is a sectional view of a first electric motor in an electric motor assembly according to the present application.

FIG. 32 is a view illustrating the structure of a power transmission mechanism of a circular saw according to an example of the present application.

FIG. 33 is a structural view of FIG. 32 from another perspective.

FIG. 34 is a partial sectional view of FIG. 33 from another perspective.

FIG. 35 is a structural view of FIG. 33 from another perspective.

FIG. 36 is a view illustrating the structure of a second type of power transmission mechanism of a circular saw according to an example of the present application.

FIG. 37 is a view illustrating the structure of a third type of power transmission mechanism of a circular saw according to an example of the present application.

FIG. 38 is a view illustrating the structures of a fourth type of electric motor assembly, a fourth type of power transmission mechanism, and a fourth type of accommodation housing of a circular saw according to an example of the present application.

FIG. 39 is a view illustrating the structures of the electric motor assembly and the power transmission mechanism in FIG. 38 from another perspective.

FIG. 40 is a schematic view illustrating the internal structure of a circular saw according to an example of the present application.

FIG. 41 is a schematic view illustrating some structures of a circular saw according to an example of the present application.

FIG. 42 is a partial sectional view of the structures in FIG. 41.

FIG. 43 is a view illustrating the structure of another example different from the structure in FIG. 40.

FIG. 44 is a view illustrating the structure of a third example different from the structure in FIG. 40.

FIG. 45 is a view illustrating the structure of a fourth example different from the structure in FIG. 40.

FIG. 46 is a view illustrating the structure of a fifth example different from the structure in FIG. 40.

FIG. 47 is a schematic diagram illustrating an electrical structure according to an example of the present application.

FIG. 48 is a schematic diagram illustrating another electrical structure according to an example of the present application.

FIG. 49 is a control flowchart according to an example of the present application.

FIG. 50 is another control flowchart according to an example of the present application.

FIG. 51 is a perspective view of a power tool as another example of the present application from one perspective.

FIG. 52 is a perspective view of the power tool shown in FIG. 51 from another perspective.

FIG. 53 is a perspective view of an electric motor assembly in the power tool shown in FIG. 51 in an example.

FIG. 54 is a perspective view of an electric motor assembly in the power tool shown in FIG. 51 in another example.

FIG. 55 is a schematic diagram of electric control of the power tool shown in FIG. 51.

FIG. 56 is another schematic diagram of electric control of the power tool shown in FIG. 51.

FIG. 57 is a control flowchart of a power tool as an example of the present application.

FIG. 58 is a control flowchart of a power tool as another example of the present application.

FIG. 59 is a schematic diagram illustrating an electrical structure according to an example of the present application.

FIG. 60 is a block diagram illustrating electrical connections according to an example of the present application.

FIG. 61 is a control flowchart according to an example of the present application, where a power tool switches between working modes in a manual mode.

FIG. 62 is another block diagram illustrating electrical connections according to an example of the present application.

FIG. 63 is a control flowchart according to an example of the present application.

FIG. 64 is a control flowchart according to an example of the present application, where

a power tool switches between working modes through electronic identification by detecting a physical quantity related to operation of a battery pack.

FIG. 65 is a control flowchart according to an example of the present application, where a controller determines, according to a physical quantity related to a running state of a battery pack, whether to respond to a configuration signal of a working mode of a power tool.

FIG. 66 is a flowchart of a control method for a power tool in an adaptive mode according to an example of the present application.

FIG. 67 is a third block diagram illustrating electrical connections according to an example of the present application.

FIG. 68 is a control flowchart according to an example of the present application, where a power tool switches between working modes through electronic identification.

FIG. 69 is a flowchart of a method for controlling rotational speeds of a first electric motor and a second electric motor of a power tool according to an example of the present application.

FIG. 70 is another flowchart of a method for controlling rotational speeds of a first electric motor and a second electric motor of a power tool according to an example of the present application.

FIG. 71A is a fourth block diagram illustrating electrical connections according to an example of the present application.

FIG. 71B is a fifth block diagram illustrating electrical connections according to an example of the present application.

FIG. 72 is a schematic view illustrating the internal structure of a circular saw according to an example of the present application.

FIG. 73 is a perspective view of a circular saw according to an example of the present application, where a first arrangement position of a mode switching switch is shown.

FIG. 74 is a perspective view of a circular saw according to an example of the present application, where a second arrangement position of a mode switching switch is shown.

FIG. 75 is a perspective view of a circular saw according to an example of the present application, where a third arrangement position of a mode switching switch is shown.

FIG. 76 is a perspective view of a circular saw according to an example of the present application, where a fourth arrangement position of a mode switching switch is shown.

FIG. 77 is a schematic view illustrating the internal structure of a circular saw according to an example of the present application, where a second arrangement position of a control circuit board is shown.

FIG. 78 is a schematic view illustrating the internal structure of a circular saw according to an example of the present application, where a third arrangement position of a control circuit board and second arrangement positions of an electric motor assembly are shown.

FIG. 79 is a schematic view illustrating the internal structure of a circular saw according to an example of the present application, where third arrangement positions of control circuit boards are shown.

FIG. 80 is a structural view of an electric motor assembly, a power transmission mechanism, and an output shaft of a circular saw according to an example of the present application, where second arrangement positions of the above components are shown.

FIG. 81 is a structural view of an electric motor assembly, a power transmission mechanism, and an output shaft of a circular saw according to an example of the present application, where third arrangement positions of the above components are shown.

FIG. 82 is a schematic view of FIG. 81 from another angle.

FIG. 83 shows a circular saw according to an example of the present application, where an electric motor assembly includes at least two electric motors.

FIG. 84 shows another circular saw according to an example of the present application, where an electric motor assembly includes at least two electric motors.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

To clearly illustrate the technical solutions of the present application, an upper side and a lower side are defined in the drawings of the specification.

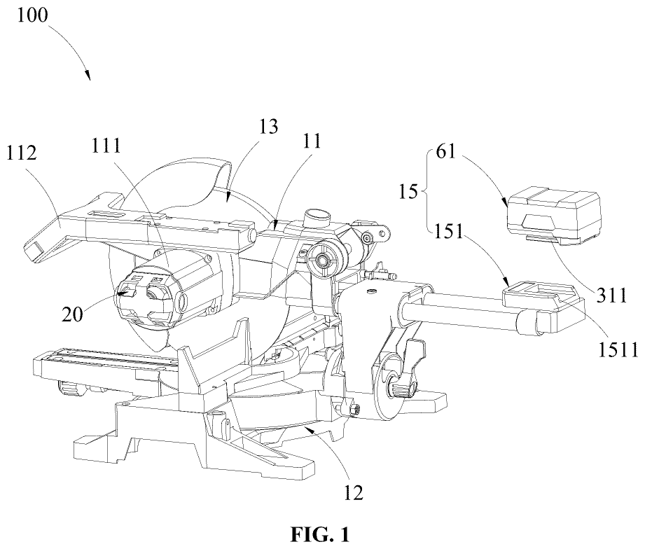

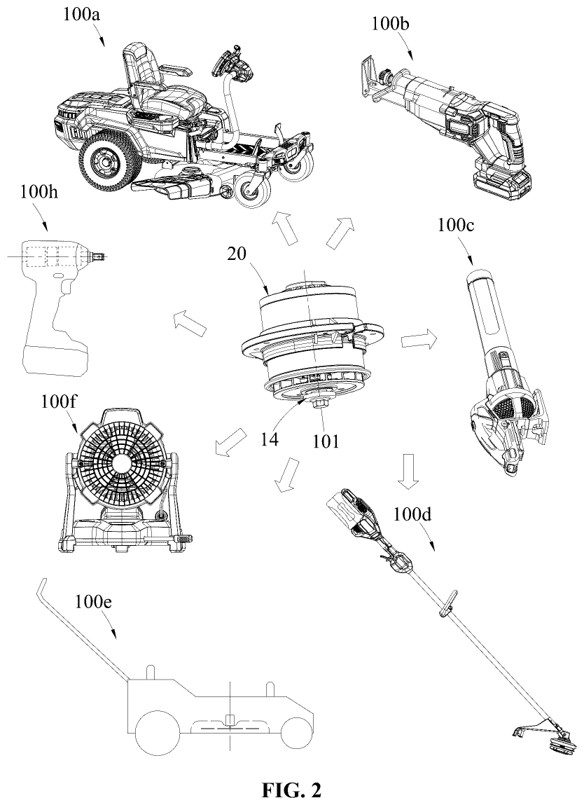

FIG. 1 shows a power tool in an example of the present application. The power tool includes an electric motor assembly 20. In this example, the power tool is a miter saw 100. As shown in FIG. 2, in some examples, the power tool may be a garden tool, for example, a string trimmer 100d, a blower 100c, a walk-behind power tool such as a mower 100e, a chainsaw, or a washer. Alternatively, the power tool may be a decoration tool, for example, a screwdriver/drill/wrench 100h, an electric hammer, a nail gun, or a sander. Alternatively, the power tool may be a sawing tool, for example, a reciprocating saw 100b, a jigsaw, or a circular saw. Alternatively, the power tool may be a table tool, for example, a table saw, a metal cutter, or a router. Alternatively, the power tool may be a sanding tool, for example, an angle grinder or a sander. Alternatively, the power tool may be another power tool, for example, a fan 100f. Alternatively, the power tool may be walking equipment 100a that does not travel on roads, for example, a utility vehicle, a dune buggy, a utility terrain vehicle (UTV), a golf cart, an all-terrain vehicle (ATV), or an agricultural machinery vehicle such as a reaper or a sprayer. Alternatively, the walking equipment may be a cleaning machine. Alternatively, the power tool may be a smart walking power tool that is driven by an electric motor or an electric motor assembly to travel and implement a work function, for example, a smart mower.

Any power tool driven by an electric motor can adopt the technical solutions disclosed in this example. Any power device adopting the technical solutions disclosed in this example falls within the scope of the present application. For example, the power tool may be a powerhead, and the powerhead includes the electric motor assembly. The powerhead is configured to be adapted to some output assemblies to implement functions of the tool.

As shown in FIG. 1, the miter saw 100 is used as an example. The miter saw 100 includes a power supply 61. In this example, the power supply 61 is a direct current power supply. The direct current power supply is configured to provide electrical energy for the miter saw 100. The direct current power supply is a battery pack, and the battery pack supplies power to the miter saw 100 in collaboration with a corresponding power supply circuit. It is to be understood by those skilled in the art that the power supply is not limited to the direct current power supply, and the corresponding components in the machine may be powered through mains power or an alternating current power supply in conjunction with corresponding rectifier, filter, and voltage regulator circuits. In the subsequent description, the battery pack 61 is used instead of the power supply 61, which cannot be construed as limiting the present application.

The miter saw 100 further includes a base 12, a housing 11, a function element 13, and an output mechanism 14. The housing 11 includes a body housing 111 and a grip 112. At least the electric motor assembly 20 and part of the output mechanism 14 are accommodated in the body housing 111. The body housing 111 is formed with or connected to the grip 112 for a user to operate.

The base 12 enables the miter saw 100 to be placed smoothly on the ground or an operation plane.

As shown in FIG. 4, the output mechanism 14 is configured to drive the function element 13. In this example, the output mechanism 14 includes an output shaft 141. In some examples, a transmission assembly is connected between the output mechanism 14 and the electric motor assembly 20, for example, in high-speed and high-torque output tools such as screwdrivers, drills, and saws. The transmission assembly transmits output power of the electric motor assembly 20 to the output mechanism 14, and the output mechanism 14 drives the function element 13 to machine a workpiece. In some examples, the electric motor assembly 20 directly drives the output mechanism 14, for example, in the fan, the blower, and mowing tools, and the output mechanism 14 drives the function element 13 to machine the workpiece.

The function element 13 is configured to implement a set function. In this example, the function element 13 is configured to implement the work function of the power tool, such as a saw blade for cutting the workpiece. In other alternative examples, the function element 13 may be a grinding disc, a blade, a screwdriver, a fan, a pump, or a walking wheel.

The overall structure of the miter saw 100 is generally the same as that of a common miter saw and is not described in detail here.

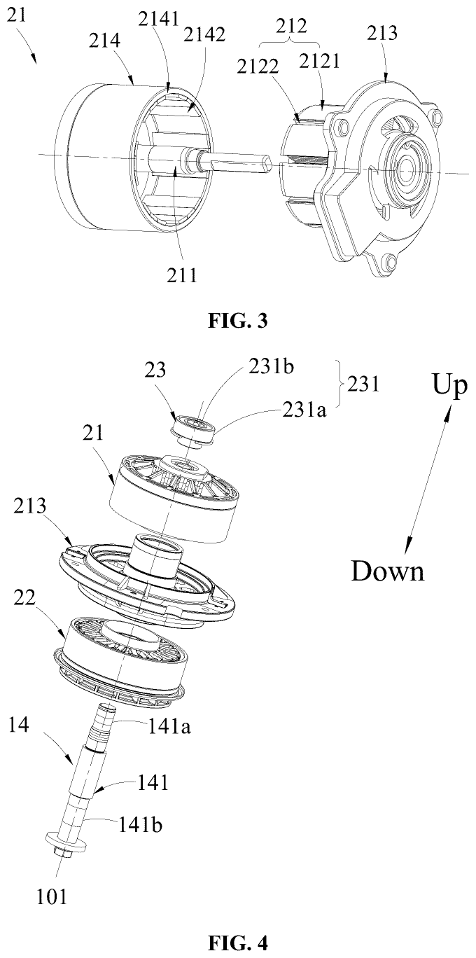

In this example, the electric motor assembly 20 is configured to provide a power source for the output mechanism 14 so that the output mechanism 14 drives the function element 13. In this example, the electric motor assembly 20 includes a first electric motor 21 and a second electric motor 22. Each of the first electric motor 21 and the second electric motor 22 includes a stator and a rotor. With the first electric motor 21 as an example, as shown in FIG. 3, a stator 212 includes a stator core 2121 and stator windings 2122. A rotor 214 includes a rotor core 2141 and permanent magnets 2142. A rotor shaft 211 is formed on or connected to the rotor 214 and used for outputting power. For an outrunner, the rotor is sleeved on the outer side of the stator. For an inrunner, the stator is sleeved on the outer side of the rotor. In this example, the first electric motor 21 is the outrunner. The first electric motor 21 further includes a stator support 213 provided with mounting holes. The stator 212 is fixed outside the stator support 213.

The overall structure of the electric motor here is generally the same as that of a common brushless motor and is not described in detail here.

As shown in FIG. 1, a power supply device 15 includes a power supply mounting portion 151 and the battery pack 61. The power supply mounting portion 151 is disposed at least partially on the housing 11. The power supply mounting portion 151 is different in position for different types of power tools. The position of the power supply mounting portion 151 does not affect the substantive content protected in the present application.

The battery pack 61 is connected to the power supply mounting portion 151 or placed at least partially in the power supply mounting portion 151. It is to be understood that the power supply mounting portion 151 is used for receiving the battery pack 61. In this example, the battery pack 61 supplies power to the first electric motor 21 and the second electric motor 22, and the nominal voltage of the power tool is greater than or equal to 18 V. The battery pack 61 supplies power to the first electric motor 21 and the second electric motor 22 in collaboration with the corresponding power supply circuit. The battery pack 61 includes an insertion structure 311 and a terminal interface (not shown in the figure). The power supply mounting portion 151 includes a coupling portion 1511 electrically connected to the battery pack 61, and the coupling portion 1511 is provided with tool terminals (not shown in the figure). Tool terminals (not shown in the figure) with the same structure are provided on different power tools to be adapted to the terminal interface (not shown in the figure) on the battery pack 61 so that the battery pack 61 can supply power to various different power tools. The power supply circuit in collaboration with the battery pack is adjusted according to control requirements of different power tools. In some examples, the nominal voltage of the power tool is greater than or equal to 36 V and less than or equal to 56 V. In some examples, the nominal voltage of the power tool is greater than 56 V and less than or equal to 120 V. In some examples, the battery pack 21 may be a lithium battery pack, a solid-state battery pack, or a pouch battery pack. The nominal voltage of the battery pack is 18 V, 24 V, 36 V, 48 V, 56 V, 80 V, or 120 V.

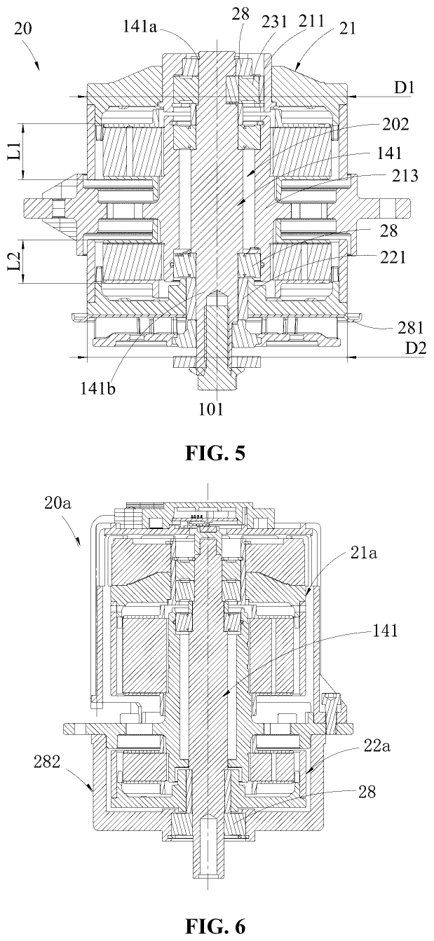

As shown in FIGS. 4 and 5, the first electric motor 21 is configured to output first torque and a first rotational speed. The second electric motor 22 is configured to output second torque and a second rotational speed. The electric motor assembly 20 further includes a connector 23. The connector 23 selectively allows power transmission between the first electric motor 21 and the second electric motor 22. In some examples, the connector 23 is connected to the first electric motor 21 and the second electric motor 22, and the connector 23 switches a connection state between the first electric motor 21 and the second electric motor 22 to switch the power transmission between the first electric motor 21 and the second electric motor 22 so that the electric motor assembly 20 switches between multiple working states. The output mechanism 14 is connected to the electric motor assembly 20. That is to say, the output mechanism 14 is connected to at least one of the first electric motor 21, the second electric motor 22, and the connector 23 so that the first electric motor 21 and the second electric motor 22 can be coupled to drive the output mechanism 14. The connector 23 transmits power from at least one of the first electric motor and the second electric motor to the output mechanism 14, and the connector 23 switches the power transmission between the first electric motor 21, the second electric motor 22, and the output shaft 141 so that the electric motor assembly 20 switches between the multiple working states.

According to a load situation of the output mechanism 14, the first electric motor 21, the second electric motor 22, or both the first electric motor 21 and the second electric motor 22 are selected to drive the output mechanism 14 so that no matter whether the power tool is in a light load state, a medium load state, or a heavy load state, appropriate input power can be allocated. The working efficiency under all conditions can be improved. The load state of the power tool may be characterized by a load state of the output shaft. The load state of the output shaft may be characterized by a parameter related to a current of the electric motor and a parameter related to output torque of the electric motor. For example, when a real-time current of the electric motor is not higher than 10% of the rated current or is 10% to 15% of the rated current, it is the light load state, and when the real-time current of the electric motor is 50% to 80% of the rated current, it is the heavy load state. Specific values may be set according to actual situations and are not specifically limited here.

The first electric motor 21 is configured to output the first torque and the first rotational speed. The second electric motor 22 is configured to output the second torque and the second rotational speed. The first torque is different from the second torque. The first rotational speed is different from the second rotational speed. It is to be interpreted that the first torque being different from the second torque is defined in some examples as different maximum output torque of the first electric motor and the second electric motor, and the first electric motor and the second electric motor may output the same torque at a moment or in a time period in the entire working process. In some examples, it is defined as different output torque ranges of the first electric motor and the second electric motor in high efficiency intervals, and the first electric motor and the second electric motor may output the same torque at a moment or in a time period in the entire working process. The first rotational speed being different from the second rotational speed is defined in some examples as different maximum output rotational speeds of the first electric motor and the second electric motor, and the first electric motor and the second electric motor may output the same rotational speed at a moment or in a time period in the entire working process. In some examples, it is defined as different output rotational speed ranges of the first electric motor and the second electric motor in high efficiency intervals, and the first electric motor and the second electric motor may output the same rotational speed at a moment or in a time period in the entire working process.

In some examples, an application situation of the first electric motor and the second electric motor is listed as an example, where the first electric motor 21 has low output torque. The second electric motor 22 has high output torque. Alternatively, the first electric motor 21 may have high output torque. The second electric motor 22 may have low output torque. Alternatively, the first electric motor 21 and the second electric motor 22 are of the same type, but the first electric motor 21 and the second electric motor 22 have different output rotational speeds and different output torque. In this example, the first electric motor 21 and the second electric motor 22 are each a direct current brushless motor.

In an example, the first electric motor 21 and the second electric motor 22 further include at least one different structural parameter. The structural parameter includes the outer diameter D of the electric motor and the stack length L of the electric motor. It is to be interpreted that the “outer diameter of the electric motor” refers to the outer diameter of the entire electric motor. The “stack length of the electric motor” refers to the length of the stator core.

In this example, the ratio of the stack length L2 of the second electric motor 22 to the stack length L1 of the first electric motor 21 is greater than or equal to 0.3. The ratio of the stack length L2 of the second electric motor 22 to the stack length L1 of the first electric motor 21 is greater than or equal to 0.4, 0.5, 0.6, 0.7, 0.8, or 0.9. In other alternative examples, the ratio of the stack length L1 of the first electric motor 21 to the stack length L2 of the second electric motor 22 is greater than or equal to 0.3. In other alternative examples, the ratio of the stack length L1 of the first electric motor 21 to the stack length L2 of the second electric motor 22 is greater than or equal to 0.4, 0.5, 0.6, 0.7, 0.8, or 0.9.

In other alternative examples, the ratio of the outer diameter D1 of the first electric motor 21 to the outer diameter D2 of the second electric motor 22 is greater than or equal to 0.4. In other alternative examples, the ratio of the outer diameter D1 of the first electric motor 21 to the outer diameter D2 of the second electric motor 22 is greater than or equal to 0.5, 0.6, 0.7, 0.8, or 0.9.

The structural parameter of the first electric motor 21 and the second electric motor 22 includes the outer diameter of the stator core, the inner diameter of the stator core, the outer diameter of the rotor core, the inner diameter of the rotor core, the thickness of a rotor pole, the thickness of a stator pole, the length of an air gap, the length of the core, the number of pairs of stator poles, an arc corresponding to the stator pole, the number of pairs of rotor poles, and an arc corresponding to the rotor pole. The first electric motor 21 and the second electric motor 22 are different in at least one structural parameter.

The output mechanism 14 includes an input end and an output end. The output end is connected to the function element 13, and the input end is connected to at least one of the first electric motor 21, the second electric motor 22, and the connector 23. In this example, the output mechanism 14 includes the output shaft 141. An output end 141b of the output shaft is the output end of the output mechanism 14, and an input end 141a of the output shaft is the input end of the output mechanism 14.

In this example, the first electric motor 21 and the second electric motor 22 are each the outrunner. A first rotor shaft 211 of the first electric motor 21, a second rotor shaft 221 of the second electric motor 22, and the output shaft 141 rotate around a first axis 101. The first rotor shaft 211 and the second rotor shaft 221 are hollow structures, and the stator 212 of the first electric motor and a stator of the second electric motor share the same stator support 213. In some examples, the stator 212 of the first electric motor and the stator of the second electric motor are each connected to the stator support 213, and the stator support of the first electric motor is connected to the stator support of the second electric motor. In some examples, the stator 212 of the first electric motor and the stator of the second electric motor are coaxially connected through the stator support. The first rotor shaft 211, the stator support 213, and the second rotor shaft 221 form a first accommodation space 202. The output shaft 141 is disposed in the first accommodation space 202. In this example, the connector 23 includes a one-way transmission assembly. Optionally, the connector 23 includes a one-way bearing 231. The one-way bearing 231 is disposed at the input end 141a. The first electric motor 21 is disposed closer to the input end 141a, and the second electric motor 22 is disposed closer to the output end 141b than the first electric motor 21. The one-way bearing 231 is disposed in the first rotor shaft 211. In this example, the first electric motor 21 is disposed above the second electric motor 22. In other alternative examples, the first electric motor 21 is disposed below the second electric motor 22. The position of the first electric motor 21 relative to the second electric motor 22 does not affect the substantive content protected in the present application. Optionally, the one-way bearing 231 connects the output mechanism 14 to the first electric motor 21 or connects the output mechanism 14 to the second electric motor 22. Optionally, the one-way bearing 231 connects the first electric motor 21 to the second electric motor 22. The one-way bearing 231 allows the first electric motor 21, the second electric motor 22, or both the first electric motor and the second electric motor to drive the output mechanism 14, and the one-way bearing 231 prevents the output mechanism 14 from driving the first electric motor 21 or the second electric motor 22.

The one-way bearing 231 includes a one-way bearing outer race 231a and a one-way bearing inner race 231b. Optionally, the one-way bearing outer race 231a is connected to the first rotor shaft 211, and the one-way bearing inner race 231b is connected to the output shaft 141. The one-way bearing 231 prevents the output shaft 141 from driving the first rotor shaft 211 to rotate.

In this example, the electric motor assembly 20 includes at least a first working state corresponding to the light load state (when required output torque of the electric motor is low) and a second working state corresponding to the heavy load state (when the required output torque of the electric motor is high). When the electric motor assembly 20 is controlled to enter the first working state, the second electric motor 22 is controlled to start working to drive the output shaft 141 to output power, and the second rotor shaft 221 and the output shaft 141 rotate along a set direction. The first electric motor 21 receives no startup signal or is controlled not to start working. Since the output shaft 141 is connected to the first rotor shaft 211, if the output shaft 141 rotates to drive the first rotor shaft 211 to rotate, the rotor of the first electric motor 21 is passively rotated in a reverse direction, easily causing damage to the electric motor. In this example, the one-way bearing 231 is disposed. When the second electric motor 22 is started and the first electric motor 21 is not started, the rotation of the output shaft 141 drives the one-way bearing inner race 231b to rotate, the one-way bearing outer race 231a rotates relative to the one-way bearing inner race 231b, and the one-way bearing outer race 231a does not rotate with the output shaft 141. The damage to the first electric motor 21 is avoided.

It is to be understood that when a power output portion of the one-way bearing (the inner race in this example) rotates faster than a power source (the outer race in this example), a one-way clutch is in a disengaged state, and the inner race and the outer race are not linked, which is a one-way overrunning function of the one-way clutch.

When the electric motor assembly 20 is controlled to enter the second working state, the second electric motor 22 is controlled to start and the first electric motor 21 is also controlled to start, and the first rotor shaft 211 and the second rotor shaft 221 are required to simultaneously drive the output shaft 141 to rotate. When the rotational speed of the first rotor shaft 211 is equal to or higher than that of the second rotor shaft 221, the relative movement between the one-way bearing inner race 231b and the one-way bearing outer race 231a is locked, and the second electric motor 22 and the first electric motor 21 drive the output shaft 141 to move. Thus, the electric motor assembly 20 is provided with different working states.

In other alternative examples, the first rotor shaft is connected to the second rotor shaft through the one-way bearing, and the output shaft is connected to the second rotor shaft. When the electric motor assembly is controlled to enter the first working state, the first electric motor is controlled to start working to drive the output shaft to output power, and the one-way bearing prevents the first electric motor from driving the second rotor shaft to move. When the electric motor assembly is controlled to enter the second working state, the first electric motor is controlled to start and the second electric motor is also controlled to start. The relative movement between the one-way bearing inner race and the one-way bearing outer race is locked. The first rotor shaft and the second rotor shaft simultaneously drive the output shaft to rotate.

As shown in FIG. 5, an ordinary bearing 28 is sleeved as needed to support the first rotor shaft 211, the second rotor shaft 221, and the output shaft 141. In this example, the ordinary bearing 28 is disposed in the first accommodation space 202, and a dustproof cover 281 is configured to block an opening of the first accommodation space closer to the output end so that dust can be prevented from entering the ordinary bearing 28. In some examples, as shown in FIG. 6, a motor shield 282 is provided on the outer side of an electric motor assembly 20a or a first electric motor 21a or a second electric motor 22a, an ordinary bearing 28 is provided on the outer side of the first electric motor 21a or the second electric motor 22a, and the ordinary bearing 28 supports the output shaft 141 and the motor shield 282.

When a load of the output mechanism 14 is relatively light, the electric motor assembly 20 is in the first working state, and only the electric motor with low output torque, such as the second electric motor 22, is started so that the second electric motor 22 can work within a power interval where the electric motor has relatively high efficiency. The energy of the battery pack 61 can be saved and the working time of the battery pack 61 can be increased. The following problem is solved: a power consumption increases due to the startup of the first electric motor 21 and the second electric motor 22, and the working duration of the battery pack 61 is reduced. Since the power of the second electric motor 22 only needs to satisfy the light load of the output mechanism 14, output power of the second electric motor 22 may be configured to be relatively small. That is to say, the second electric motor 22 with small power can be used so that the cost can be reduced. When the load of the output mechanism 14 is relatively heavy, the electric motor assembly 20 is in the second working state, and both the first electric motor 21 and the second electric motor 22 are started so that the first electric motor 21 and the second electric motor 22 can work within power intervals where the electric motors have relatively high efficiency. The working efficiency and high efficiency interval of the electric motor assembly 20 are improved.

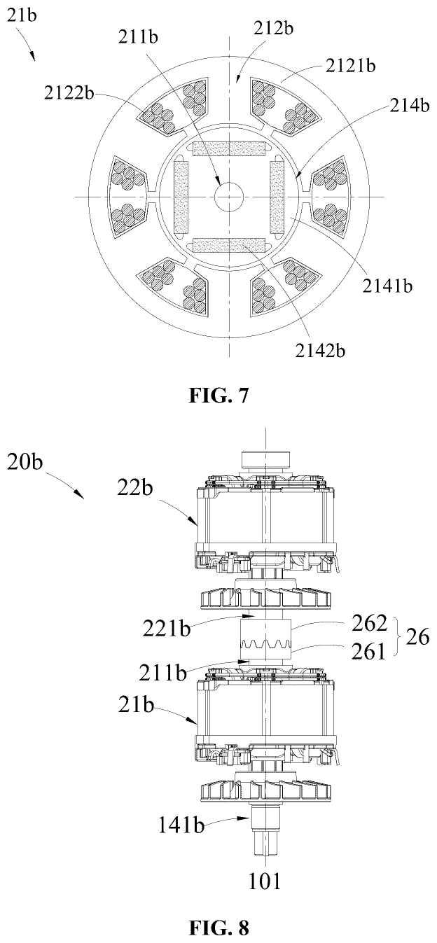

As shown in FIG. 7, in some alternative examples, a first electric motor 21b and a second electric motor 22b are each the inrunner. With the first electric motor 21b as an example, the first electric motor 21b includes a stator 212b and a rotor 214b. The stator 212b includes a stator core 2121b and coil windings 2122b on the stator core. The rotor 214b includes a rotor core 2141b and permanent magnets 2142b on the rotor core, where the permanent magnets 2142b are arranged at intervals along a circumferential direction of the rotor core 2141b and configured to generate a magnetic field. A rotor shaft 211b is formed on or connected to the rotor 214b and used for outputting power. The coil windings 2122b are windings of conductive metal, such as copper windings.

As shown in FIG. 8, a first rotor shaft 211b of the first electric motor 21b, a second rotor shaft 221b of the second electric motor 22b, and an output shaft 141b rotate around the first axis 101. The first rotor shaft 211b is connected to the second rotor shaft 221b by a clutch assembly 26. The clutch assembly 26 includes a driving member 261 and a driven member 262, and the clutch assembly 26 has a first state and a second state. When the clutch assembly 26 is in the first state, the driving member 261 is disconnected from the driven member 262. Thus, the power transmission between the first rotor shaft 211b and the second rotor shaft 221b is disconnected. When the clutch assembly 26 is in the second state, the driving member 261 is engaged with the driven member 262, and power is transmitted between the first rotor shaft 211b and the second rotor shaft 221b.

The output shaft 141b is mounted to the first rotor shaft 211b. When an electric motor assembly 20b is in the first working state, the first electric motor 21b is controlled to start and the second electric motor 22b receives no startup signal or is controlled not to start working. At the same time, the clutch assembly 26 is switched to the first state. In this case, only the first electric motor 21b drives the output shaft 141b to output power. When the electric motor assembly 20b is in the second working state, the second electric motor 22b is controlled to start and the first electric motor 21b is also controlled to start. At the same time, the clutch assembly is switched to the second state. In this case, the first electric motor 21b directly drives the output shaft 141b to output power, and the second electric motor 22b drives the first electric motor 21b to drive the output shaft 141b to output power.

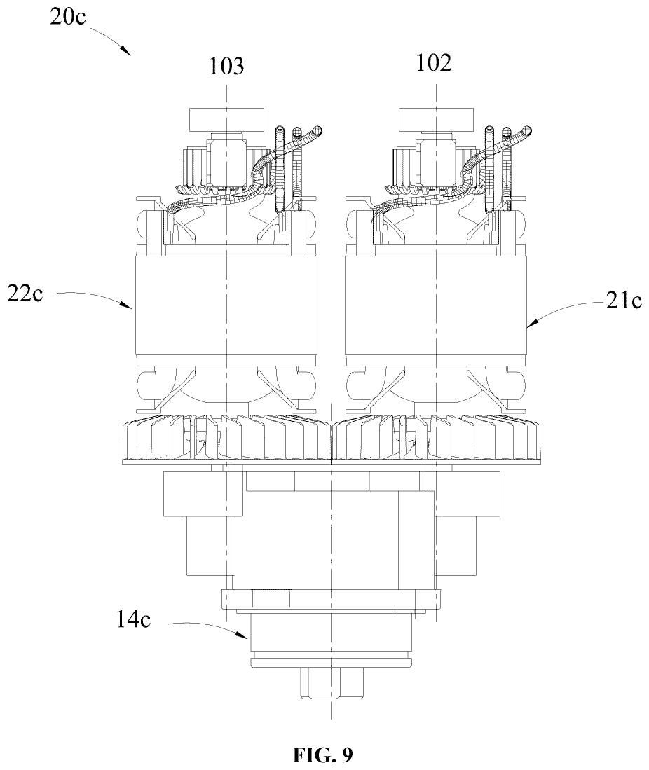

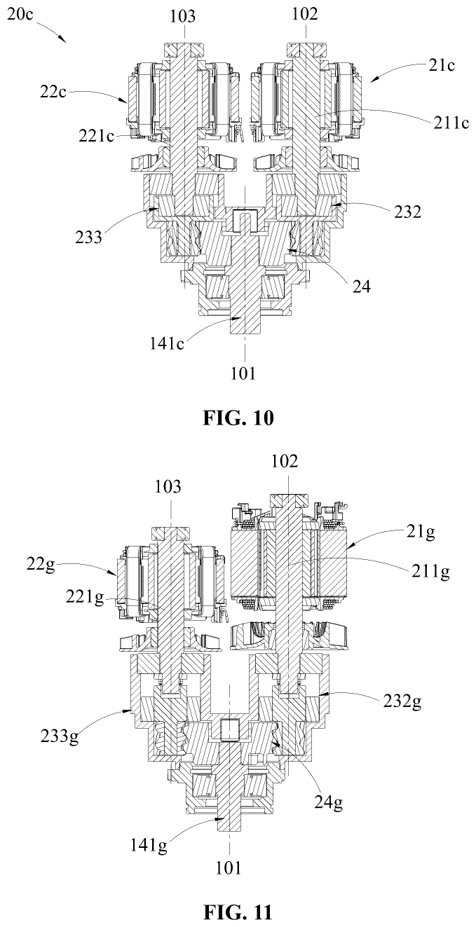

As shown in FIGS. 9 to 11, in some alternative examples, the output shaft rotates around the first axis 101, the first rotor shaft of the first electric motor rotates around a second axis 102, and the second rotor shaft of the second electric motor rotates around a third axis 103. In this example, the first axis 101 is parallel to but does not coincide with the second axis 102 and the third axis 103. In other examples, the first axis 101 may be parallel to or coincide with the second axis 102 and the third axis 103.

The clutch assembly includes a first clutch 232 and a second clutch 233. The first clutch 232 is disposed between a first electric motor 21c and an output mechanism 14c, and the first clutch 232 is configured to transmit power between the first electric motor 21c and the output mechanism 14c. The second clutch 233 is disposed between a second electric motor 22c and the output mechanism 14c, and the second clutch 233 is configured to transmit power between the second electric motor 22c and the output mechanism 14c.

In this example, an electric motor assembly 20c further includes a transmission member 24, and the transmission member 24 is drivingly connected to a first rotor shaft 211c and a second rotor shaft 221c. The transmission member 24 is connected to an output shaft 141c, where the transmission member 24 does not move relative to the output shaft 141c. In this example, the first clutch 232 is disposed between the transmission member 24 and the first rotor shaft 211c. The first clutch 232 is a one-way transmission assembly. In this example, the first clutch 232 is a one-way bearing. The second clutch 233 is disposed between the transmission member 24 and the second rotor shaft 221c. The second clutch 233 is a one-way transmission assembly. In this example, the second clutch 233 is a one-way bearing. When the electric motor assembly 20c is controlled to enter the first working state, the first electric motor 21c is controlled to start working to drive, through the transmission member 24, the output shaft 141c to output power, and the one-way bearing 231 prevents the transmission member 24 from driving the second rotor shaft 221c to move. When the electric motor assembly 20c is controlled to enter the second working state, the second electric motor 22c is controlled to start and the first electric motor 21c is also controlled to start. The relative movement between the one-way bearing inner race and the one-way bearing outer race is locked. The first rotor shaft 211c and the second rotor shaft 221c simultaneously drive the output shaft 141c to rotate. In this example, the electric motor assembly 20c may further include a third working state, that is, the second electric motor 22c is controlled to start working to drive, through the transmission member 24, the output shaft 141c to output power, and the one-way bearing 231 prevents the transmission member 24 from driving the first rotor shaft 211c to move. In this case, only the second electric motor 22c drives the output shaft 141c.

In some alternative examples, at least one of the first electric motor and the second electric motor is an alternating current electric motor, and the clutch assembly includes the first clutch and the second clutch.

In some alternative examples, the clutch assembly includes one of the first clutch 232 and the second clutch 233. In some alternative examples, at least one of the first electric motor and the second electric motor is an alternating current electric motor, and the first electric motor is rigidly connected to the second electric motor. In some alternative examples, the first electric motor and the second electric motor are each a direct current electric motor, and the first electric motor is rigidly connected to the second electric motor.

As shown in FIG. 11, in some alternative examples, a first clutch 232g includes a first driving member and a first driven member, and a second clutch 233g includes a second driving member and a second driven member. The first clutch 232g has a first state and a second state. When the first clutch 232g is in the first state, the first driving member is disconnected from the first driven member. Thus, the power transmission between a first rotor shaft 211g and a transmission member 24g is disconnected. When the first clutch 232g is in the second state, the first driving member is engaged with the first driven member, and power is transmitted between the first rotor shaft 211g and the transmission member 24g. The second clutch 233g has a third state and a fourth state. When the second clutch 233g is in the third state, the second driving member is disconnected from the second driven member. Thus, the power transmission between a second rotor shaft 221g and the transmission member 24g is disconnected. When the second clutch 233g is in the fourth state, the second driving member is engaged with the second driven member, and power is transmitted between the second rotor shaft 221g and the transmission member 24g.

In some alternative examples, the connector includes a differential assembly that allows the first electric motor and the second electric motor to simultaneously output power to the output mechanism at different rotational speeds.

Part of the structures of the connector in the preceding examples may be used alone, or a combination of several technical solutions may be used.

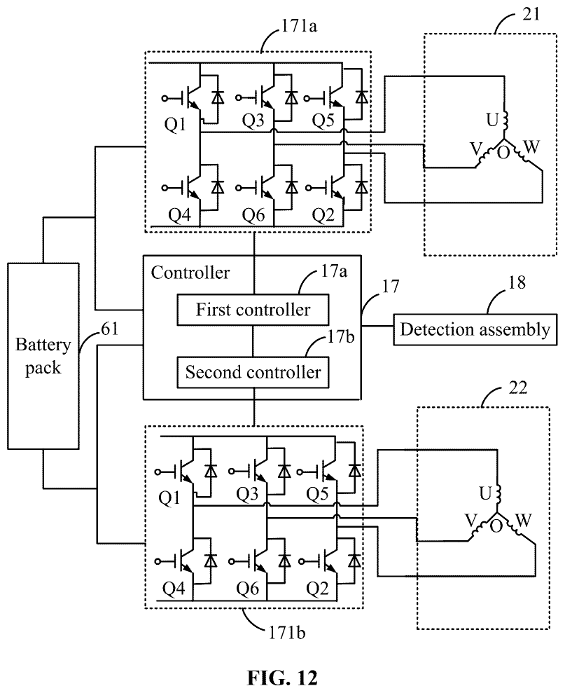

As shown in FIG. 12, the power tool further includes a controller 17 for controlling the electric motor assembly 20. The controller 17 is disposed on a control circuit board including a printed circuit board (PCB) and a flexible printed circuit (FPC) board. The controller 17 adopts a dedicated control chip, such as a single-chip microcomputer or a microcontroller unit (MCU). It is to be noted that the control chip may be integrated into the controller 17 or may be disposed independently of the controller 17. A structural relationship between a driver chip and the controller 17 is not limited in this example.

The controller 17 is configured to determine, according to a load parameter of the output mechanism and a load distribution coefficient of the electric motor assembly, an output parameter value of the first electric motor 21 and an output parameter value of the second electric motor 22 or the ratio of an output parameter of the first electric motor 21 to an output parameter of the second electric motor 22. The load distribution coefficient enables the total efficiency of the electric motor assembly 20 to be greater than or equal to the efficiency of the first electric motor 21 or the second electric motor 22 that works alone in response to the same load of the output mechanism. The load distribution coefficient enables the ratio of an efficiency interval of the electric motor assembly 20 greater than or equal to 70% to a total efficiency interval of the electric motor assembly 20 to be greater than or equal to 0.5. In this example, the load distribution coefficient ensures optimal efficiency distribution between the first electric motor and the second electric motor so that the total efficiency of the electric motor assembly 20 is optimal. The controller 17 determines a required parameter of the electric motor assembly 20 according to the load of the output shaft 141, where the required parameter includes at least one of required torque, a required rotational speed, and required power. The output parameter includes at least one of output torque, an output rotational speed, and output power, and the ratio of output parameters includes at least one of the ratio of output torque, the ratio of output rotational speeds, and the ratio of output power.

In this example, the required torque of the electric motor assembly is used as an example. According to a principle that the first electric motor 21 and the second electric motor 22 can be in the high efficiency intervals of operation of the electric motors, total required output torque is distributed to the first electric motor 21 and the second electric motor 22. An efficiency interval of the first electric motor 21, an efficiency interval of the second electric motor 22, and an efficiency interval of the electric motor assembly 20 are determined through table lookup or measured in advance, and through first-order, second-order, or higher-order operations or first-order, second-order, or higher-order derivatives, proportional coefficient values of the first electric motor and the second electric motor or a proportional coefficient set of the first electric motor and the second electric motor that maximizes the efficiency of the electric motor assembly 20 is obtained, which constitutes the load distribution coefficient of the electric motor assembly.

In some examples, the load distribution coefficient includes at least one of a load distribution coefficient of the first electric motor and a load distribution coefficient of the second electric motor. After the total required output torque of the electric motor assembly 20 is determined, the load distribution coefficient of the first electric motor is determined by looking up a load distribution coefficient table, and the required torque of the electric motor assembly 20 is multiplied by the load distribution coefficient of the first electric motor to obtain required torque of the first electric motor. Required torque of the second electric motor may be obtained by a difference between the required torque of the electric motor assembly 20 and the required torque of the first electric motor, by a product of the required torque of the electric motor assembly 20 and (1−the load distribution coefficient of the first electric motor), or by a product of the required torque of the electric motor assembly 20 and the load distribution coefficient of the second electric motor obtained by looking up the table.

In this example, the load distribution coefficient is stored in a memory unit of the controller 17. At least one of the load distribution coefficient of the first electric motor and the load distribution coefficient of the second electric motor is stored in the memory unit of the controller 17. In some examples, a correspondence relationship between the load distribution coefficient and the load parameter of the output mechanism and the load distribution coefficient are stored in the memory unit of the controller.

The load parameter of the output mechanism includes at least one of output torque, an output rotational speed, and an output current. Output torque of the first electric motor and output torque of the second electric motor are reasonably distributed according to a required load value and the load distribution coefficient to ensure a long high efficiency interval of the electric motor assembly. Meanwhile, the battery life and service life of a battery are guaranteed. Moreover, a control method of the present application is simple, reliable, and robust.

In some examples, the controller 17 is configured to configure, according to the load parameter of the output mechanism, the output parameter value of the first electric motor and the output parameter value of the second electric motor or the ratio of the output parameter of the first electric motor to the output parameter of the second electric motor so that the ratio of the efficiency interval of the electric motor assembly greater than or equal to 70% to the total efficiency interval of the electric motor assembly is greater than or equal to 0.5. That is to say, the controller 17 stores the efficiency interval of the first electric motor 21, the efficiency interval of the second electric motor 22, and the efficiency interval of the electric motor assembly 20 and determines the total required output torque of the electric motor assembly 20 according to the load parameter value or load value of the output shaft 141. According to the pre-stored efficiency interval of the first electric motor 21, efficiency interval of the second electric motor 22, and efficiency interval of the electric motor assembly 20, the controller 17 calculates, in real time, the output torque value of the first electric motor 21 and the output torque value of the second electric motor 22 that maximize the efficiency of the electric motor assembly. In some examples, the ratio of an efficiency interval of the electric motor assembly greater than or equal to 75% to the total efficiency interval of the electric motor assembly is made greater than or equal to 0.5.

A combination of the first electric motor capable of outputting the first torque and the first rotational speed and the second electric motor capable of outputting the second torque and the second rotational speed is used, the connector is used to selectively start the first electric motor, the second electric motor, or both the first electric motor and the second electric motor, and running states of the first electric motor and the second electric motor are controlled separately so that a torque range of the electric motor assembly where the efficiency is greater than or equal to 70% is greater than that of the first electric motor working alone or the second electric motor working alone, thereby expanding a high-efficiency output range of the power tool and enabling high-efficiency operation under various conditions. The torque range of the electric motor assembly where the efficiency is greater than or equal to 70% is the high efficiency interval of the electric motor assembly, where the high efficiency interval is long and accounts for a large proportion.

In this example, the controller 17 includes a first controller 17a and a second controller 17b, that is, dual-MCU control. The first controller 17a is connected to the first electric motor 21, and the second controller 17b is connected to the second electric motor 22. The first controller 17a is communicatively connected to the second controller 17b. In some examples, the first controller 17a and the second controller 17b may be combined into one controller 17, that is, single-MCU control, to control both the first electric motor 21 and the second electric motor 22. Alternatively, in some examples, more than two controllers are included, that is, multi-MCU control.

In this example, the controller 17 is configured to, when determining that the first electric motor 21 or the second electric motor 22 in the electric motor assembly 20 is started and the total required output torque of the electric motor assembly 20 is greater than first preset torque, switch the electric motor assembly 20 to startup of both the first electric motor 21 and the second electric motor 22. After a preset time since the first electric motor 21 and the second electric motor 22 are started, the output torque value of the first electric motor 21 and the output torque value of the second electric motor 22 or the ratio of the output torque of the first electric motor 21 to the output torque of the second electric motor 22 is controlled according to a first set parameter and the load distribution coefficient of the electric motor assembly. One of the first electric motor and the second electric motor is controlled through a first parameter set and the other of the first electric motor and the second electric motor is controlled through a second parameter set, where the first parameter set and the second parameter set have at least one different parameter. In this example, the first electric motor is controlled using the first parameter set, and the first parameter set includes the rotational speed and current of the electric motor. The electric motor adopts closed-loop control so that the electric motor is controlled more accurately. The second electric motor is controlled using the second parameter set, and the second parameter set includes the current of the electric motor. The electric motor adopts the closed-loop control so that the electric motor is controlled more accurately.

In this example, the controller 17 is configured to, when determining that both the first electric motor 21 and the second electric motor 22 in the electric motor assembly 20 are started and the total required output torque of the electric motor assembly 20 is less than second preset torque, switch the electric motor assembly 20 to startup of the first electric motor 21 or the second electric motor 22. In some examples, the controller 17 controls and selects, according to the load distribution coefficient of the electric motor assembly, the startup of the first electric motor 21 or the second electric motor 22 in the electric motor assembly 20. According to the principle that the first electric motor 21 or the second electric motor 22 can be in the high efficiency interval of operation of the electric motor, the first electric motor 21 or the second electric motor 22 is selected to start according to the load distribution coefficient corresponding to the total required output torque.

A second preset value is less than a first preset value to prevent too frequent switching between a single-electric motor working state and a dual-electric motor working state of the electric motor assembly.

In this example, the load distribution coefficient of the electric motor assembly is input into the memory unit of the controller 17. At least one of the efficiency interval of the first electric motor 21, the efficiency interval of the second electric motor 22, and the efficiency interval of the electric motor assembly 20 is input into the memory unit of the controller 17.

After receiving distributed target torque, the first controller 17a and the second controller 17b may control the corresponding electric motors by a preset method. In some examples, the first controller 17a and the second controller 17b adopt vector control. In some examples, the first controller 17a and the second controller 17b control the running of the electric motors by different control methods. For example, the first controller 17a adopts vector control and the second controller 17b adopts direct torque control. Alternatively, the first controller 17a adopts direct torque control and the second controller 17b adopts vector control. Alternatively, the first controller 17a adopts vector control and the second controller 17b adopts square wave control. Alternatively, the first controller 17a adopts square wave control and the second controller 17b adopts vector control. Alternatively, the first controller 17a adopts square wave control and the second controller 17b adopts direct torque control. Alternatively, the first controller 17a adopts direct torque control and the second controller 17b adopts square wave control. The square wave control is a traditional control technology and is not described in detail here. Under the square wave control, the controller 17 may adjust pulse-width modulation (PWM), a conduction angle, or a lead angle according to the distributed target torque.

As shown in FIG. 12, in this example, the first electric motor 21 and the second electric motor 22 are each a three-phase brushless motor. The three-phase brushless motor includes electronically commutated three-phase stator windings U, V, and W. In some examples, the three-phase stator windings U, V, and W adopt a start connection. In some other examples, the three-phase stator windings U, V, and W adopt a delta connection. In an example, other types of brushless motors are within the scope of the present application. The brushless motor may include less than or more than three phases.

The power tool further includes a driver circuit. The driver circuit is electrically connected to the stator windings U, V, and W of the electric motor and configured to transmit a current from the battery pack 61 to the stator windings U, V, and W to drive the electric motor to rotate. In this example, the power tool includes a first driver circuit 171a and a second driver circuit 171b. The first driver circuit 171a is connected to the first controller 17a and the battery pack 61, and the second driver circuit 171b is connected to the second controller 17b and the battery pack 61. With the first driver circuit 171a as an example, the first driver circuit 171a includes multiple switching elements Q1, Q2, Q3, Q4, Q5, and Q6. A gate terminal of each switching element is electrically connected to the first controller 17a and used for receiving a control signal from the first controller 17a. A drain or source of each switching element is connected to the stator windings U, V, and W of the first electric motor 21. The switching elements Q1 to Q6 receive control signals from the first controller 17a to change their respective on states, thereby changing the current loaded by the battery pack 61 to the stator windings U, V, and W of the first electric motor 21. In an example, the first driver circuit 171a may be a three-phase bridge driver circuit including six controllable semiconductor power devices (such as field-effect transistors (FETs), bipolar junction transistors (BJTs), or insulated-gate bipolar transistors (IGBTs)). In some examples, the driver circuit may include more than six controllable semiconductor power devices. In an example, the switching elements may be any other types of solid-state switches, such as the IGBTs or the BJTs.

The controller 17 (including the first controller 17a and the second controller 17b) specifically controls on or off states of the switching elements in the driver circuit through the control chip. In some examples, the controller controls the ratio of an on time of a drive switch to an off time of the drive switch based on a PWM signal.

The power tool further includes a detection assembly 18 for detecting the load parameter of the output mechanism. In this example, the load parameter is specifically a load parameter of the output shaft. The detection assembly 18 is formed on or connected to the controller 17. The detection assembly 18 detects a phase current, bus voltage, bus current, current holding time, demagnetization time, and other parameters in the driver circuit and sends these parameters to the controller 17 in the form of signals. In some examples, the detection assembly 18 detects the rotational speed of the electric motor, a commutation parameter of the electric motor, and the torque of the electric motor and sends them to the controller 17 in the form of signals.

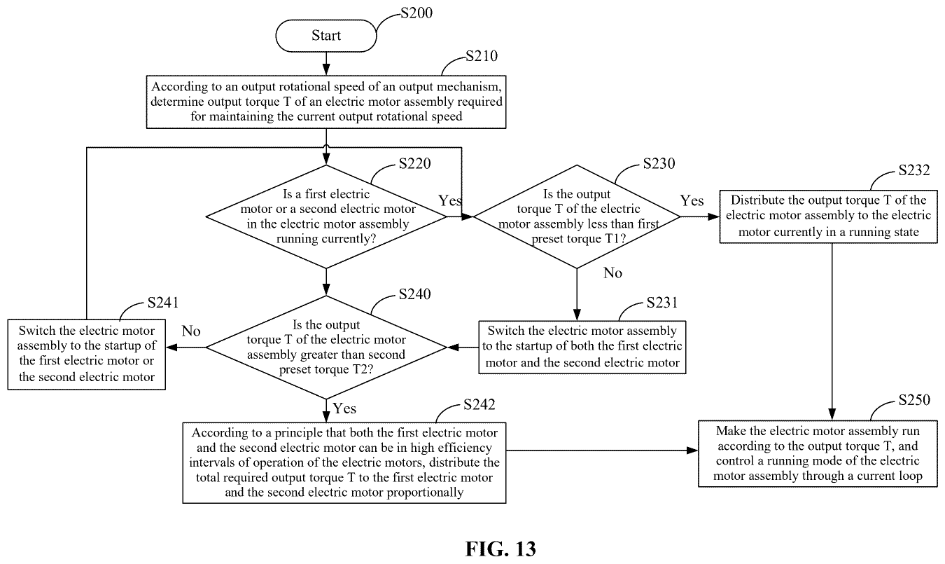

FIG. 13 shows a control method for the power tool. The power tool includes the electric motor assembly 20 and the output mechanism 14 driven by the electric motor assembly 20, and the electric motor assembly 20 includes the first electric motor 21 and the second electric motor 22. The control method specifically includes the steps below.

In S200, the method starts.

In S210, according to an output rotational speed of the output mechanism, output torque T of the electric motor assembly 20 required for maintaining the current output rotational speed is determined.

In S220, it is determined that the first electric motor 21 or the second electric motor 22 in the electric motor assembly 20 is running currently. If so, S230 is performed. If not, S240 is performed.

The controller 17 determines, according to an electrical parameter such as a current or a voltage or a physical parameter, whether the electric motor assembly 20 is currently in single electric motor operation or dual electric motor operation.

In S230, it is determined that the output torque T of the electric motor assembly 20 is less than first preset torque T1. If so, S232 is performed. If not, S231 is performed.

The controller 17 pre-stores the appropriate first preset torque T1 as a threshold and compares the first preset torque T1 with the real-time output torque T.

In S231, the electric motor assembly 20 is switched to the startup of both the first electric motor 21 and the second electric motor 22, and S240 is performed.

After a preset time since the startup of both the first electric motor and the second electric motor is switched to, S240 is performed. Then, a dual electric motor control process begins. The preset time is a time for the electric motor to run stably and may be one or more commutation cycles of the electric motor or one or more complete waveform cycles of the current of the electric motor.

In S232, the output torque T of the electric motor assembly 20 is distributed to the electric motor currently in a running state.

In S250, the electric motor assembly 20 runs according to the output torque T, and a running mode of the electric motor assembly 20 is controlled through a current loop.

In S240, it is determined that the output torque T of the electric motor assembly 20 is greater than second preset torque T2. If so, S242 is performed. If not, S241 is performed.

In S241, the electric motor assembly 20 is switched to the startup of the first electric motor 21 or the second electric motor 22, and S230 is performed.

After the preset time since the startup of the first electric motor or the second electric motor, that is, the startup of a single electric motor, is switched to, S230 is performed. Then, a single electric motor control process begins. The preset time is a time for the electric motor to run stably and may be one or more commutation cycles of the electric motor or one or more complete waveform cycles of the current of the electric motor.

In S242, the total required output torque is distributed to the first electric motor 21 and the second electric motor 22 according to the output torque T of the electric motor assembly 20 and the load distribution coefficient of the electric motor assembly, and S250 is performed.

The load distribution coefficient ensures the optimal efficiency distribution between the first electric motor and the second electric motor so that the total efficiency of the electric motor assembly 20 is optimal. The ratio of the efficiency interval of the electric motor assembly 20 greater than or equal to 70% to the total efficiency interval of the electric motor assembly 20 is greater than or equal to 0.5. The total efficiency of the electric motor assembly 20 is greater than or equal to the efficiency of the first electric motor 21 or the second electric motor 22 in response to the same load of the output mechanism. The load distribution coefficient of the electric motor assembly 20 is obtained through table lookup. The efficiency interval of the first electric motor 21 and/or the efficiency interval of the second electric motor 22 and/or the efficiency interval of the electric motor assembly 20 are acquired by a table lookup method.

In some examples, the power tool switches the running mode of the electric motor assembly 20 using a mechanical structure. For example, the power tool may further include a mode switching switch for the user to operate, and the mode switching switch is connected to a control mechanism to switch the electric motor assembly 20 to the first working state or the second working state. In this manner, the user can autonomously operate the mode switching switch so that the user can autonomously control the electric motor assembly 20 to be in the first working state or the second working state. The controller 17 may identify the working state of the electric motor assembly 20 according to a signal sent by the mode switching switch. The user may autonomously control the working state of the electric motor assembly 20 by operating the mode switching switch so that the working state can be switched according to different requirements of the user, thereby improving the applicability of the power tool.

In some examples, a connecting member of the power tool switches the electric motor assembly 20 to the first working state or the second working state through a mechanical structure. For example, the connecting member is a one-way transmission structure, and at least one of the first electric motor 21 and the second electric motor 22 implements a rotational speed balance or torque balance with the one-way transmission structure. That is to say, for example, the one-way transmission structure operates synchronously with the second electric motor 22, and the one-way transmission structure is connected to the second electric motor 22 and is directly provided with a rotational speed balancing member. When the rotational speed of the second electric motor 22 exceeds a balanced rotational speed, the one-way transmission structure releases a limitation on the first electric motor 21 so that the first electric motor 21 and the second electric motor 22 rotate together. It is to be understood that a balanced state may also be achieved through torsion or a centrifugal force, which does not affect the substantive content of the present application.

In some examples, the power tool includes both a mechanical mechanism and an electronic control mechanism for switching the working state of the electric motor assembly 20. Before the power tool is started, the controller 17 cannot control the working state of the electric motor assembly 20. In this case, the user may select an appropriate working state through the mode switching switch, that is, select the startup of the first electric motor 21 or the second electric motor 22 or the startup of both the first electric motor and the second electric motor. After the power tool is started, the controller 17 is powered on to control the working state of the power tool.

Part of the technical solutions in the preceding examples may be used alone, or a combination of several technical solutions may be used, so as to improve the efficiency of the electric motor according to actual requirements.

It is to be interpreted that the “motor efficiency” refers to the ratio of output power (mechanical) to input power (electrical) and is generally expressed as a percentage. The output power (mechanical) is calculated using the required torque and speed. The input power (electrical) is calculated using the voltage and current supplied to the electric motor.

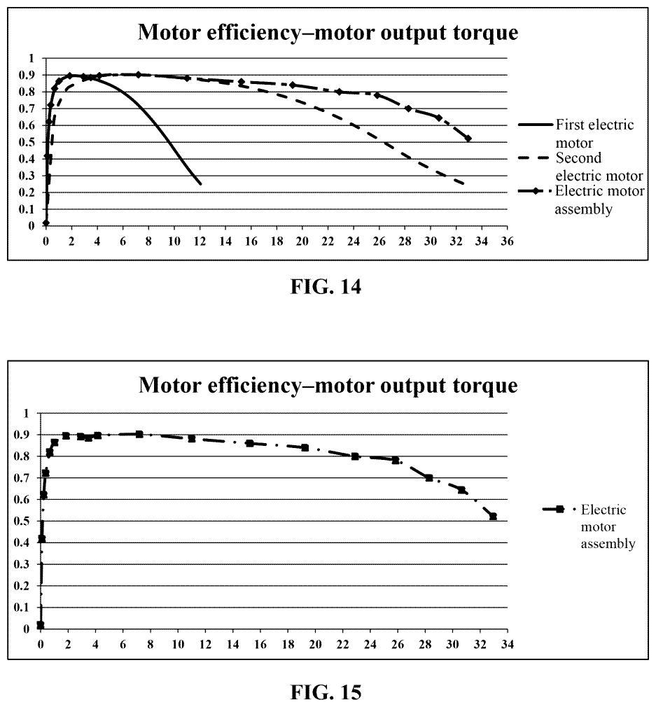

FIG. 14 is a graph showing motor efficiency and motor output torque of a first electric motor 21, a second electric motor 22, and an electric motor assembly 20 according to an example. The first electric motor 21 has low output torque. In the related art, the electric motor with low output torque has the following parameters: the outrunner has an outer diameter of φ 105 mm and a stack length of 15 mm, the stator windings of the electric motor have a wire diameter of φ 0.5 mm, 6 wires are wound in parallel, the number of turns is 18T, and a maximum value of the output torque is 12 N·m. It is to be interpreted that the “outer diameter of the electric motor” refers to the outer diameter of the entire electric motor. The “stack length of the electric motor” refers to the length of the stator core.

When a load is applied, that is, when the output torque is less than or equal to 1.86 N·m, the motor efficiency gradually increases. When the output torque reaches a first torque value (in this example, the first torque value is 0.37 N·m), the motor efficiency reaches 70% or more. When the output torque reaches a second torque value (in this example, the second torque value is 0.5 N·m), the motor efficiency reaches 75% or more. When the output torque is in a first maximum efficiency interval (greater than or equal to 1.86 N·m and less than or equal to 2.92 N·m in this example), the motor efficiency remains the highest. When the output torque exceeds a limit value of the first maximum efficiency interval (2.92 N·m in this example), the motor efficiency begins to decrease. When the output torque exceeds a third torque value (in this example, the third torque value is 6.9 N·m), the motor efficiency is less than 75%. When the output torque exceeds a fourth torque value (in this example, the fourth torque value is 7.7 Nm), the motor efficiency is less than 70%. In this example, for the electric motor with low output torque, an output torque interval where the motor efficiency is greater than 50% is greater than or equal to 0.2 N·m and less than or equal to 9.3 N·m. A first output torque interval where the motor efficiency is greater than 70% is greater than or equal to the first torque value (0.37 N·m) and less than or equal to the fourth torque value (7.7 N·m). An output torque interval where the motor efficiency is greater than 75% is greater than or equal to the second torque value (0.5 N·m) and less than or equal to the third torque value (6.9 N·m).

The second electric motor 22 has high output torque. In this example, the electric motor with high output torque has the following parameters: the outrunner has an outer diameter of φ 105 mm and a stack length of 40 mm, the stator windings of the electric motor have a wire diameter of φ 0.63 mm, 9 wires are wound in parallel, the number of turns is 7T, and a maximum value of the output torque is 33 N·m.

When the output torque reaches a fifth torque value (in this example, the fifth torque value is 0.99 N·m), the motor efficiency reaches 70% or more. When the output torque reaches a sixth torque value (in this example, the sixth torque value is 1.1 N·m), the motor efficiency reaches 75% or more. When the output torque is in a second maximum efficiency interval (greater than or equal to 4.17 N·m and less than or equal to 11.0 N·m in this example), the motor efficiency remains the highest. When the output torque exceeds a limit value of the second maximum efficiency interval (11.0 N·m in this example), the motor efficiency begins to decrease. When the output torque exceeds a seventh torque value (in this example, the seventh torque value is 19.2 N·m), the motor efficiency is less than 75%. When the output torque exceeds an eighth torque value (in this example, the eighth torque value is 21 N·m), the motor efficiency is less than 70%. In this example, for the electric motor with high output torque, an output torque interval where the motor efficiency is greater than 50% is greater than or equal to 0.5 N·m and less than or equal to 25.8 N·m. A second output torque interval where the motor efficiency is greater than 70% is greater than or equal to the fifth torque value (0.99 N·m) and less than or equal to the eighth torque value (21 N·m). An output torque interval where the motor efficiency is greater than 75% is greater than or equal to the sixth torque value (1.1 N·m) and less than or equal to the seventh torque value (19.2 N·m).

FIGS. 14 and 15 are graphs showing motor efficiency and motor output torque of the electric motor assembly 20. When the electric motor assembly 20, that is, a combination of the first electric motor 21 and the second electric motor 22 is used, when the output torque reaches the first torque value (in this example, the first torque value is 0.37 N·m), the motor efficiency reaches 70% or more. When the output torque reaches the second torque value (in this example, the second torque value is 0.5 N·m), the motor efficiency reaches 75% or more. When the output torque is in a third maximum efficiency interval (greater than or equal to 1.86 N·m and less than or equal to 11.0 N·m in this example), the motor efficiency remains the highest. When the output torque exceeds the limit value of the second maximum efficiency interval (11.0 N·m in this example), the motor efficiency begins to decrease. When the output torque is greater than the seventh torque value (in this example, the seventh torque value is 19.2 N·m), the motor efficiency is still greater than 75%. When the output torque exceeds the eighth torque value (in this example, the eighth torque value is 21 N·m), the motor efficiency is still greater than 70%. In this example, for the electric motor assembly 20, an output torque interval where the motor efficiency is greater than 50% is greater than or equal to 0.2 N·m and less than or equal to 25.8 N·m. When the output torque of the electric motor assembly is greater than or equal to the first torque value (0.37 N·m) and less than or equal to the eighth torque value (21 N·m), working efficiency of the electric motor assembly is greater than or equal to 70%.

In this example, it is defined that when the working efficiency of the electric motor assembly is greater than or equal to 70%, the electric motor assembly is in a third output torque interval, where the third output torque interval covers at least the first output torque interval and the second output torque interval. In this example, a right limit value of the third output torque interval is greater than the eighth torque value. The combination of the first electric motor capable of outputting the first torque and the first rotational speed and the second electric motor capable of outputting the second torque and the second rotational speed is used, and the connector is used to selectively start the first electric motor, the second electric motor, or both the first electric motor and the second electric motor so that the torque range of the electric motor assembly where the efficiency is greater than or equal to 70% is greater than that of the first electric motor working alone or the second electric motor working alone, thereby expanding the high-efficiency output range of the power tool and enabling the high-efficiency operation under various conditions.

When the output torque of the electric motor assembly is greater than or equal to the second torque value (0.5 N·m) and less than or equal to the seventh torque value (19.2 N·m), the motor efficiency of the electric motor assembly is greater than 75%.

When the first electric motor 21 and the second electric motor 22 work simultaneously, a maximum value of the output torque of the first electric motor 21 and the second electric motor 22 is greater than or equal to a sum of maximum output torque of the first electric motor and maximum output torque of the second electric motor.

Limit values of efficiency of the electric motor assembly 20 constitute the total efficiency interval, and efficiency values of the electric motor assembly 20 greater than or equal to 70% constitute the first efficiency interval, where the ratio of the first efficiency interval to the total efficiency interval is greater than or equal to 0.5. In other examples, the ratio of the first efficiency interval to the total efficiency interval is greater than or equal to 0.6. In other examples, the ratio of the first efficiency interval to the total efficiency interval is greater than or equal to 0.7. In other examples, the ratio of the first efficiency interval to the total efficiency interval is greater than or equal to 0.8. In other examples, the ratio of the first efficiency interval to the total efficiency interval is greater than or equal to 0.9. Efficiency values of the electric motor assembly 20 greater than or equal to 50% constitute a second efficiency interval, where the ratio of the first efficiency interval to the second efficiency interval is greater than or equal to 0.4. In other examples, the ratio of the first efficiency interval to the second efficiency interval is greater than or equal to 0.5. In other examples, the ratio of the first efficiency interval to the second efficiency interval is greater than or equal to 0.6. In other examples, the ratio of the first efficiency interval to the second efficiency interval is greater than or equal to 0.7. A proportion of the high efficiency interval of the electric motor assembly is increased.

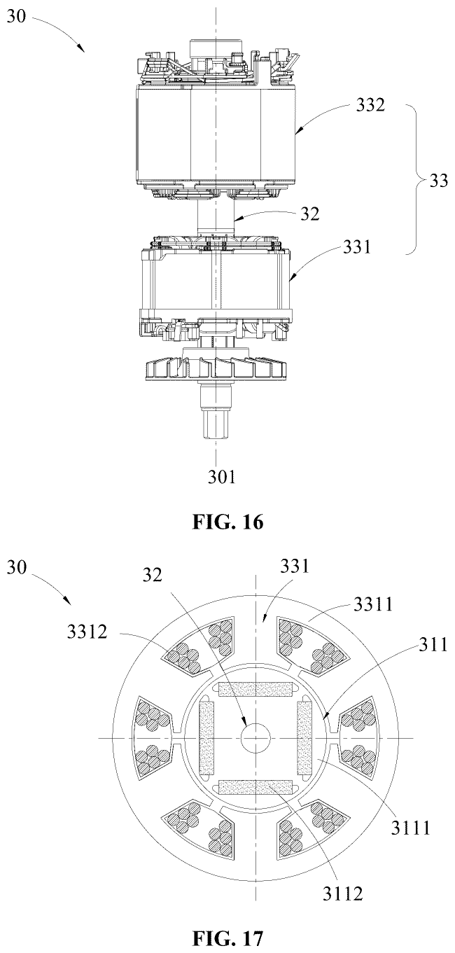

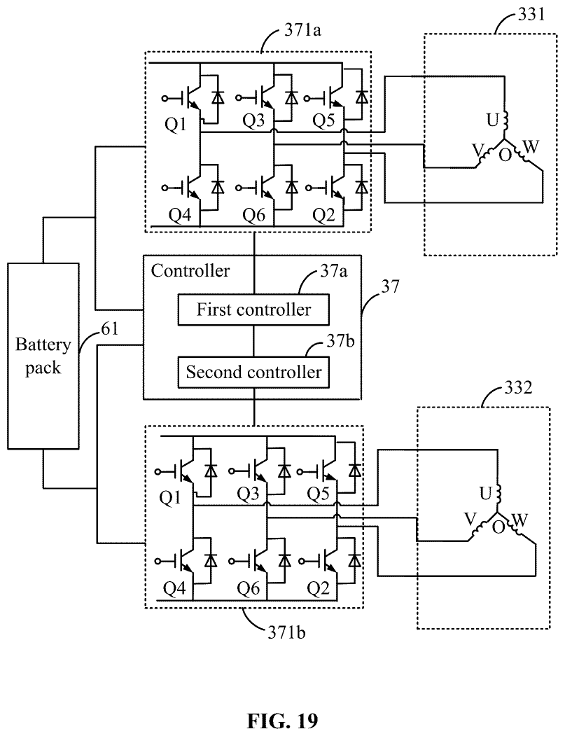

As shown in FIGS. 16 to 19, a power tool is disclosed in this example. Components of this example the same as or corresponding to those of example one use the corresponding reference numerals or names in example one. For simplicity, only differences between example two and example one are described. A difference between the power tool of this example and that of example one lies in the structure of an electric motor.

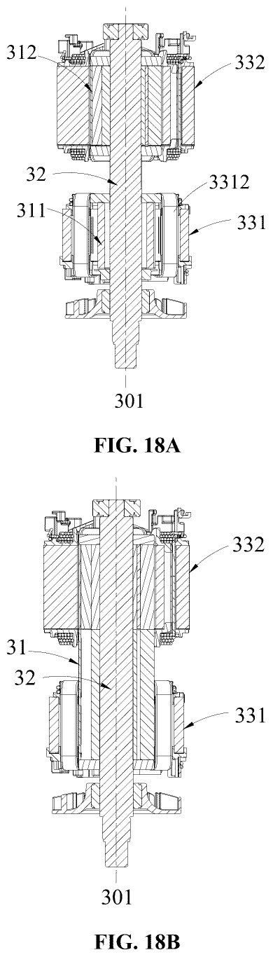

In this example, the power tool includes an electric motor 30. The electric motor 30 includes a rotor assembly 31 and a stator assembly 33. For an outrunner, a rotor is sleeved on the outer side of a stator. For an inrunner, the stator is sleeved on the outer side of the rotor. In this example, the electric motor 30 is the inrunner. The rotor assembly 31 includes at least one rotor body. As shown in FIG. 18A, the rotor assembly includes a first rotor 311 and a second rotor 312, and the first rotor 311 and the second rotor 312 are disposed at two ends of a rotor shaft 32 one to one. The rotor shaft 32 is formed on or connected to the first rotor 311 or the second rotor 312. Structural forms of the first rotor 311 and the second rotor 312 are basically the same. With the first rotor 311 as an example, as shown in FIG. 17, the first rotor 311 includes a rotor core 3111 and permanent magnets 3112 on the rotor core 3111, where the permanent magnets 3112 are arranged at intervals along a circumferential direction of the rotor core 3111 and configured to generate a magnetic field. The rotor shaft 32 is formed on or connected to the first rotor 311 and configured to output power, and the rotor shaft 32 rotates around a first axis 301. In this example, the first rotor 311 and the second rotor 312 may have the same or different dimensional characteristics. For example, the first rotor 311 and the second rotor 312 may have different numbers of permanent magnets, or the first rotor 311 and the second rotor 312 may have different diameters of the rotor core. Specific dimensions and values may be set according to actual situations and are not specifically limited here.

The stator assembly 33 includes a first stator 331 and a second stator 332. Structural forms of the first stator 331 and the second stator 332 are basically the same. With the first stator 331 as an example, the stator includes a stator core 3311 and coil windings 3312 on the stator core 3311, where the coil windings 3312 are windings of conductive metal, such as copper windings. In this example, the first stator 331 and the second stator 332 each include electronically commutated three-phase stator windings U, V, and W. In some examples, the three-phase stator windings U, V, and W adopt a start connection. In some other examples, the three-phase stator windings U, V, and W adopt a delta connection. However, in an example, other types of stator windings are within the scope of the present application. The stator windings may include less than or more than three phases.

The power tool further includes a controller 37 and a driver circuit. The controller 37 is configured to control the electric motor 30, that is, control energized states of the first stator and the second stator. The driver circuit is electrically connected to the stator windings U, V, and W and configured to transmit a current from a battery pack 61 to U, V, and W of the stator windings 3312 to drive the electric motor to rotate. The driver circuit includes multiple switching elements Q1, Q2, Q3, Q4, Q5, and Q6. A gate terminal of each switching element is electrically connected to the controller 37 and configured to receive a control signal from the controller 37. A drain or source of each switching element is connected to the stator windings U, V, and W. The switching elements Q1 to Q6 receive control signals from the controller 37 to change their respective on states, thereby changing the current loaded by the battery pack 61 to the stator windings U, V, and W. In an example, the driver circuit may be a three-phase bridge driver circuit including six controllable semiconductor power devices (such as FETs, BJTs, or IGBTs). In some examples, the driver circuit may include more than six controllable semiconductor power devices. In an example, the switching elements may be any other types of solid-state switches, such as the IGBTs or the BJTs.

The controller 37 is disposed on a control circuit board including a printed circuit board (PCB) and a flexible printed circuit (FPC) board. The controller 37 adopts a dedicated control chip, for example, a single-chip microcomputer or an MCU. It is to be noted that the control chip may be integrated into the controller 37 or may be disposed independently of the controller 37. A structural relationship between a driver chip and the controller 37 is not limited in this example.

Specifically, the controller 37 controls on or off states of the switching elements in the driver circuit through the control chip. In some examples, the controller 37 controls the ratio of an on time of a drive switch to an off time of the drive switch based on a PWM signal. The driver circuit includes a first driver circuit 371a and a second driver circuit 371b. The first driver circuit 371a is connected to the first stator 331, and the second driver circuit 371b is connected to the second stator 332. The controller 37 controls both the first driver circuit 371a and the second driver circuit 371b according to a setting. In some examples, the controller 37 includes a first controller 37a and a second controller 37b which are connected to the first driver circuit 371a and the second driver circuit 371b, respectively.

In this example, the controller 37 is configured to determine the energized states of the first stator 331 and the second stator 332 according to a principle of optimal efficiency and a load of an output mechanism. In this manner, no matter which load condition the power tool is under, the electric motor can be distributed with appropriate input power and output appropriate output torque. The working efficiency under all conditions can be improved.

In this example, the first stator 331 and the second stator 332 have at least one different structural parameter, such as at least one of the outer diameter of the stator core, the inner diameter of the stator core, the thickness of a stator pole, and a parameter of a coil winding. Therefore, when the first stator 331 and the second stator 332 are energized alone, the electric motor 30 has different output load ranges. For example, when the first stator 331 is energized and the second stator 332 is de-energized, the electric motor 30 is in a first working state corresponding to a light load state. When the first stator 331 is de-energized and the second stator 332 is energized, the electric motor 30 is in a second working state corresponding to a medium load state. When the first stator 331 is energized and the second stator 332 is energized, the electric motor 30 is in a third working state corresponding to a heavy load state.

Limit values of motor efficiency of the electric motor 30 in all the working states constitute a total efficiency interval, and efficiency values of the electric motor 30 greater than or equal to 70% constitute a first efficiency interval, where the ratio of the first efficiency interval to the total efficiency interval is greater than or equal to 0.5. In other examples, the ratio of the first efficiency interval to the total efficiency interval is greater than or equal to 0.6. In other examples, the ratio of the first efficiency interval to the total efficiency interval is greater than or equal to 0.7. In other examples, the ratio of the first efficiency interval to the total efficiency interval is greater than or equal to 0.8. In other examples, the ratio of the first efficiency interval to the total efficiency interval is greater than or equal to 0.9. The electric motor including the first stator and the second stator is disposed, and the first stator and the second stator are in different energized and de-energized states to set different working states so that the ratio of the efficiency interval of the electric motor greater than or equal to 70% to the total efficiency interval is greater than or equal to 0.5, thereby expanding a high-efficiency output range of the power tool and enabling high-efficiency operation under various conditions. A torque range of the electric motor assembly where the efficiency is greater than or equal to 70% is a high efficiency interval of the electric motor assembly, where the high efficiency interval is long and accounts for a large proportion.

In some examples, the limit values of motor efficiency of the electric motor 30 in all the working states constitute the total efficiency interval, and efficiency values of the electric motor 30 greater than or equal to 75% constitute a third efficiency interval, where the ratio of the third efficiency interval to the total efficiency interval is greater than or equal to 0.5. In other examples, the ratio of the third efficiency interval to the total efficiency interval is greater than or equal to 0.6. In other examples, the ratio of the third efficiency interval to the total efficiency interval is greater than or equal to 0.7. In other examples, the ratio of the third efficiency interval to the total efficiency interval is greater than or equal to 0.8. In other examples, the ratio of the third efficiency interval to the total efficiency interval is greater than or equal to 0.9.

In some examples, the first stator 331 and the second stator 332 are disposed one behind the other in an axial direction. The first stator 331 and the second stator 332 do not overlap in the axial direction.

The stator assembly 33 and the rotor assembly 31 are arranged with the first axis 301 as a central axis, that is, the stator assembly 33 and the rotor assembly 31 are coaxially arranged. The first stator 331 and the second stator 332 are coaxially arranged. In some examples, the first stator 331 and the second stator 332 are coaxially sleeved, that is, the first stator 331 and the second stator 332 are an inner stator and an outer stator, respectively. The first stator 331 includes a core of the first stator 331 and windings of the first stator 331, the second stator 332 includes a core of the second stator 332 and windings of the second stator 332, the number of slots of the first stator 331 is consistent with that of the second stator 332, the center of the slots of the first stator 331 corresponds to that of the second stator 332, and the center of teeth of the first stator 331 corresponds to that of the second stator 332. The driver circuit is electrically connected to the windings of the first stator 331 and the windings of the second stator 332. The windings of the first stator 331 and the windings of the second stator 332 are each controlled to be energized or de-energized so that the first stator 331 and the second stator 332 are each controlled to be energized or de-energized.

As shown in FIG. 18B, in some alternative examples, the rotor assembly 31 is an integral structure.

The electric motor 30 has two sets of stator windings. Each set of windings has a common three-phase structure so that the two sets of windings have multiple connection manners, for example, three common connection manners which are a series connection, a parallel connection, and independent control, respectively. Under a given bus voltage, if the electric motor 30 needs to work at a low speed and with high torque, that is, in a heavy load state, the windings need to be connected in series. If the electric motor 30 needs to work at a high speed and in a light load state, the windings need to be connected in parallel to reduce an internal back electromotive force and achieve speed expansion. If the electric motor works with relatively high safety and reliability, six-phase windings are independently controlled to increase phase redundancy. The switching between working modes may be implemented by a switch to achieve transitions during operation.

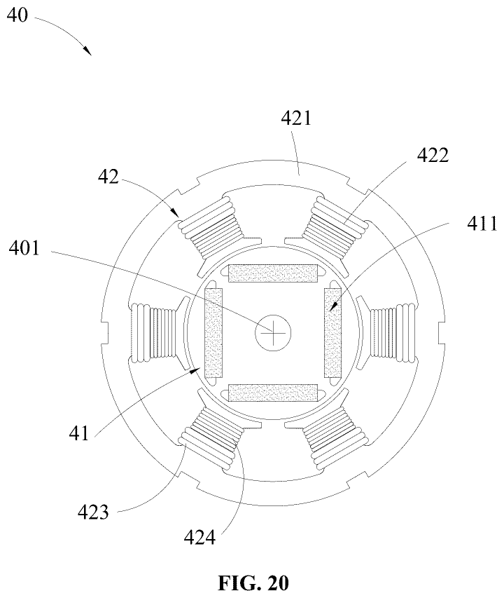

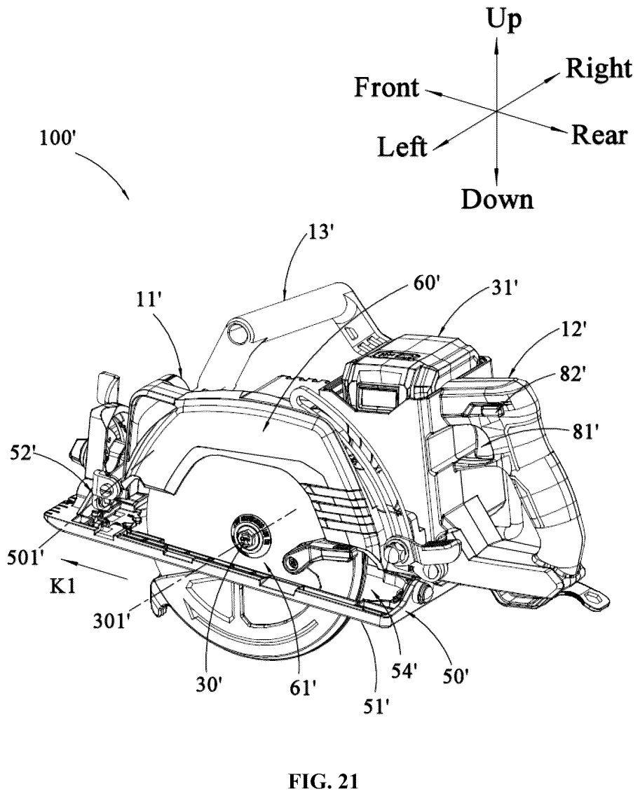

As shown in FIG. 20, a power tool is disclosed in this example. Components of this example the same as or corresponding to those of example one use the corresponding reference numerals or names in example one. For simplicity, only differences between example three and example one are described. A difference between the power tool of this example and that of example one lies in the structure of an electric motor.

An electric motor 40 includes a rotor 41 and a stator 42. The rotor 41 rotates around a first axis 401. The stator 42 includes a ring yoke portion 421, tooth portions 422, first windings 423, and second windings 424. The tooth portions 422 are formed on or connected to the ring yoke portion 421. The tooth portions 422 protrude from the inner side or outer side of the ring yoke portion 421. Multiple tooth portions 422 are provided. The first windings 423 are wound around the multiple tooth portions 422 and configured to generate a first magnetic field. The second windings 424 are wound around the multiple tooth portions 422 and configured to generate a second magnetic field. A battery pack 61 supplies power to the first windings 423 and the second windings 424. A first winding 423 and a second winding 424 are arranged along a radial direction of the first axis 401. The electric motor including the first windings and the second windings is disposed, the same power supply supplies power to the first windings and the second windings, and the first winding and the second winding are radially arranged so that each tooth portion of the stator includes the same winding form. The structure of the electric motor has high versatility, reducing a manufacturing cost. The number of tooth portions of the electric motor does not need to be additionally limited.

The battery pack 61 supplies power to the first windings 423 and the second windings 424. The nominal voltage of the power tool is greater than or equal to 18 V. The battery pack 61 supplies power to the first windings 423 and the second windings 424 in collaboration with a corresponding power supply circuit. In some examples, the nominal voltage of the power tool is greater than or equal to 36 V and less than or equal to 56 V. In some examples, the nominal voltage of the power tool is greater than 56 V and less than or equal to 120 V.

The power tool further includes a controller and a driver circuit. The controller is configured to control the electric motor, that is, control energized states of the first windings 423 and the second windings 424. The driver circuit is electrically connected to the first windings 423 and the second windings 424. The driver circuit is electrically connected to the first windings U, V, and W and configured to transmit a current from the battery pack 61 to the first windings U, V, and W to drive the electric motor to rotate. The driver circuit is electrically connected to the second windings U, V, and W and configured to transmit a current from the battery pack 61 to the second windings U, V, and W to drive the electric motor to rotate. The driver circuit includes multiple switching elements Q1, Q2, Q3, Q4, Q5, and Q6. A gate terminal of each switching element is electrically connected to the controller and used for receiving a control signal from the controller. A drain or source of each switching element is connected to the windings U, V, and W. The switching elements Q1 to Q6 receive control signals from the controller to change their respective on states, thereby changing the current loaded by the battery pack 61 to the windings U, V, and W. In an example, the driver circuit may be a three-phase bridge driver circuit including six controllable semiconductor power devices (such as FETs, BJTs, or IGBTs). In some examples, the driver circuit includes more than six controllable semiconductor power devices. In an example, the switching elements may be any other types of solid-state switches, such as the IGBTs or the BJTs.

In this example, the controller is configured to determine the energized states of the first windings and the second windings according to a principle of optimal efficiency and a load of an output mechanism. In this manner, no matter which load condition the power tool is under, the electric motor can be distributed with appropriate input power and output appropriate output torque. The working efficiency under all conditions can be improved.

In this example, the first winding and the second winding have at least one different structural parameter, such as at least one of a wire diameter of the winding, the number of turns of the winding, the number of parallel wires of the winding, the shape of a cross-section of the winding, and a slot fill factor of the winding. Therefore, when the first windings 423 and the second windings 424 are energized alone, the electric motor has different output load ranges. For example, when the first windings 423 are energized and the second windings 424 are de-energized, the electric motor 40 is in a first working state corresponding to a light load state. When the first windings 423 are de-energized and the second windings 424 are energized, the electric motor 40 is in a second working state corresponding to a medium load state. When the first windings 423 are energized and the second windings 424 are energized, the electric motor 40 is in a third working state corresponding to a heavy load state. The first winding and the second winding are radially arranged and their different energized states may be controlled so that different output load states of the electric motor can be achieved, and the electric motor is applicable to more conditions.

The electric motor 40 further includes a detection circuit configured to detect energized and de-energized states of the first windings 423 and the second windings 424.

In this example, the electric motor 40 is a direct current brushless inrunner 40. Of course, the electric motor 40 may be an outrunner 40.

The rotor 41 is configured to rotate around the first axis 401. The rotor 41 is provided with permanent magnets 411 configured to generate a magnetic field, and permanent magnet slots are arranged at intervals along a circumferential direction of the first axis 401 and configured to hold the permanent magnets 411 capable of generating or inducing the magnetic field. The rotor 41 is sleeved within the stator 42 and a radial gap is formed between the rotor 41 and the stator 42.

The first windings 423 are configured to generate a first magnetic field under the action of the power supply and the second windings 424 are configured to generate a second magnetic field overlapping the first magnetic field under the action of the power supply. The first winding 423 and the second winding 424 are arranged along the radial direction of the first axis 401.

With the first winding 423 and the second winding 424 as an example, the first winding 423 and the second winding 424 are arranged in sequence on the same tooth portion 422 along the radial direction of the first axis 401. An insulating layer is disposed between the first winding 423 and the second winding 424 to isolate mutual interference of the two magnetic fields.

It is to be noted that the same tooth portion 422 here includes the same multiple tooth portions 422 and the same single tooth portion 422.

In this manner, several first windings 423 are connected to each other in series or in parallel to form three voltage input ends to be connected to the battery pack 61. Several second windings 424 are connected to each other in series or in parallel to form another three voltage input ends to be connected to an energy storage device.

In this example, the number of turns of the first winding 423 is different from the number of turns of the second winding 424. In some examples, the wire diameter of the first winding 423 is different from the wire diameter of the second winding 424. In some examples, the number of turns and the wire diameter of the first winding 423 are different from those of the second winding 424.

To clearly illustrate the technical solutions of the present application, an upper side and a lower side are defined in the drawings of the specification.

FIG. 21 shows a power tool in an example of the present application. The power tool includes an electric motor assembly 20′. In this example, the power tool is a circular saw 100′. In some examples, the power tool may be another cutting tool, such as a table saw, a miter saw, a marble cutter, a tile saw, or a chainsaw.

As shown in FIG. 21, the circular saw 100′ is used as an example. The circular saw 100′ is a handheld circular saw. Unless otherwise specified, directional terms, such as front, rear, left, right, up, and down, are the directions of the circular saw 100′ in normal use. For example, the forward direction of the circular saw 100′ is defined as the front, and the direction opposite to the forward direction of the circular saw 100′ is defined as the rear.

The circular saw 100′ includes a power supply 31′. In this example, the power supply 31′ is a direct current power supply. The direct current power supply provides electrical energy for the circular saw 100′. The direct current power supply includes at least one battery pack 31′ configured to provide a source of energy for the electric motor assembly 20′. The battery pack 31′ mates with the corresponding power circuit to supply power to the circular saw 100′. It is to be understood by those skilled in the art that the power supply is not limited to the direct current power supply, and the corresponding components in the machine may be powered through mains power or an alternating current power supply in conjunction with corresponding rectifier, filter, and voltage regulator circuits. In the subsequent description, the battery pack 31′ is used instead of the power supply 31′, which cannot be construed as limiting the present application.

The battery pack 31′ may be a lithium battery pack, a solid-state battery pack, or a pouch battery pack. In some examples, when the power supply includes multiple battery packs 31′, the battery packs 31′ may be of the same type or of different types. In some examples, the electrical parameters, structural parameters, and physical parameters of the multiple battery packs 31′ may be the same or different.

As shown in FIGS. 21 to 28, the circular saw 100′ further includes an output shaft 30′, a body housing 11′, the electric motor assembly 20′, a power transmission mechanism 40′, and a base plate 50′. The output shaft 30′ is used for mounting a cutting part 61′. The cutting part 61′ rotates about an output axis 301′. In this example, the cutting part 61′ is a circular saw blade. The electric motor assembly 20′ is configured to drive the output shaft 30′ to rotate. The power transmission mechanism 40′ is configured to transmit the output power of the electric motor assembly 20′ to the output shaft 30′. The body housing 11′ is configured to accommodate parts such as the electric motor assembly 20′ and the power transmission mechanism 40′, and the output shaft 30′ and the cutting part 61′ are disposed outside the body housing 11′. The base plate 50′ is movably connected to the body housing 11′, and the base plate 50′ is formed with a base plate bottom surface 51′ in contact with the workpiece. The base plate 50′ is formed with a saw blade through hole 54′ extending along a first direction K1, and the saw blade can pass through the saw blade through hole 54′ and protrude downward from the base plate bottom surface 51′.

The body housing 11′ includes a first housing 111′, and the first housing 111′ is formed with or connected to a grip 12′ for holding. The grip 12′ is located at the rear end of the circular saw 100′ and can be held by the user, thereby operating the circular saw 100′ to perform a cutting operation. In some examples, a control switch 81′ and a safety switch 82′ are further provided on the grip 12′, and the control switch 81′ can be triggered only when the safety switch 82′ is pressed. That is to say, two actions are required before the electric motor or electric motor assembly 20′ can be started. Therefore, the danger caused by a single operation is avoided. When the user holds the grip 12′, the hand of the user holding the grip 12′ can trigger the safety switch 82′ and the control switch 81′ to start or shut down the circular saw 100′. In an example, the first housing 111′ may be further formed with a second grip 13′. The second grip 13′ is located at the front end of the circular saw 100′ and is used as an auxiliary handle. In an example, the second grip 13′ may be an external handle mounted on the body housing 11′, that is to say, the second grip 13′ may be an auxiliary operating component mounted separately on the body housing 11′.

The circular saw 100′ further includes a guard assembly 60′. The guard assembly 60′ can at least partially surround the cutting part 61′ to protect the environment and the user. The guard assembly 60′ includes a fixed guard 62′ with an arc-shaped structure and a movable guard 63′ that rotates relative to the fixed guard 62′. The fixed guard 62′ is connected to the first housing 111′. The movable guard 63′ is sleeved in the fixed guard 62′ and can rotate about the output axis 301′ to be retracted into the fixed guard 62′. The output shaft 30′ extends into the fixed guard 62′, and the cutting part 61′ and the output shaft 30′ are detachably connected. In actual work, different types of cutting parts 61′ may be used according to the materials of the objects to be cut. The cutting part 61′ is disposed in the fixed guard 62′, almost the upper half of the outer circumference of the cutting part 61′ is covered by the fixed guard 62′, and the movable guard 63′ rotates in the fixed guard 62′ to cover or expose the lower half of the cutting part 61′. An opening part 64′ of the movable guard 63′ is provided between the movable guard 63′ and the fixed guard 62′. When the circular saw 100′ is used, the operator manually pushes the opening part 64′ to rotate the movable guard 63′ to expose part of the saw teeth.

The base plate 50′ is movably connected to the fixed guard 62′. In this example, a connection base 52′ is disposed on the front side of the base plate 50′, and the connection base 52′ is connected to the fixed guard 62′ via a pin 53′ so that the fixed guard 62′ can rotate relative to the base plate 50′. The axis on which the pin 53′ lies is defined as a pivot axis 501′. The pivot axis 501′ is parallel to the output axis 301′. When the fixed guard 62′ rotates about the pivot axis 501′ relative to the base plate 50′, the relative position between the fixed guard 62′ and the base plate 50′ changes so that the circular saw 100′ can have different depths of cut. The fixed guard 62′ is rotated by applying a force to the grip 12′ to rotate the grip 12′ relative to the base plate 50′, thereby driving the fixed guard 62′ to rotate relative to the base plate 50′. It is to be understood that in some examples, the pivot axis 501′ and the output axis 301′ may intersect or be perpendicular.

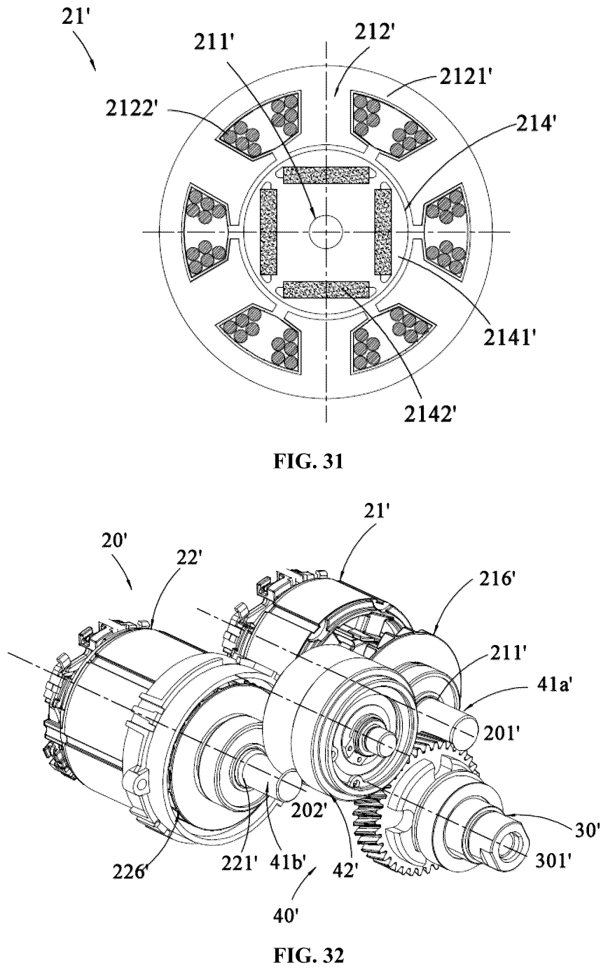

As shown in FIGS. 26 and 28, the electric motor assembly 20′ includes a first electric motor 21′ and a second electric motor 22′. The first electric motor 21′ includes a first drive shaft 211′ rotating about a first axis 201′. The second electric motor 22′ includes a second drive shaft 221′ rotating about a second axis 202′. Each of the first electric motor 21′ and the second electric motor 22′ includes a stator and a rotor. With the first electric motor 21′ as an example, as shown in FIG. 31, a stator 212′ includes a stator core 2121′ and stator windings 2122′. A rotor 214′ includes a rotor core 2141′ and permanent magnets 2142′. A drive shaft is formed on or connected to the rotor 214′ and configured to output power. For an outrunner, a rotor is sleeved on the outer side of a stator. For an inrunner, a stator is sleeved on the outer side of a rotor. In this example, the overall structure of the electric motor here is generally the same as that of a common brushless motor and is not described in detail here.

As shown in FIGS. 26 and 28, the power transmission mechanism 40′ is configured to transmit power of at least one of the first electric motor 21′ and the second electric motor 22′ to the output shaft 30′. The torque of the first drive shaft 211′ and the torque of the second drive shaft 221′ are outputted through the output shaft 30′. In this example, the first electric motor 21′ and the second electric motor 22′ work in coordination to output the torque of the electric motor assembly 20′ through the output shaft 30′, thereby outputting torque outward through the output shaft 30′. The electric circular saw of the present application is used as an example. The first electric motor 21′ and the second electric motor 22′ work in coordination so that the output shaft 30′ drives the cutting part 61′ to perform a cutting operation. In the related art, multiple electric motors drive the power tool. For example, in an outdoor traveling device or a wheeled device, multiple electric motors such as two electric motors are used for driving different output shafts or output portions, respectively. For example, in the related art, the first electric motor and the second electric motor are used for driving two or more drive gears or drive shafts, respectively. However, in this example, the electric motor assembly including multiple electric motors is used for driving the same output shaft, that is to say, the torque of the drive shafts of the multiple electric motors are all outputted through one output shaft. The torque transmission paths of the multiple electric motors have the same endpoint so that the high-efficiency working interval of the entire power tool can be improved, thereby enabling the power tool with only one output shaft to be efficiently driven using the multiple electric motors. Compared with multiple electric motors driving different output portions or output shafts, in the present application, the multiple electric motors are used for driving one output shaft, and more difficulties need to be overcome for the transmission coordination, power distribution, and drive structure of the electric motor assembly 20′ and the power transmission mechanism 40′.

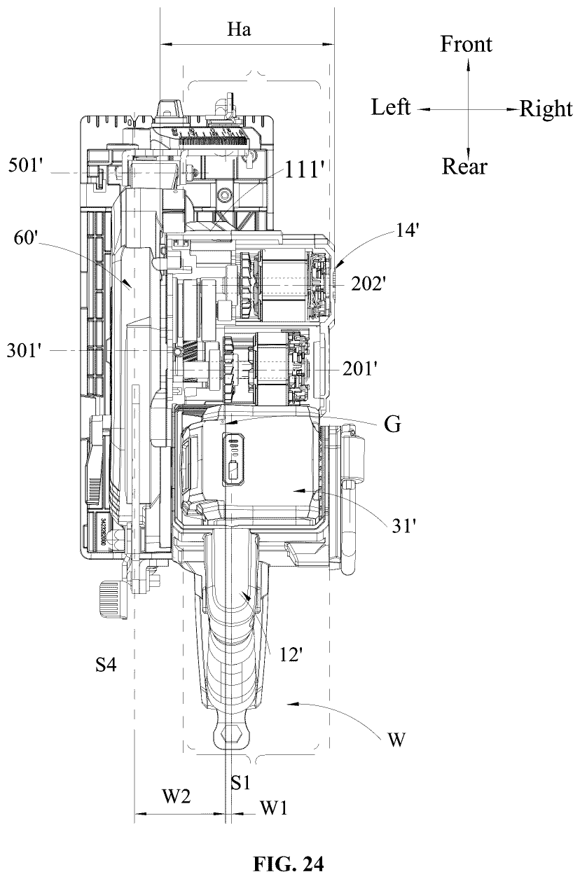

As shown in FIGS. 24 to 30, the first electric motor 21′ and the second electric motor 22′ are arranged along the radial direction, that is to say, the first drive shaft 211′ and the second drive shaft 221′ are arranged along the radial direction of the first drive shaft 211′. Alternatively, the first drive shaft 211′ and the second drive shaft 221′ are arranged along the radial direction of the second drive shaft 221′. In this example, the first drive shaft 211′ and the second drive shaft 221′ are parallel and do not coincide. In this example, the first drive shaft 211′ and the second drive shaft 221′ are both parallel to the output shaft 30′. In some alternative examples, the first drive shaft 211′ and the second drive shaft 221′ intersect or are perpendicular.

The body housing 11′ includes an accommodation housing 14′ configured to accommodate the electric motor assembly 20′. The accommodation housing 14′ is formed on or connected to the first housing 111′. In this example, the guard assembly 60′ and the accommodation housing 14′ are basically located on two sides of the first housing 111′. It is to be understood that the guard assembly 60′ is located on the left side of the first housing 111′, and the accommodation housing 14′ is located on the right side of the first housing 111′. In this example, the first housing 111′ and the accommodation housing 14′ are connected to each other. A through hole 1111′ for the accommodation housing 14′ to pass through is formed on the right sidewall of the first housing 111′. The power transmission mechanism 40′ is accommodated in the first housing 111′ and is located outside the accommodation housing 14′. In this manner, the arrangement of the components inside the body housing 11′ can be more reasonable.

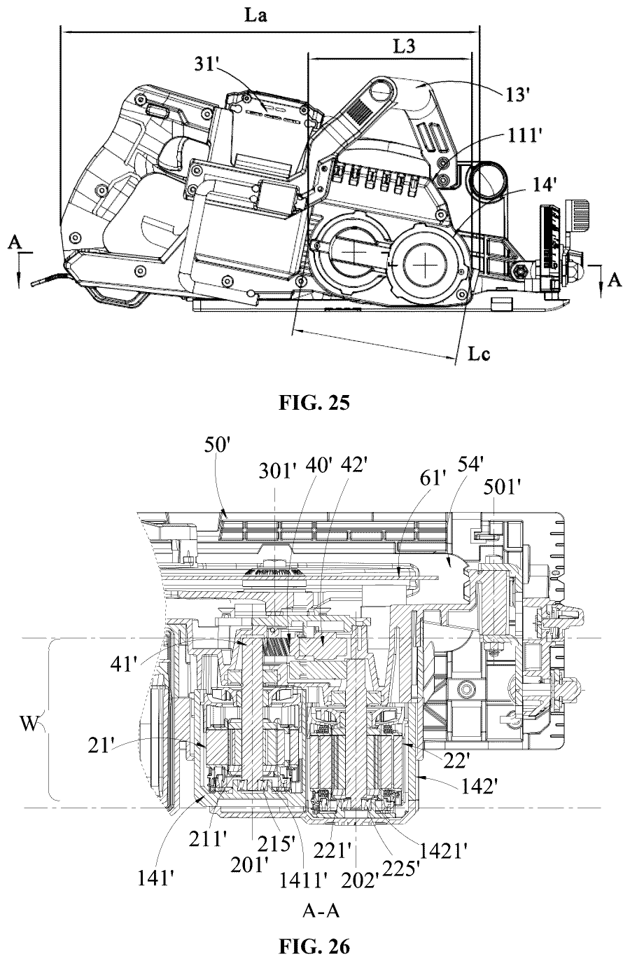

The accommodation housing 14′ includes a first accommodation portion 141′ for accommodating the first electric motor 21′ and a second accommodation portion 142′ for accommodating the second electric motor 22′. As shown in FIGS. 25 and 28, when the following orthographic projections are observed along the extension direction of the output shaft 301′, along the direction of the line connecting the projection of the first axis 201′ and the projection of the second axis 202′, the ratio of the outer dimension Lc of the projection of the accommodation housing 14′ to the outer diameter D1 or D2 of any one of the electric motors is greater than or equal to 1.1. In the case where the first electric motor 21′ and the second electric motor 22′ are used for mating with each other in controlling the output of the output shaft 30′, when the first electric motor 21′ and the second electric motor 22′ are non-coaxially arranged, to ensure that the first electric motor 21′ and the second electric motor 22′ can both be mounted stably, the dimension of the accommodation housing 14′ needs to be greater than 1.1 times the diameter of a single electric motor. In this manner, the relative position between the first electric motor 21′ and the second electric motor 22′ is reasonably set so that the space in which the first electric motor 21′ and the second electric motor 22′ can be mounted stably exists. On the other hand, the user can easily identify the difference between the product controlled by one electric motor and the product simultaneously controlled by the first electric motor 21′ and the second electric motor 22′.

In this example, the second electric motor 22′ is used as an example, the second electric motor 22′ is an inrunner, and the “outer diameter of the electric motor” is the outer diameter of the stator of the electric motor. The outer diameter of the second electric motor 21′ is D2. Along the direction of the line connecting the projection of the first axis 201′ and the projection of the second axis 202′, the ratio of the outer dimension Lc of the projection of the accommodation housing 14′ to the outer diameter D2 of the second electric motor 21′ is greater than or equal to 1.2, 1.4, 1.6, or 1.8. In some examples, along the direction of the line connecting the projection of the first axis 201′ and the projection of the second axis 202′, the ratio of the outer dimension Lc of the projection of the accommodation housing 14′ to the outer diameter D2 of the second electric motor 21′ is greater than or equal to 2. In some examples, along the direction of the line connecting the projection of the first axis 201′ and the projection of the second axis 202′, the ratio of the outer dimension Lc of the projection of the accommodation housing 14′ to the outer diameter D2 of the second electric motor 21′ is greater than or equal to 2.1 or 2.2. In this example, the first electric motor 21′ and the second electric motor 22′ have the same outer diameter. In terms of the arrangement positions, the first electric motor 21′ and the second electric motor 22′ are radially separated from each other. In this example, as shown in FIGS. 26 and 8, the first electric motor 21′ and the second electric motor 22′ do not overlap along a direction perpendicular to the base plate bottom surface 51′. In some examples, the first electric motor 21′ and the second electric motor 22′ do not overlap in the extension direction of the cutting part 61′, that is to say, no straight line that extends along the direction of the output axis 301′ and can pass through the first electric motor 21′ and the second electric motor 22′ at the same time exists.

In this example, the first electric motor 21′ and the second electric motor 22′ at least partially overlap in the direction of the output axis 301′. That is to say, at least a third straight line that is perpendicular to the output axis 301′ and passes through both the first electric motor 21′ and the second electric motor 22′ exists. In this manner, the electric motor assembly 20′ can be more compact in the direction of the output axis 301′. In this example, the outer dimension Lc of the projection of the accommodation housing 14′ along the direction of the line connecting the projection of the first axis 201′ and the projection of the second axis 202′ is greater than the outer dimension H1 of the accommodation housing 14′ along the direction of the output axis 301′, that is, the radial dimension of the accommodation housing 14′ is greater than the axial dimension of the accommodation housing 14′.

As shown in FIGS. 26 and 28, the first accommodation portion 141′ supports at least a first bearing portion 215′ of the first electric motor 21′, and the first bearing portion 215′ is on a side facing away from the output shaft 30′. The first bearing portion 215′ includes a ball bearing. The ball bearing supports an end of the first drive shaft 211′ facing away from the output shaft 30′. A first bearing seat 1411′ for supporting the ball bearing is disposed on the bottom surface of the first accommodation portion 141′. The second accommodation portion 142′ supports at least a second bearing portion 225′ of the second electric motor 22′, and the second bearing portion 225′ is on a side facing away from the output shaft 30′. The second bearing portion 225′ includes a ball bearing. The ball bearing supports an end of the second drive shaft 221′ facing away from the output shaft 30′. A second bearing seat 1421′ for supporting the ball bearing is disposed on the bottom surface of the second accommodation portion 142′. In this manner, the first electric motor 21′ and the second electric motor 22′ are stably mounted in the first accommodation portion 141′ and the second accommodation portion 142′, respectively.

In some alternative examples, the first electric motor 21′ and the second electric motor 22′ are configured to partially overlap in the radial direction, that is to say, at least a fourth straight line that is parallel to the output axis 301′ and passes through both the first electric motor 21′ and the second electric motor 22′ exists. In this manner, the electric motor assembly 20′ can be more compact in the radial direction. In this manner, in this case, the outer dimension Lc of the projection of the accommodation housing 14′ along the direction of the line connecting the projection of the first axis 201′ and the projection of the second axis 202′ may be less than or equal to the outer dimension H1 of the accommodation housing 14′ along the direction of the output axis 301′.

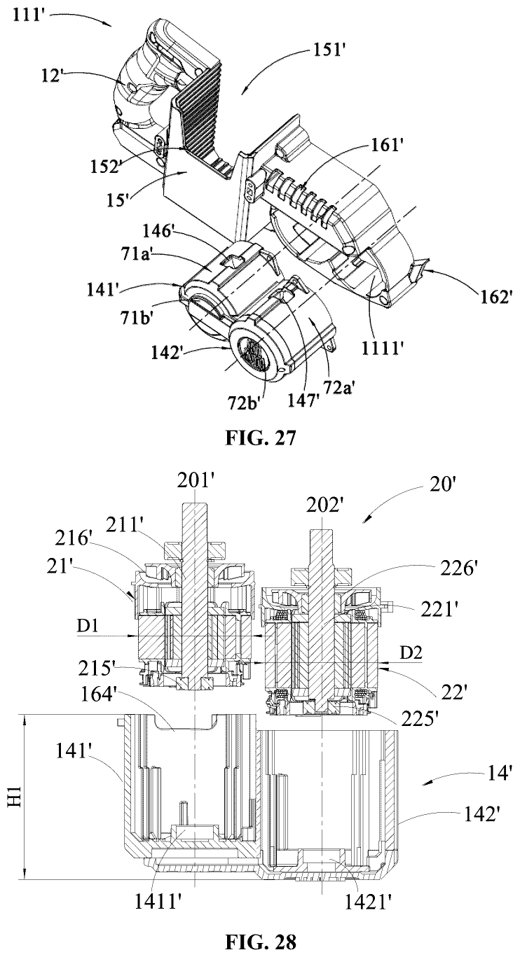

As shown in FIGS. 27 to 30, the accommodation housing 14′ includes a first marker structure corresponding to the first electric motor 21′ and a second marker structure corresponding to the second electric motor 22′. The first marker structure and the second marker structure are formed on or connected to the outer wall surface of the accommodation housing 14′. In this manner, the user can easily identify that the first electric motor 21′ and the second electric motor 22′ mating with each other for driving are used in the product. Therefore, the internal features of the product can be apparent, and the user participation in product selection can be improved.

In some examples, as shown in FIG. 27, a first marker structure 71a′ is configured to include a shape similar to the partial outline of the first electric motor 21′. A second marker structure 72a′ is configured to include a shape similar to the partial outline of the second electric motor 22′. For example, the first marker structure 71a′ is the first accommodation portion 141′ in the accommodation housing 14′, and the outer wall of the first accommodation portion 141′ is an arc edge that is similar to the outer shape of the first electric motor 21′. The second marker structure 72a′ is the second accommodation portion 142′ in the accommodation housing 14′, and the outer wall of the second accommodation portion 142′ is an arc edge that is similar to the outer shape of the second electric motor 22′. Alternatively, for example, the first marker structure 71a′ is the first accommodation portion 141′ in the accommodation housing 14′, and the second marker structure 72a′ is the second accommodation portion 142′ in the accommodation housing 14′. An apparent recess, protrusion, distinguishing shape, or separation mark exists between the first accommodation portion 141′ and the second accommodation portion 142′, thereby dividing the accommodation housing 14′ into partitions associated with the number of electric motors. It is to be understood that the outer wall of the first accommodation portion 141′ may be designed into other shapes from the perspective of industrial design, and the outer wall of the second accommodation portion 142′ may be designed into other shapes from the perspective of industrial design. In the technical field and in the eyes of ordinary consumers, the shape identified as the electric motor may be understood as a shape similar to the outline of the electric motor. For example, in addition to the circle that is the same as the shape of the electric motor, the shape identified as the electric motor may be an ellipse, a shape formed by the combination of arcs and straight lines, a shape formed by the combination of multiple arcs, a rectangle, a polygon, a triangle, or another shape formed by lines.

In this example, the outer walls of the first marker structure 71a′ and the second marker structure 72a′ are configured to be a continuous surface. As shown in FIG. 27, the outer walls of the first accommodation portion 141′ and the second accommodation portion 142′ are a continuous structure, that is, the accommodation housing 14′ is an integral structure.

In some alternative examples, the first marker structure and the second marker structure are configured to be independent double-cylinder structures. It is feasible that the accommodation housing 14′ may be an integral structure, and the first marker structure and the second marker structure are two closed structures, respectively and are disposed on the outer wall of the accommodation housing 14′. It is also feasible that the accommodation housing 14′ may be divided into the first accommodation portion 141′ and the second accommodation portion 142′, which are structures enclosed by two independent outer walls.

In some alternative examples, as shown in FIG. 27, a first marker structure 71b′ and a second marker structure 72b′ are additional line structures disposed on the outer walls of the first accommodation portion 141′ and the second accommodation portion 142′. For example, the first marker structure 71b′ is a line structure that is on the outer wall of the first accommodation portion 141′ and is similar to the outline of the electric motor. The second marker structure 72b′ is a line structure that is on the outer wall of the second accommodation portion 142′ and is similar to the outline of the electric motor. The line structure may be a convex line, an inset line, a concave line, or a hollow line. For example, the first marker structure 71b′ is a line structure that is on the outer wall of the first accommodation portion 141′ and associated with the represented electric motor or the number of electric motors. The second marker structure 72b′ is a line structure that is on the outer wall of the second accommodation portion 142′ and associated with the represented electric motor or the number of electric motors, such as the “word”, “letter”, “number”, or another related or similar thing. “The structure representing the electric motor” is a line structure that may be identified as the electric motor in the technical field and in the eyes of ordinary consumers.

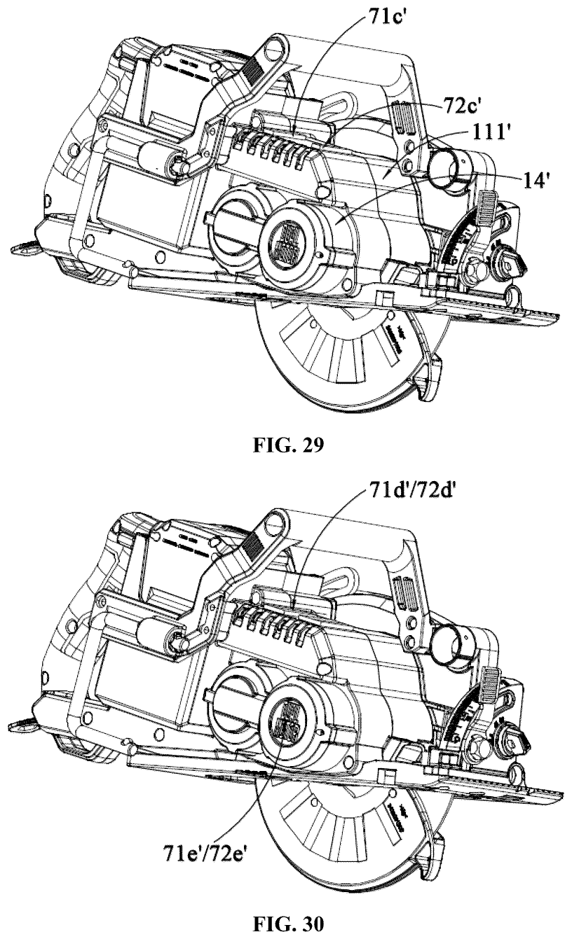

In some alternative examples, as shown in FIGS. 29 and 30, the first marker structure includes a first display portion 71c′ or 71d′, and the second marker structure includes a second display portion 72c′ or 72d′. The first display portion 71c′ or 71d′ and the second display portion 72c′ or 72d′ are disposed at easily visible positions on the body housing 11′, respectively. In this manner, in the process of using the circular saw 100′, the user can check the usage states of the first electric motor 21′ and the second electric motor 22′ on the display portions simply by moving the line of sight.

In some examples, as shown in FIG. 29, the first display portion 71c′ includes a light emitter, and the light emitter indicates at least the on state and the off state of the first electric motor 21′. For example, the first display portion 71c′ includes a light-emitting diode (LED) lamp, a chip on board (COB) light bead, or an incandescent light bulb. The first display portion 71c′ is disposed on the upper surface of the first housing 111′, and the first display portion 71c′ is disposed on the upper surface of a portion of the first housing 111′ closer to the accommodation housing 14′. In some examples, the first display portion 71c′ is disposed on the upper surface of the accommodation housing 14′. The first display portion 71c′ indicates the on/off state of the first electric motor 21′ through changes in display, for example, through different indication features such as lighting up and extinguishing, steady illumination and flashing, and different colors. The first display portion 71c′ may also be multiple lights or a light strip. The rotational speed interval of the first electric motor 21′ is indicated by using the difference in display characteristics of lights of different numbers or sections. In some examples, the first display portion 71c′ may further indicate an abnormality and send an abnormality alarm.

In some alternative examples, as shown in FIG. 30, the first display portion 71d′ includes a display screen, and the display screen is used as a human-computer interaction interface to display the operation state of the first electric motor 21′. For example, the first display portion 71d′ includes an LED display screen, a liquid-crystal display (LCD) display screen, or an organic electroluminescent diode (OLED) display screen. The first display portion 71d′ is disposed on the upper surface of the accommodation housing 14′. In some examples, the first display portion 71d′ is disposed on the upper surface of the first housing 111′, and the first display portion 71d′ is disposed on the upper surface of a portion of the first housing 111′ closer to the accommodation housing 14′. Since the display screen is used as the human-computer interaction interface, more contents can be displayed and the display contents are more detailed and more intuitive. Therefore, depending on different settings, the display screen may display various information about the first electric motor 21′ during the working process, such as power on and off information, speed information, output torque information, forward and reverse rotation information, loss information, and temperature information, and the first electric motor 21′ can even be intuitively displayed in a dynamic shape on the display screen.

In some examples, the first display portion may include both the light emitter and the display screen. The second display portion 72c′ includes at least one of the light emitter and the display screen and is configured to indicate the operation state of the second electric motor 22′. That is to say, the first display portion 71c′ or 71d′ and the second display portion 72c′ may be display components of the same type or of different types. At the same time, to facilitate user observation, the first display portion 71c′ or 71d′ and the second display portion 72c′ are disposed in the same region. For example, the first display portion 71c′ or 71d′ and the second display portion 72c′ are both disposed on the upper part of the accommodation housing 14′, one of the first display portion 71c′ or 71d′ and the second display portion 72c′ is adjacent to the first electric motor 21′, and the other one of the first display portion 71c′ or 71d′ and the second display portion 72c′ is adjacent to the second electric motor 22′. When the first display portion and the second display portion use the same type of display components, the first display portion and the second display portion may be integrated. For example, different brightness and different colors of the LED lamp are used for displaying different electric motor start-up combinations. For example, different display regions of the same display interface of the display screen are used for displaying the information about the first electric motor 21′ and the information about the second electric motor 22′, or different display interfaces are used for displaying the information about the first electric motor 21′ and the information about the second electric motor 22′, respectively, or a menu is used for allowing the user to choose among display of the information about the first electric motor 21′, display of the information about the second electric motor 22′, or display of the information about the first electric motor 21′ and the second electric motor 22′.

In some examples, a first display portion 71e′ includes an icon representing the first electric motor 21′, a second display portion 72e′ includes an icon representing the second electric motor 22′, and the first display portion 71e′ and the second display portion 72e′ are each provided with an adhesive backing layer. That is to say, the first display portion 71e′ and the second display portion 72e′ are adhesive labels. The icon representing the first electric motor 21′ and the icon representing the second electric motor 22′ may be Chinese characters, English words, graphics, or the like. The first display portion 71e′ and the second display portion 72e′ may be disposed on the same paper with an adhesive backing layer.

Some of the technical solutions in the preceding examples may be used alone, or a combination of several technical solutions may be used, thereby setting specific examples of the first marker structure and the second marker structure according to the actual requirements of the power tool.

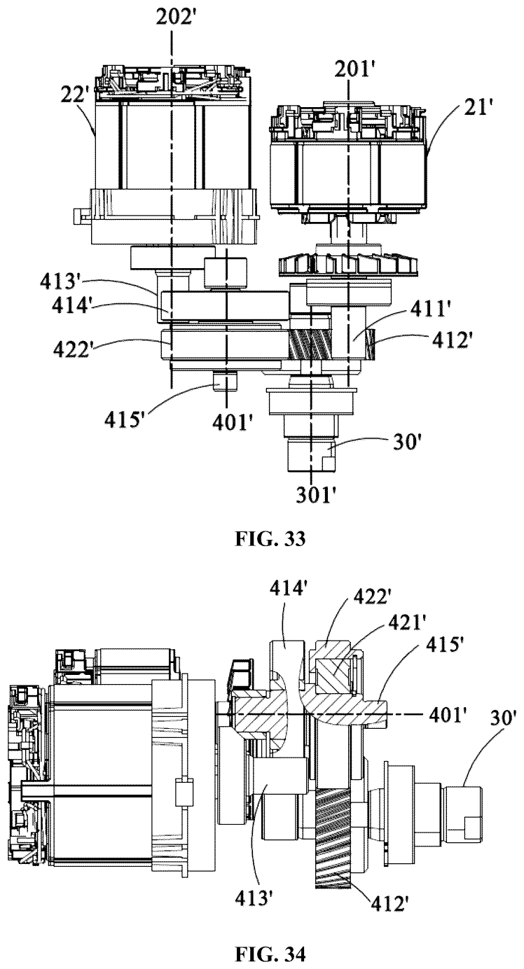

As shown in FIG. 26 and FIGS. 32 to 36, the power transmission mechanism 40′ is configured to transmit power of at least one of the first electric motor 21′ and the second electric motor 22′ to the output shaft 30′. The torque of the first drive shaft 211′ and the torque of the second drive shaft 221′ are outputted through the output shaft 30′. The power transmission mechanism 40′ includes a transmission assembly 41′ disposed between the output shaft 30′ and at least one of the first electric motor 21′ and the second electric motor 22′. The transmission assembly 41′ includes at least a deceleration mechanism. A clutch assembly 42′ is disposed between the first electric motor 21′ and the second electric motor 22′, and the clutch assembly 42′ is configured to allow or not allow at least one of the first drive shaft 211′ or the second drive shaft 221′ to drive the output shaft 30′ under a preset condition. In this manner, the first electric motor 21′ can drive the output shaft 30′ to operate in an interval where the motor efficiency of the first electric motor 21′ is relatively high, and the second electric motor 22′ can drive the output shaft 30′ to operate in an interval where the motor efficiency of the second electric motor 22′ is relatively high. It is to be understood that the clutch assembly 42′ is disposed between the first electric motor 21′ and the second electric motor 22′. On the one hand, in terms of orientations, the clutch assembly 42′ at least partially overlaps any one of the first electric motor 21′ and the second electric motor 22′ in the axial direction of the drive shafts or at least partially overlaps any one of the first electric motor 21′ and the second electric motor 22′ in the radial direction of the drive shafts. On the other hand, in terms of the connection relationship, the clutch assembly 42′ is directly or indirectly connected to the first electric motor 21′ and the second electric motor 22′ separately; or a direct or indirect power transmission path exists between the clutch assembly 42′ and the first electric motor 21′ and a direct or indirect power transmission path exists between the clutch assembly 42′ and the second electric motor 22′.

The transmission assembly 41′ with the deceleration mechanism is provided to improve the cutting capability of the circular saw 100′ and improve the cutting efficiency of the circular saw 100′. The coupling of the electric motor assembly 20′ enables the circular saw 100′ to be used in both the light load condition and the heavy load condition. At the same time, the performance requirements for the electric motor in the electric motor assembly are reduced so that the performance of a large electric motor can be achieved by using an electric motor with a small diameter. In this manner, not only can costs be reduced, but also the requirements for machine heat dissipation and other aspects can be lowered.

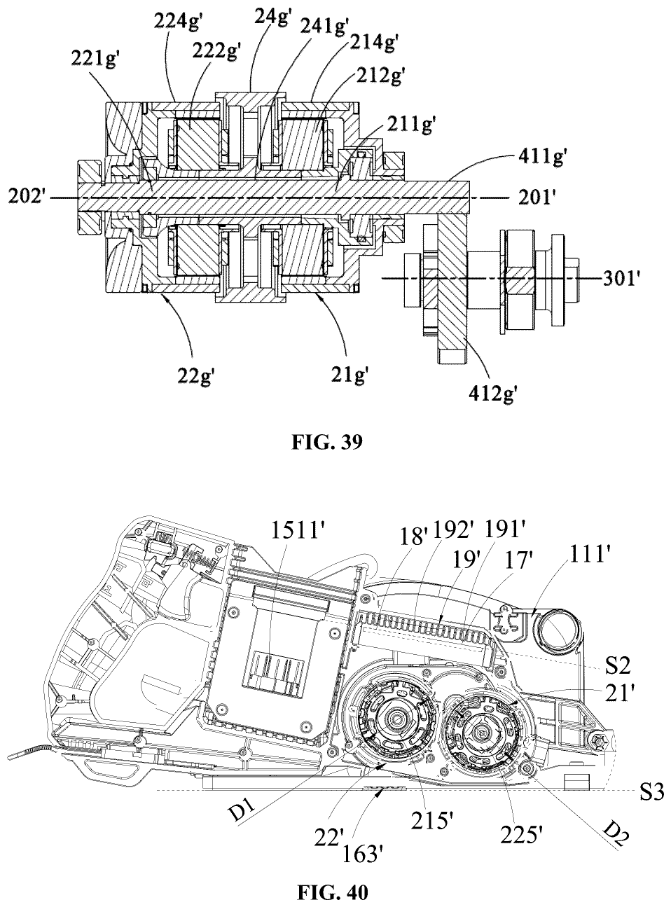

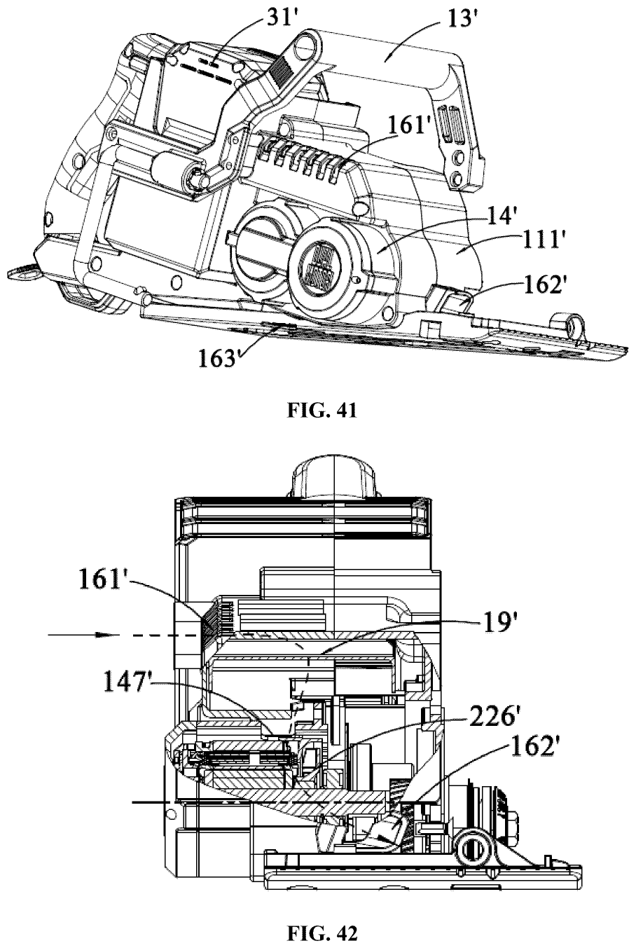

The transmission assembly 41′ is configured to connect at least one of the first drive shaft 211′ and the second drive shaft 221′ to the clutch assembly 42′. As shown in FIGS. 39 to 41 in an example, the transmission assembly 41′ includes a first gearset 41a′ configured to connect the first drive shaft 211′ to the output shaft 30′. The transmission assembly 41′ further includes a second gearset 41b′ connecting the second drive shaft 221′ to the output shaft 30′. The clutch assembly 42′ is disposed between the second gearset 41b′ and the output shaft 30′. In this example, the first gearset 41a′ is a reduction gear drive, and the second gearset 41b′ is a reduction gear drive. The first gearset 41a′ is a one-stage reduction drive, that is to say, the first gearset 41a′ provides a deceleration movement. The second gearset 41b′ is a one-stage reduction drive, that is to say, the second gearset 41b′ provides a deceleration movement. In some alternative examples, the first gearset 41a′ and the second gearset 41b′ may each include the multi-stage reduction drive or the speed-increasing drive followed by the reduction drive. In some alternative examples, the gear ratios or reduction ratios of the first gearset 41a′ and the second gearset 41b′ may be adjusted so that one gearset can provide multiple gear ratios or reduction ratios. In this example, the reduction ratio of the first gearset 41a′ is different from the reduction ratio of the second gearset 41b′. The first gearset 41a′ and the second gearset 41b′ each include one or a combination of the cylindrical gear transmission, the bevel gear transmission, the worm transmission, and the planet gear transmission.

The first gearset 41a′ includes a first drive gear 411′ and a first driven gear 412′. The first drive gear 411′ is formed on or connected to the first drive shaft 211′. Optionally, the first drive gear 411′ is formed at an end of the first drive shaft 211′ facing the cutting part 61′. The first drive gear 411′ rotates about the first axis 201′, the first driven gear 412′ externally meshes with the first drive gear 411′, the first driven gear 412′ is mounted on the output shaft 30′, and the first driven gear 412′ rotates about the output axis 301′. The first drive gear 411′ and the first driven gear 412′ form the reduction drive. As an example, the reduction ratio between the first drive gear 411′ and the first driven gear 412′ is 8/38.

The second gearset 41b′ includes a second drive gear 413′ and a second driven gear 414′. The second drive gear 413′ is formed on or connected to the second drive shaft 221′. Optionally, the second drive gear 413′ is formed at an end of the second drive shaft 221′ facing the cutting part 61′. The second drive gear 413′ rotates about the second axis 202′, the second driven gear 414′ externally meshes with the second drive gear 413′, the second driven gear 414′ is mounted on an idler shaft 415′, and the second driven gear 414′ rotates about a third axis 401′ of the idler shaft 415′. The third axis 401′ and the first axis 201′ are parallel and do not coincide. The second drive gear 413′ and the second driven gear 414′ form the reduction drive. In this example, the clutch assembly 42′ includes a one-way transmission member 421′. The one-way transmission member 421′ is operable to connect the rotation of the first electric motor 21′ to the rotation of the second electric motor 22′ in a first direction of rotation and disconnect the rotation of the first electric motor 21′ from the rotation of the second electric motor 22′ in a second direction of rotation. Optionally, the clutch assembly 42′ is a one-way bearing or an overrunning clutch. The one-way transmission member 421′ is mounted on the idler shaft 415′, and the one-way transmission member 421′ rotates synchronously with the second driven gear 414′. The inner race of the one-way transmission member 421′ is connected to the idler shaft 415′, and the outer race of the one-way transmission member 421′ is connected to a third gear 422′. The third gear 422′ externally meshes with the first driven gear 412′ so that the first electric motor 21′ and the second electric motor 22′ can be coupled. In this manner, the transmission between the second electric motor 22′ and the first electric motor 21′ can be controlled. In this example, the third gear 422′ and the first driven gear 412′ are basically in constant speed transmission, that is, the rotational speed of the third gear 422′ is the same as the rotational speed of the first driven gear 412′. The gear ratio between the third gear 422′ and the first driven gear 412′ is 1. As an example, the reduction ratio between the second drive gear 413′ and the second driven gear 414′ is 7/38.

During operation, when the first electric motor 21′ starts to work, through the first gearset 41a′, the first electric motor 21′ drives the output shaft 30′ to rotate. The one-way transmission member 421′ is provided to restrict the transmission of the output rotational speed of the first electric motor 21′ to the second electric motor 22′, that is, the one-way transmission member 421′ allows only the transmission of the rotation of the second drive shaft 221′ (the second drive gear) of the second electric motor 22′ to the second driven gear 414′. Therefore, in this case, only the first electric motor 21′ drives the output shaft 30′ to rotate. When the second electric motor 22′ starts, the rotation lock achieved by the one-way transmission member 421′ is released. When the rotational speed of the second driven gear 414′ is less than the rotational speed of the third gear 422′, the rotational speed of the second driven gear 414′ cannot be transmitted to the output shaft. It is to be understood that when a power output portion of a one-way clutch (the outer race in this example) rotates faster than a power source (the inner race in this example), the one-way clutch is in a disengaged state, and the inner race and the outer race are not linked, which is a one-way overrunning function of the one-way clutch. When the rotational speed of the second driven gear 414′ is equal to or higher than the rotational speed of the first driven gear 412′, that is, when the rotational speed of the second driven gear 414′ is equal to or higher than the rotational speed of the third gear 422′, the inner race and the outer race of the one-way clutch are linked, and the first electric motor 21′ and the second electric motor 22′ simultaneously drive the output shaft 30′ to move. At the same time, the first driven gear 412′ is driven by the second driven gear 414′ through the third gear 422′ so that the first driven gear 412′ moves at the rotational speed of the second driven gear 414′ (that is, the idler shaft 415′).

A non-thrust bearing is disposed at a first end of the idler shaft 415′, and an elastic member is disposed at an end of the non-thrust bearing. In this manner, the gears on the idler shaft 415′ can be prevented from moving axially.

In some examples, the clutch assembly may be another mechanical clutch assembly. For example, the clutch assembly may include a dog clutch, a ratchet clutch, a centrifugal clutch, a differential, a friction clutch, or a hydrodynamic clutch. The preceding mechanical clutches in simple modifications or combinations may be used as the clutch assembly of the present application. On the premise that the function of the clutch assembly of the present application can be implemented, the specific form of the structure does not affect the substantive content of the present application.

In some examples, the clutch assembly further includes an electronic clutch. For example, the clutch assembly includes an electromagnetic clutch. For example, the electromagnetic clutch may be a dry single-plate electromagnetic clutch, a dry multi-plate electromagnetic clutch, a wet multi-plate electromagnetic clutch, a magnetic particle clutch, or a slip electromagnetic clutch.

In some examples, the mechanical clutch assembly and the electronic clutch may be coupled, thereby allowing or not allowing at least one of the first drive shaft 211′ or the second drive shaft 221′ to drive the output shaft 30′ under the preset condition.

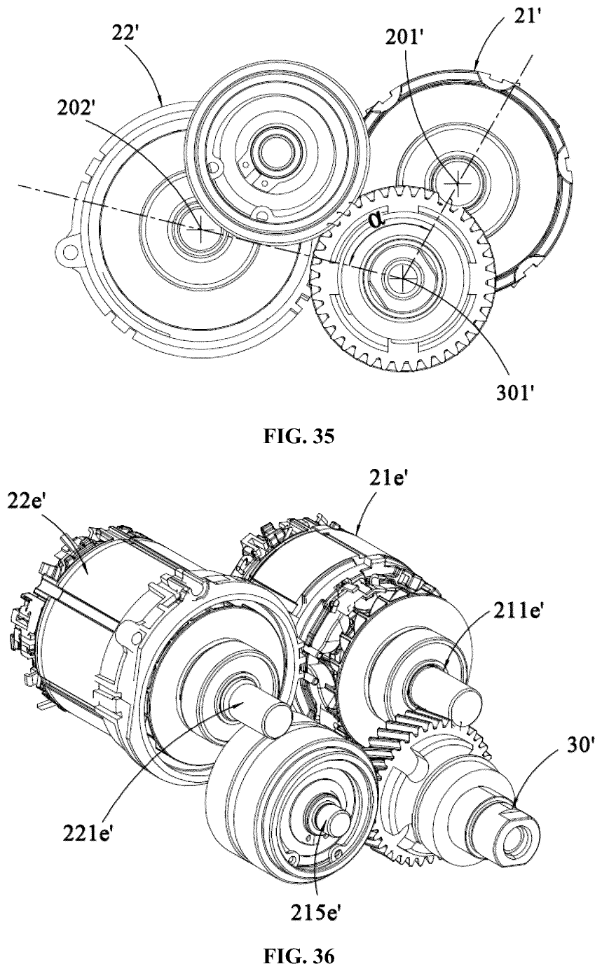

As shown in FIG. 35, along the direction of the output axis 301′, the projection of the first axis 201′ and the projection of the second axis 202′ are located above the projection of the output axis 301′. In this manner, a larger portion of the electric motor assembly is located on the upper side of the output shaft so that the depth of cut of the circular saw can be ensured. The output axis 301′ is basically at the center position of the cutting part 61′, and the depth of cut of the circular saw is closely related to the positional relationship between the output axis and the base plate. The drive axis of the electric motor assembly is disposed above the output axis, thereby not affecting the installation of the base plate and the usage of the circular saw. During the cutting process of the circular saw, no component interfering with the output axis approaching the base plate exists. An included angle α between a line connecting the first axis 201′ and the output axis 301′ and a line connecting the second axis 202′ and the output axis 301′ is greater than or equal to 45° and less than or equal to 180°. In this manner, the transmission between the first electric motor and the second electric motor can be ensured. On the other hand, the arrangement structure of the first electric motor, the second electric motor, and the output shaft can be compact.

Optionally, when the first electric motor 21′ and the second electric motor 22′ are arranged radially, the first electric motor 21′ and the second electric motor 22′ are staggered with each other in the up and down direction. The output shaft 30′ and the idler shaft 415′ are located on two sides of the first drive shaft 211′, respectively. The output shaft 30′ and the idler shaft 415′ are located on two sides of the second drive shaft 221′, respectively. In this example, the first electric motor 21′ is a small torque output electric motor, and the second electric motor 22′ is a large torque output electric motor. At least one of the first gearset 41a′ and the second gearset 41b′ includes a helical gear.

As shown in FIG. 36, when a first electric motor 21e′ and a second electric motor 22e′ are arranged radially, a first drive shaft 211e′ is basically flush with a second drive shaft 221e′ in the up and down direction. The output shaft 30′ and an idler shaft 415e′ are located on the same side of the first drive shaft 211e′.

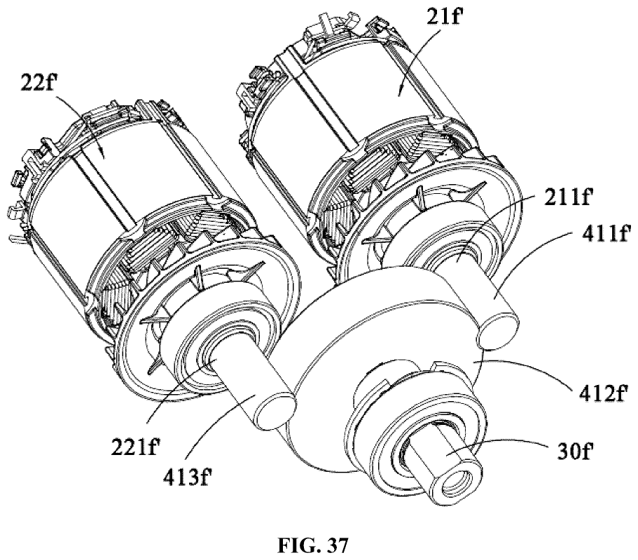

As shown in FIG. 37, as an example, a first electric motor 21f′ and a second electric motor 22f are arranged radially, and a first drive gear 411f′ on a first drive shaft 211f′ and a second drive gear 413f′ on a second drive shaft 221f′ both externally mesh with a driven gear 412f on an output shaft 30f. In this case, the first electric motor 21f and the second electric motor 22f may not be provided with a clutch assembly, that is, the first electric motor and the second electric motor synchronously or basically synchronously output torque. In this case, along the direction of the output axis 301′, the projection of the first axis 201′ and the projection of the second axis 202′ are located above the projection of the output axis 301′. The included angle α between a line connecting the first axis and the output axis and a line connecting the second axis and the output axis is greater than or equal to 45° and less than or equal to 180°.

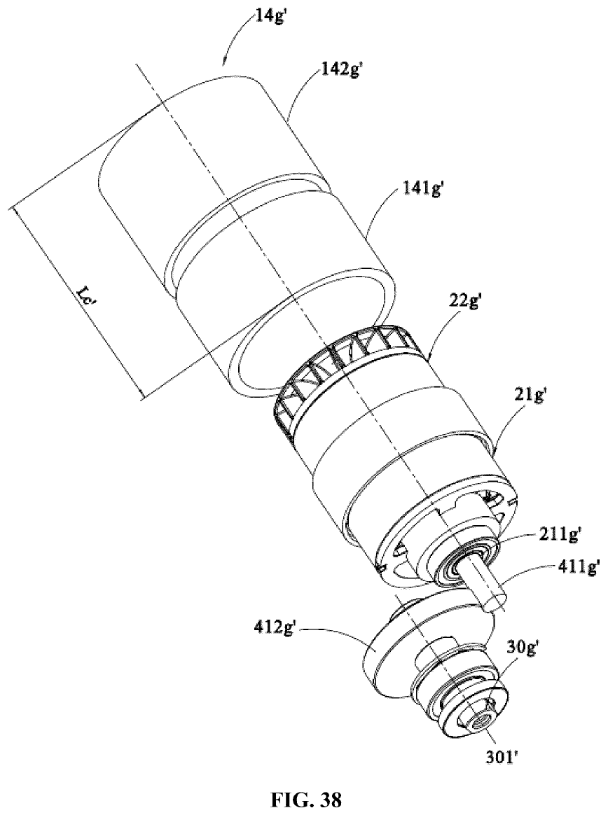

As shown in FIGS. 38 and 39, as another example of the present application, a first electric motor 21g′ and a second electric motor 22g′ are arranged axially. That is, a first drive shaft 211g′ of the first electric motor 21g′ and a second drive shaft 221g′ of the second electric motor 22g′ are arranged coaxially. The first drive shaft 211g′ is mechanically coupled to the second drive shaft 221g′. A first drive gear 411g′ is on the first drive shaft 211g′. The first drive gear 411g′ externally meshes with a driven gear 412g′ on an output shaft 30g′. The first drive gear 411g′ and the driven gear 412g′ form the reduction drive.

An accommodation housing 14g′ is configured to accommodate the first electric motor 21g′ and the second electric motor 22g′. Optionally, a first accommodation portion 141g′ of the accommodation housing 14g′ for accommodating the first electric motor 21g′ and a second accommodation portion 142g′ of the accommodation housing 14g′ for accommodating the second electric motor 22g′ are arranged axially. The ratio of the outer dimension Lc′ of the accommodation housing 14g′ along the direction of the first drive shaft 211g′ or the second drive shaft 221g′ to the length of any one of the first drive shaft 211g′ and the second drive shaft 221g′ is greater than or equal to 1.1. When the first electric motor 21g′ and the second electric motor 22g′ are coaxially arranged, to ensure that the first electric motor 21g′ and the second electric motor 22g′ can be mounted stably, the dimension of the accommodation housing 14g′ needs to be greater than 1.1 times the length of a single drive shaft. In this manner, the relative position between the first electric motor 21g′ and the second electric motor 22g′ is reasonably set so that the space in which the first electric motor 21g′ and the second electric motor 22g′ can be mounted stably exists. In some examples, the ratio of the outer dimension Lc′ of the accommodation housing 14g′ along the direction of the first drive shaft 211g′ or the second drive shaft 221g′ to the length of any one of the first drive shaft 211g′ and the second drive shaft 221g′ is greater than or equal to 1.2, 1.4. 1.6, or 1.8. In some examples, the ratio of the outer dimension Lc′ of the accommodation housing 14g′ along the direction of the first drive shaft 211g′ or the second drive shaft 221g′ to the length of any one of the first drive shaft 211g′ and the second drive shaft 221g′ is greater than or equal to 2. In some examples, the ratio of the outer dimension Lc′ of the accommodation housing 14g′ along the direction of the first drive shaft 211g′ or the second drive shaft 221g′ to the length of any one of the first drive shaft 211g′ and the second drive shaft 221g′ is greater than or equal to 2.1 or 2.2.

As shown in FIG. 39, the first electric motor 21g′ is an outrunner, and the second electric motor 22g′ is an outrunner. The first electric motor 21g′ includes a first stator 212g′ and a first rotor 214g′, and the first drive shaft 211g′ is formed on or connected to the first rotor 214g′. The second electric motor 22g′ includes a second stator 222g′ and a second rotor 224g′. The second drive shaft 221g′ is formed on or connected to the second rotor 224g′.

The first drive shaft 211g′ rotates synchronously with the second drive shaft 221g′. In this example, the first drive shaft 211g′ and the second drive shaft 221g′ are formed into an integral structure. In some examples, the first drive shaft 211g′ and the second drive shaft 221g′ may be separately provided independent shafts, and the first drive shaft and the second drive shaft may be connected by a connector or a fastener so that the first drive shaft can rotate synchronously with the second drive shaft. An electric motor fixing portion 24g′ connected to the first stator 212g′ and the second stator 222g′ separately is further included. The electric motor fixing portion 24g′ is provided with an accommodation channel 241g′ configured to at least partially accommodate the first drive shaft 211g′ and the second drive shaft 221g′. The accommodation channel 241g′ at least partially overlaps the first stator 212g′ along the direction of the first axis 201′, and the accommodation channel 241g′ at least partially overlaps the second stator 222g′ along the direction of the first axis 201′. The stator 212g′ of the first electric motor and the stator 222g′ of the second electric motor are coaxially connected via the electric motor fixing portion 24g′.

In some alternative examples, a clutch assembly is provided between a first motor shaft and a second motor shaft, or a clutch assembly is provided between the first electric motor and the output shaft, or a clutch assembly is provided between the second electric motor and the output shaft so that the power of the first electric motor and the power of the second electric motor can be selectively transmitted to the output shaft. The clutch assembly may be any one of the clutch structures in the preceding examples. The clutch assembly is disposed in the electric motor fixing portion or between the first drive gear 411g′ and the first driven gear. In this case, along the direction of the output axis 301′, the projection of the first axis 201′ and the projection of the second axis 202′ are located above the projection of the output axis 301′.

In the present application, the first electric motor 21′ outputs the first torque and the first rotational speed. The second electric motor 22′ outputs the second torque and the second rotational speed. In some examples, the first torque is different from the second torque. The first rotational speed is different from the second rotational speed. In some examples, the first torque being different from the second torque is interpreted as that the maximum output torque of the first electric motor 21′ and the second electric motor 22′ are different and the first electric motor 21′ and the second electric motor 22′ may output the same torque at a moment or in a time period in the entire working process. In some examples, the output torque ranges of the first electric motor 21′ and the second electric motor 22′ in high efficiency intervals are different, and the first electric motor 21′ and the second electric motor 22′ may output the same torque at a moment or in a time period in the entire working process. In some examples, the first rotational speed being different from the second rotational speed is interpreted as that the maximum output rotational speeds of the first electric motor 21′ and the second electric motor 22′ are different, and the first electric motor 21′ and the second electric motor 22′ may output the same rotational speed at a moment or in a time period in the entire working process. In some examples, the output rotational speed ranges of the first electric motor 21′ and the second electric motor 22′ in high efficiency intervals are different, and the first electric motor 21′ and the second electric motor 22′ may output the same rotational speed at a moment or in a time period in the entire working process.

In some examples, the first electric motor 21′ and the second electric motor 22′ are used as an example, where the first electric motor 21′ has low output torque. The second electric motor 22′ has high output torque. Alternatively, the first electric motor 21′ may have high output torque. The second electric motor 22′ may have low output torque. Alternatively, the first electric motor 21′ and the second electric motor 22′ are the same type of electric motor and have different output rotational speeds and different output torques. In this example, the first electric motor 21′ and the second electric motor 22′ are each a direct current brushless motor.

Moreover, the first electric motor 21′ and the second electric motor 22′ further include at least one different structural parameter. The structural parameter includes the outer diameter D of the electric motor and the stack length of the electric motor. It is to be interpreted that the “outer diameter of the electric motor” refers to the outer diameter of the entire electric motor. The “stack length of the electric motor” refers to the length of the stator core. In this example, the diameter of the first electric motor 21′ is less than or equal to 75 mm. The diameter of the first electric motor 21′ is less than or equal to 70 mm. The diameter of the first electric motor 21′ is less than or equal to 65 mm. In some examples, the diameter of the first electric motor 21′ is less than or equal to 69 mm, 68 mm, 67 mm, 66 mm, 64 mm, 63 mm, 62 mm, 61 mm, 60 mm, 59 mm, 58 mm, 57 mm, 56 mm, or 55 mm. In this example, the diameter of the second electric motor 22′ is less than or equal to 75 mm. The diameter of the second electric motor 22′ is less than or equal to 70 mm. The diameter of the second electric motor 22′ is less than or equal to 65 mm. In some examples, the diameter of the second electric motor 22′ is less than or equal to 69 mm, 68 mm, 67 mm, 66 mm, 64 mm, 63 mm, 62 mm, 61 mm, 60 mm, 59 mm, 58 mm, 57 mm, 56 mm, or 55 mm.

In some examples, the structural parameter of the first electric motor 21′ and the second electric motor 22′ includes the outer diameter of the stator core, the inner diameter of the stator core, the outer diameter of the rotor core, the inner diameter of the rotor core, the thickness of a rotor pole, the thickness of a stator pole, the length of an air gap, the length of the core, the number of pairs of stator poles, an arc corresponding to the stator pole, the number of pairs of rotor poles, and an arc corresponding to the rotor pole. The first electric motor 21′ and the second electric motor 22′ are different in at least one structural parameter.

Of course, in some examples, the first electric motor 21′ and the second electric motor 22′ may be two completely identical electric motors. The first electric motor and the second electric motor are coupled to each other, thereby operating in an interval where the efficiency is higher.

In this example, the battery pack 31′ supplies power to the first electric motor 21′ and the second electric motor 22′. The first electric motor 21′ and the second electric motor 22′ are powered through the battery pack 31′ in conjunction with corresponding power circuits. As shown in FIGS. 25 and 27, the body housing 11′ is provided with a semi-open battery accommodation compartment 15′ which is recessed inward. The battery accommodation compartment 15′ is disposed between the grip 12′ and the electric motor assembly 20′. The battery accommodation compartment 15′ and the electric motor assembly 20′ are disposed on the same side of the first housing 111′. The battery accommodation compartment 15′ and the battery pack 31′ are disposed in front of the grip 12′. The battery accommodation compartment 15′ is disposed on the first housing 111′.

As shown in FIG. 40, the battery accommodation compartment 15′ includes a coupling portion 1511′ electrically connected to the battery pack 31′, and the coupling portion 1511′ is provided with tool terminals (not shown in the figure). Tool terminals with the same structures (not shown in the figure) are provided on different power tools. The battery pack 31′ includes an insertion structure and terminal interfaces. The tool terminals are adapted to the terminal interfaces on the battery pack 31′. Tool terminals with the same structures are provided on different power tools so that the battery pack 31′ can supply power to a variety of different power tools. The power circuit in collaboration with the battery pack is adjusted according to the control requirements of different power tools. In some examples, the nominal voltage of the power tool is greater than or equal to 18 V. The nominal voltage of the power tool is greater than or equal to 36 V and less than or equal to 56 V. In some examples, the nominal voltage of the power tool is greater than 56 V and less than or equal to 120 V. The first electric motor 21′, the second electric motor 22′, the battery pack 31′, and the grip 12′ are disposed on the same side of the cutting part 61′, and after the battery pack 31′ is inserted into the battery holder 15′, the battery pack 31′ is at least partially behind the first electric motor and the second electric motor and at least partially in front of the grip 12′. Optionally, the battery pack 31′ is inserted obliquely into the battery holder 15′. In some examples, the battery pack 31′ is partially located above the first electric motor and the second electric motor.

As shown in FIG. 40, the circular saw 100′ further includes a controller 17′ configured to control the electric motor assembly 20′. The controller 17′ is disposed on a control circuit board 18′, where the control circuit board 18′ includes a printed circuit board (PCB) and a flexible printed circuit (FPC) board. A dedicated control chip is used as the controller 17′, for example, a single-chip microcomputer or a microcontroller unit (MCU). It is to be noted that the control chip may be integrated in the controller 17′ or may be disposed independently of the controller 17′. The structural relationship between a driver chip and the controller 17′ is not limited in this example.

As shown in FIGS. 26 and 28, the electric motor assembly 20′ further includes a first fan 216′ supported by the first drive shaft 211′ and driven by the first electric motor 21′ to rotate and generate the cooling airflow. The electric motor assembly 20′ further includes a second fan 226′ supported by the second drive shaft 221′ and driven by the second electric motor 22′ to rotate and generate the cooling airflow. As shown in FIGS. 40 to 42, an airflow port is formed on the body housing 11′. When any one of the first fan 216′ and the second fan 226′ rotates, a heat dissipation air path can be generated, and the cooling airflow flows through at least the control circuit board 18′ and the electric motor assembly 20′. The brushless motor has higher output power than the brushed motor. However, at the same time, the heat generated by the brushless motor increases, and the heat generated by the control circuit board 18′ for controlling the power supply of the electric motors also increases. Therefore, sufficient heat dissipation for the control circuit board 18′ is required. In some examples, when the first electric motor and the second electric motor are arranged coaxially, the first fan may be supported by at least one of the first drive shaft, the second drive shaft, or the output shaft. When any one of the first electric motor and the second electric motor rotates, the first fan rotates to generate a heat dissipation air path.

The airflow port includes a first air inlet 161′ and a first air outlet 162′. The cooling airflow enters the body housing 11′ from the first air inlet 161′ and flows out of the body housing 11′ from the first air outlet 162′. The control circuit board 18′ is disposed in the first housing 111′. The first air inlet 161′ allows the cooling airflow to enter the accommodation housing 14′ from the first housing 111′. When any electric motor in the electric motor assembly 20′ is started, the corresponding fan rotates synchronously to generate the cooling airflow. In this manner, the cooling airflow can flow through at least the control circuit board 18′ and the electric motor assembly 20′. That is to say, at least one of the control circuit board 18′ and the electric motor assembly 20′ needs to be disposed in the flow path of the cooling airflow. In this manner, when any electric motor in the electric motor assembly 20′ is started and the fan rotates, external air can flow into the interior of the circular saw 100′ through the air inlet to form the cooling airflow; and in the process of flowing to the fan, the cooling airflow flows through at least the circuit board and any electric motor in the electric motor assembly 20′ and finally flows out through the air outlet.

FIGS. 40 to 42 show a first example of the heat dissipation solution. The control circuit board 18′ is disposed above the electric motor assembly 20′. The plane on which the control circuit board 18′ extends is defined as a second plane S2. The plane where the base plate bottom surface 51′ is located is defined as a third plane S3. Along a direction perpendicular to the extension direction of the cutting part 61′, that is, along the direction of the output axis, the second plane S2 is a straight line, and the third plane S3 is a straight line. The second plane S2 and the third plane S3 may be parallel or may intersect. The control circuit board 18′ is accommodated in a circuit board housing 19′. The circuit board housing 19′ includes a heat dissipation plate 191′. In this example, the circuit board housing 19′ is made of the heat dissipation material, and the heat dissipation plate 191′ is provided on the sidewall in contact with the control circuit board 18′. The heat dissipation plate 191′ includes heat dissipation fins 192′ extending for a certain length. The control circuit board 18′ is connected to the heat dissipation plate 191′ so that the heat generated by the control circuit board 18′ can be transferred and conducted to the heat dissipation plate 191′ and the heat dissipation fins 192′. In this example, the plane where the heat dissipation plate 191′ is located is parallel to or coincides with the second plane S2. When the circuit board housing 19′ is disposed in the first housing 111′, to reduce the flow resistance of the cooling airflow and optimize the cooling effect, the extension direction of the space defined by adjacent sheet-like fins is along the flow direction of the cooling airflow.

The first fan 216′ is disposed at an end of the first drive shaft 211′ facing the output shaft 30′. The first fan 216′ is at least partially disposed in the accommodation housing 14′. The second fan 226′ is disposed at an end of the second drive shaft 221′ facing the output shaft 30′. The second fan 226′ is at least partially disposed in the accommodation housing 14′. The circuit board housing 19′ and the control circuit board 18′ are disposed outside the first fan 216′ and the second fan 226′ in the radial direction thereof. Optionally, the circuit board housing 19′ and the control circuit board 18′ are disposed above the first fan 216′ and the second fan 226′ in the radial direction thereof. The circuit board housing 19′ and the control circuit board 18′ are disposed in the first housing 111′. The first air inlet 161′ is disposed on the upper sidewall of the first housing 111′. In this example, the first air inlet 161′ is disposed on the right sidewall and the upper sidewall of the first housing 111′. It may also be understood as that part of the first air inlet 161′ is located on the upper sidewall and part of the first air inlet 161′ is located on a sidewall of the first housing 111′ facing away from the output shaft 30′. In this manner, the heat dissipation air path can have a longer contact path with the circuit board housing 19′. That is to say, the first air inlet 161′ and the fans are basically located on the upper and lower sides and the left and right sides of the control circuit board 18′. The first air inlet 161′ is configured to be a matrix hole formed by multiple through holes, thereby preventing the operator from accidentally inserting the finger or the like into the airflow port.

As shown in FIG. 27, since the first fan 216′ and the second fan 226′ are basically located in the accommodation housing 14′, the accommodation housing 14′ is provided with a first connecting hole 146′ and a second connecting hole 147′ corresponding to the first fan 216′ and the second fan 226′, respectively. In some examples, the positions of the first connecting hole 146′ and the second connecting hole 147′ are specifically determined according to the positions of the first fan 216′ and the second fan 226′. Of course, the first connecting hole 146′ and the second connecting hole 147′ may not be provided. It is ensured that the cooling airflow entering from the first air inlet 161′ and flowing through the control circuit board 18′ is generated by effectively utilizing the negative pressure generated by the rotation of the fans.

The airflow port further includes the first air outlet 162′ for allowing the cooling airflow to flow out of the body housing 11′. The first air outlet 162′ connects the accommodation housing 14′ and the first housing 111′ with the external environment. In this example, the air discharge direction of the first air outlet 162′ is toward the front side of the circular saw 100′. Optionally, the second electric motor 22′ is in front of the first electric motor 21′. In some examples, airflow guide ribs are provided in the first housing 111′ and are configured to guide the cooling airflow so that the cooling airflow flows within the space defined by the airflow guide ribs.

During the cutting operation, when the base plate bottom surface 51′ abuts against the workpiece to be cut, the control switch 81′ is triggered normally, at least the first electric motor 21′ is started, and the saw blade rotates, thereby cutting the workpiece to be cut. At the same time, at least the first fan 216′ rotates to form negative pressure, thereby driving external air into the interior of the circular saw 100′ to dissipate heat. After the fan rotates, the cooling airflow enters the first housing 111′ from the first air inlet 161′, and the cooling airflow flows through the circuit board housing 19′ and the control circuit board 18′, then flows through the first electric motor 21′ and the second electric motor 22′ from the first connecting hole 146′, and flows out from the first air outlet 162′.

In this example, a second air outlet 163′ is further included. The second air outlet 163′ and the first air outlet 162′ have different air discharge directions. In this example, the second air outlet 163′ is disposed near the second electric motor 22′, and the second air outlet 163′ discharges air in a direction away from the cutting part 61′ so that the cooling airflow from the second air outlet 163′ has a dust blowing function in addition to the heat dissipation function. The dust generated during the cutting process can be blown away. Optionally, the second air outlet 163′ includes a third connecting hole 164′ configured to connect the accommodation housing 14′ and the first housing 111′ with the outside and a fourth connecting hole 165′ disposed on the sidewall of the base plate 50′ and configured to have the dust blowing function. In this example, the heat dissipation air path includes a first heat dissipation air path F1 and a second heat dissipation air path F2. The first heat dissipation air path F1 is configured such that when at least one of the first electric motor 21′ and the second electric motor 22′ is operating, the cooling airflow enters from the first air inlet 161′ and flows through the control circuit board 18′ and the electric motor assembly 20′, and then most of the cooling airflow flows out from the first air outlet 162′. The second heat dissipation air path F2 is configured such that when at least one of the first electric motor 21′ and the second electric motor 22′ is operating, the cooling airflow enters from the first air inlet 161′ and flows through the control circuit board 18′ and the electric motor assembly 20′, and then most of the cooling airflow flows out from the second air outlet 163′.

In this example, one circuit board housing 19′ is provided, at least one controller is provided, and the number of control circuit boards 18′ corresponds to the number of controllers. Alternatively, multiple controllers may be disposed on one control circuit board 18′. The circuit board housing 19′ may accommodate at least one control circuit board 18′. Multiple controllers are connected communicatively or electrically.

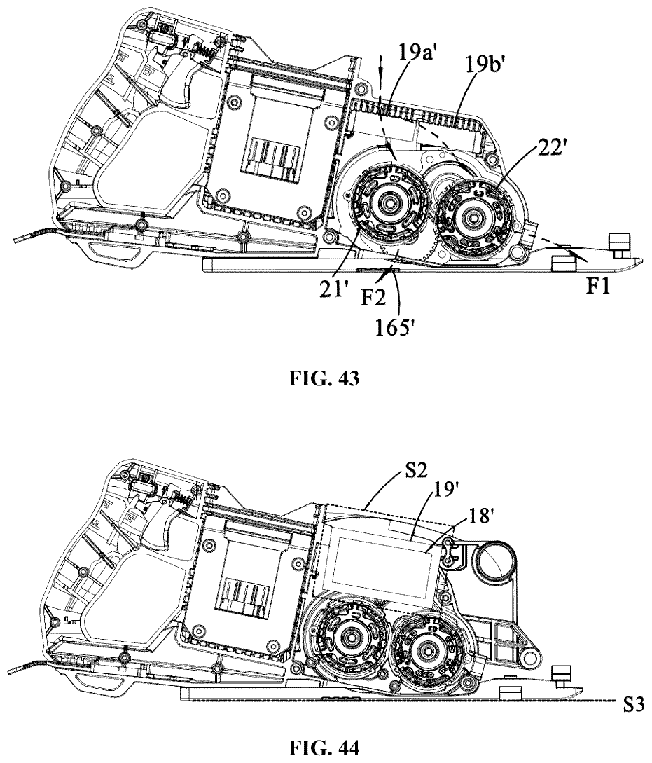

As shown in FIG. 43, as an optional example, two circuit board housings 19′ are provided, and at least two control circuit boards 18′ are provided. Multiple controllers are provided on multiple control circuit boards 18′, thereby reducing the capacity requirements for the control circuit boards 18′. The circuit board housings 19′ are placed outside the first fan and the second fan in the radial direction thereof. Optionally, the circuit board housings 19′ and the control circuit boards 18′ are disposed above the first fan and the second fan 226′ in the radial direction thereof. The circuit board housings 19′ include a first circuit board housing 19a′ and a second circuit board housing 19b′. The first circuit board housing 19a′ and the second circuit board housing 19b′ may have the same structures, thereby improving versatility. The first circuit board housing 19a′ and the second circuit board housing 19b′ may have different structures. The specific structures of the first circuit board housing 19a′ and the second circuit board housing 19b′ may be specifically set according to different specific positions of the first circuit board housing 19a′ and the second circuit board housing 19b′.

As shown in FIG. 44, as an optional example, the second plane S2 of the control circuit board 18′ is spatially perpendicular to the third plane S3. Optionally, along a plan of the extension direction of the cutting part 61′, the projection of the second plane S2 is a plane, and the projection of the third plane S3 is a straight line. The projection the second plane S2 is parallel to the extension direction of the cutting part 61′. The control circuit board 18′ conducts heat with the fixed guard. In this example, the circuit board housing 19′ is in close contact with the fixed guard so that the heat of the circuit board housing 19′ can be radiated and dissipated through the surface of the fixed guard, thereby increasing the heat dissipation path of the control circuit board 18′.

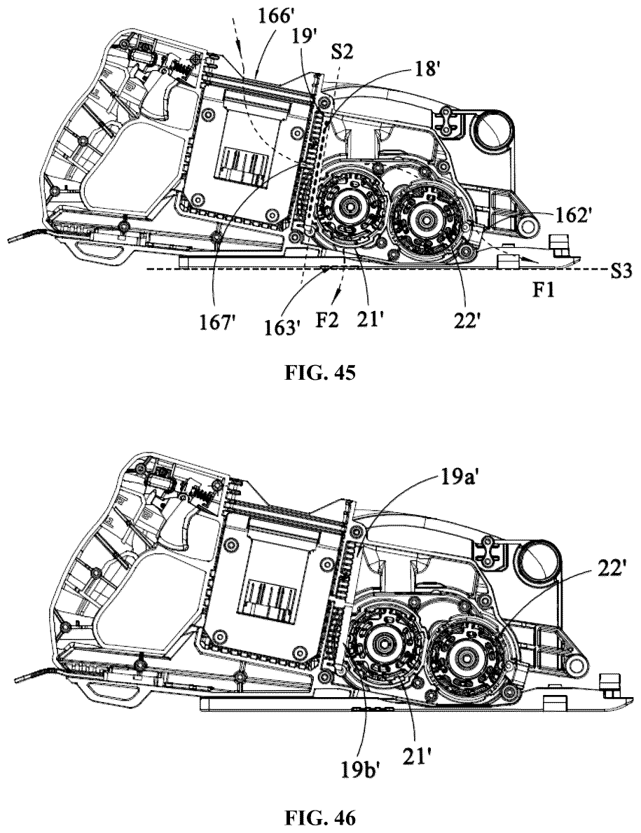

FIG. 45 shows a second example of the heat dissipation solution. The control circuit board 18′ is disposed between the electric motor assembly 20′ and the battery pack 31′. Optionally, the control circuit board 18′ is disposed in the first housing 111′ and is located between a accommodation housing and the battery accommodation compartment 15′. Along a direction perpendicular to the extension direction of the cutting part 61′, the second plane S2 is a straight line, and the third plane S3 is a straight line. The second plane S2 and the third plane S3 intersect or are perpendicular.

The structure of the electric motor assembly is the same as that in the first example of the heat dissipation solution. The circuit board housing 19′ and the control circuit board 18′ are disposed outside the first fan 216′ and the second fan 226′ in the radial direction thereof. Optionally, the circuit board housing 19′ and the control circuit board 18′ are disposed on the rear side of the first fan 216′ and the second fan 226′ in the radial direction thereof and between the battery accommodation compartment 15′ and the accommodation housing 14′. A second air inlet 166′ is disposed in the battery accommodation compartment 15′. In this example, as shown in FIG. 27, the battery accommodation compartment 15′ includes a first outlet 151′ for the at least one battery pack 31′ to enter and be pulled out of the battery accommodation compartment 15′ and a second outlet 152′ different from the first outlet 151′. As shown in FIGS. 27 and 45, the second air inlet 166′ includes the first outlet 151′, the second outlet 152′, and a fifth connecting hole 167′ connecting the battery accommodation compartment 15′ with the first housing 111′. It is to be understood that the fifth connecting hole 167′ is an airflow port for allowing the cooling airflow to flow out of the battery accommodation compartment 15′. To ensure more sufficient heat dissipation of the cooling airflow, the fifth connecting hole 167′ is disposed above the first fan 216′ and the second fan 226′, and the fifth connecting hole 167′ is disposed at least below the first outlet 151′.

As shown in FIG. 27, since the first fan 216′ and the second fan 226′ are basically located in the accommodation housing 14′, the accommodation housing 14′ is provided with the first connecting hole 146′ and the second connecting hole 147′ corresponding to the first fan 216′ and the second fan 226′, respectively. In some examples, the positions of the first connecting hole 146′ and the second connecting hole 147′ are specifically determined according to the positions of the first fan 216′ and the second fan 226′. Of course, the first connecting hole 146′ and the second connecting hole 147′ may not be provided. It is ensured that the cooling airflow entering from the second air inlet 166′ and flowing through the battery pack 31′ and the control circuit board 18′ is generated by effectively utilizing the negative pressure generated by the rotation of the fans.

As shown in FIGS. 27 and 45, the airflow port further includes the first air outlet 162′ for allowing the cooling airflow to flow out of the body housing 11′. The first air outlet 162′ connects the accommodation housing 14′ and the first housing 111′ with the external environment. In this example, the air discharge direction of the first air outlet 162′ is toward the front side of the circular saw 100′. Optionally, the second electric motor 22′ is in front of the first electric motor 21′. In some examples, airflow guide ribs are provided in the first housing 111′ and are configured to guide the cooling airflow so that the cooling airflow flows within the space defined by the airflow guide ribs.

During the cutting operation, when the base plate bottom surface 51′ abuts against the workpiece to be cut, the control switch 81′ is triggered normally, at least the first electric motor 21′ is started, and the saw blade rotates, thereby cutting the workpiece to be cut. At the same time, at least the first fan 216′ rotates to form negative pressure, thereby driving external air into the interior of the circular saw 100′ to dissipate heat. After the fan rotates, the cooling airflow enters the battery accommodation compartment 15′ and the first housing 111′ from the second air inlet, and the cooling airflow flows through the battery pack 31′, the circuit board housing 19′, and the control circuit board 18′, then flows through the first electric motor 21′ and the second electric motor 22′ from the first connecting hole 146′, and flows out from the first air outlet 162′.

In this example, a second air outlet 163′ is further included. The second air outlet 163′ and the first air outlet 162′ have different air discharge directions. In this example, the second air outlet 163′ is disposed near the second electric motor 22′, and the second air outlet 163′ discharges air in a direction away from the saw blade so that the cooling airflow from the second air outlet 163′ has a dust blowing function in addition to the heat dissipation function. The dust generated during the cutting process can be blown away. Optionally, the second air outlet 163′ includes the third connecting hole 164′ configured to connect the accommodation housing 14′ and the first housing 111′ with the outside and the fourth connecting hole 165′ disposed on the sidewall of the base plate 50′ and configured to have the dust blowing function. As shown in FIG. 45, the air path includes the first heat dissipation air path F1 and the second heat dissipation air path F2. The first heat dissipation air path F1 is configured such that when at least one of the first electric motor 21′ and the second electric motor 22′ is operating, the cooling airflow enters from the second air inlet 166′ and flows through the battery pack 31′, the control circuit board 18′, and the electric motor assembly 20′, and then most of the cooling airflow flows out from the first air outlet 162′. The second heat dissipation air path F2 is configured such that when at least one of the first electric motor 21′ and the second electric motor 22′ is operating, the cooling airflow enters from the second air inlet 166′ and flows through the battery pack 31′, the control circuit board 18′, and the electric motor assembly 20′, and then most of the cooling airflow flows out from the second air outlet 163′.

In some examples, the circular saw 100′ is provided with both the first air inlet 161′ and the second air inlet 166′. In this manner, sufficient heat dissipation for the control circuit board 18′ and the electric motor assembly 20′ can be achieved.

In this example, one circuit board housing 19′ is provided, at least one controller is provided, and the number of control circuit boards 18′ corresponds to the number of controllers. Alternatively, multiple controllers may be disposed on one control circuit board 18′. The circuit board housing 19′ may accommodate at least one control circuit board 18′. Multiple controllers are connected communicatively or electrically.

As shown in FIG. 46, as an optional example, two circuit board housings 19′ are provided, and at least two control circuit boards 18′ are provided. Multiple controllers are provided on multiple control circuit boards 18′, thereby reducing the capacity requirements for the control circuit boards 18′. The circuit board housings 19′ and the control circuit boards 18′ are disposed outside the first fan 216′ and the second fan 226′ in the radial direction thereof. Optionally, the circuit board housings 19′ and the control circuit boards 18′ are disposed on the rear side of the first fan 216′ and the second fan 226′ in the radial direction thereof and between the battery accommodation compartment 15′ and the accommodation housing 14′. The circuit board housings 19′ include the first circuit board housing 19a′ and the second circuit board housing 19b′. The first circuit board housing 19a′ and the second circuit board housing 19b′ may have the same structures, thereby improving versatility. The first circuit board housing 19a′ and the second circuit board housing 19b′ may have different structures. The specific structures of the first circuit board housing 19a′ and the second circuit board housing 19b′ may be specifically set according to different specific positions of the first circuit board housing 19a′ and the second circuit board housing 19b′.

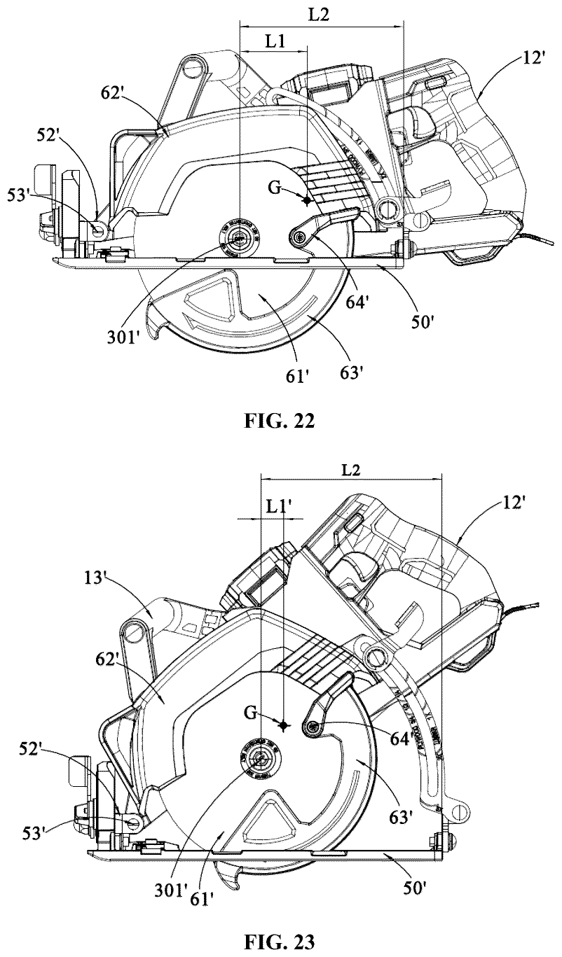

As shown in FIGS. 21 to 25, the cutting part 61′ in this example is the blade of the circular saw 100′ and has an outer diameter greater than 6 inches. In some examples, the blade of the circular saw 100′ has an outer diameter ranging from about 6 inches to 12′ inches. As shown in FIGS. 22 and 23, along a direction perpendicular to the cutting part 61′, the projection of the center of gravity G of the circular saw 100′ is located between the rear edge of the base plate 50′ and the output axis 301′. Optionally, FIG. 22 shows the circular saw 100′ in the first state in which the fixed guard 62′ is rotated about the pivot axis 501′ to the minimum angle relative to the base plate 50′. The ratio of the distance L1 between the projection of the center of gravity G of the circular saw 100′ and the output axis 301′ to the distance L2 between the rear edge of the base plate 50′ and the output axis 301′ is less than or equal to 1. In some examples, the ratio of the distance L1 between the projection of the center of gravity G of the circular saw 100′ and the output axis 301′ to the distance L2 between the rear edge of the base plate 50′ and the output axis 301′ is less than or equal to 0.9, 0.8, 0.7, 0.6, 0.5, 0.4, 0.3, or 0.2. The center of gravity G of the circular saw 100′ is closer to the output axis 301′ and is always located on the rear side of the output axis 301′, that is, located on a side of the output axis 301′ facing the grip 12′. FIG. 23 shows the circular saw 100′ in the second state. In this case, when the fixed guard 62′ is rotated about the pivot axis 501′ to the maximum angle relative to the base plate 50′, the distance L1′ between the center of gravity of the circular saw 100′ and the output axis 301′ is the smallest.

As shown in FIG. 24, the cutting part 61′ extends in a cutting plane S4, and the grip 12′ is basically symmetrically disposed about a first plane S1. Along a direction perpendicular to the base plate bottom surface 51′, the projections of the first drive shaft 201′ and the second drive shaft 202′ have two endpoints that are farthest apart along the direction of the output axis 301′. A width interval W is defined between two straight lines on the projection plane each of which passes through one endpoint and is perpendicular to the output axis 301′. The projection of the center of gravity G of the circular saw is set within the width interval W. In an example, the first electric motor and the second electric motor are arranged radially, and the first drive shaft and the second drive shaft are parallel to each other. Along a direction perpendicular to the base plate bottom surface 51′, the projections of the first drive shaft and the second drive shaft include a first endpoint closest to the cutting part and a second endpoint farthest from the cutting part, and the first endpoint and the second endpoint are the extreme endpoints in the left and right direction of the circular saw when the first drive shaft and the second drive shaft are regarded as a whole. The width interval W is defined between a straight line passing through the first endpoint and perpendicular to the output axis and a straight line passing through the second endpoint and perpendicular to the output axis, that is, the width interval W is the position interval of the whole machine within this width. The width interval in the front and rear direction of the circular saw is not limited to the front and rear range of the electric motor assembly but covers the front and rear range of the entire circular saw. In an example, the first electric motor and the second electric motor are arranged radially, and the first drive shaft and the second drive shaft intersect. Along a direction perpendicular to the base plate bottom surface 51′, the projections of the first drive shaft and the second drive shaft include a first endpoint closest to the cutting part and a second endpoint farthest from the cutting part, and the first endpoint and the second endpoint are the extreme endpoints in the left and right direction of the circular saw when the first drive shaft and the second drive shaft are regarded as a whole. The width interval W is defined between a straight line passing through the first endpoint and perpendicular to the output axis and a straight line passing through the second endpoint and perpendicular to the output axis, that is, the width interval W is the position interval of the whole machine within this width. The width interval in the front and rear direction of the circular saw is not limited to the front and rear range of the electric motor assembly but covers the front and rear range of the entire circular saw.

In an example, when the first electric motor and the second electric motor are coaxially arranged, along a direction perpendicular to the base plate bottom surface 51′, the projections of the first drive shaft and the second drive shaft include a first endpoint closest to the cutting part and a second endpoint farthest from the cutting part, and the first drive shaft and the second drive shaft are arranged left and right in the left and right direction of the circular saw. Therefore, the first endpoint is the leftmost end, and the second endpoint is the rightmost end. The width interval W is defined between a straight line passing through the first endpoint and perpendicular to the output axis and a straight line passing through the second endpoint and perpendicular to the output axis, that is, the width interval W is the position interval of the whole machine within this width. The width interval in the front and rear direction of the circular saw is not limited to the front and rear range of the electric motor assembly but covers the front and rear range of the entire circular saw. A bad operating feel of the circular saw 100′ during operation does not exist. The center of gravity of the circular saw is set within the width range of the first electric motor and the second electric motor in the width direction during operation so that the force applied to the whole machine is more stable during operation.

In some examples, along a direction perpendicular to the base plate bottom surface 51′, the projection of the center of gravity G of the circular saw 100′ is located between the projection of the cutting plane S4 and the right edge of the projection of the base plate, that is, the projection of the center of gravity G of the circular saw 100′ is located within the projection of the base plate and is not located on the left side of the projection of the cutting plane S4. Moreover, the center of gravity G of the circular saw 100′ is located near the first plane S1. Optionally, the distance between the center of gravity G of the circular saw 100′ and the first plane S1 is less than the distance between the center of gravity G of the circular saw 100′ and the cutting plane S4. Optionally, the ratio of the distance W1 between the projection of the center of gravity G of the circular saw 100′ and the first plane S1 to the distance W2 between the cutting plane S4 and the first plane S1 is less than or equal to 1/3. In some examples, the center of gravity G of the circular saw 100′ is disposed on the first plane S1 as much as possible, thereby not causing a bad operating feel of the circular saw 100′ during operation. Optionally, the center of gravity G of the circular saw 100′ may be located on the left side or the right side of the first plane S1.

The base plate 50′ is formed with a hole extending along the first direction K1 so that the cutting part 61′ can pass through the base plate 50′. As shown in FIG. 25, along the first direction K1, the ratio of the outer edge dimension L3 of the accommodation housing 14′ to the outer edge dimension La of the body housing 11′ is greater than or equal to 0.2 and less than or equal to 0.4. It is to be understood that, in some examples, the outer edge dimension L3 of the accommodation housing 14′ may be the same as the outer dimension Lc of the accommodation housing 14′ along the direction of the perpendicular of the first drive shaft 211′ and the second drive shaft 221′.

As shown in FIGS. 24 and 28, along the direction of the output axis 301′, the ratio of the outer edge dimension H1 of the accommodation housing 14′ to the outer edge dimension Ha of the body housing 11′ is greater than or equal to 0.15 and less than or equal to 0.4.

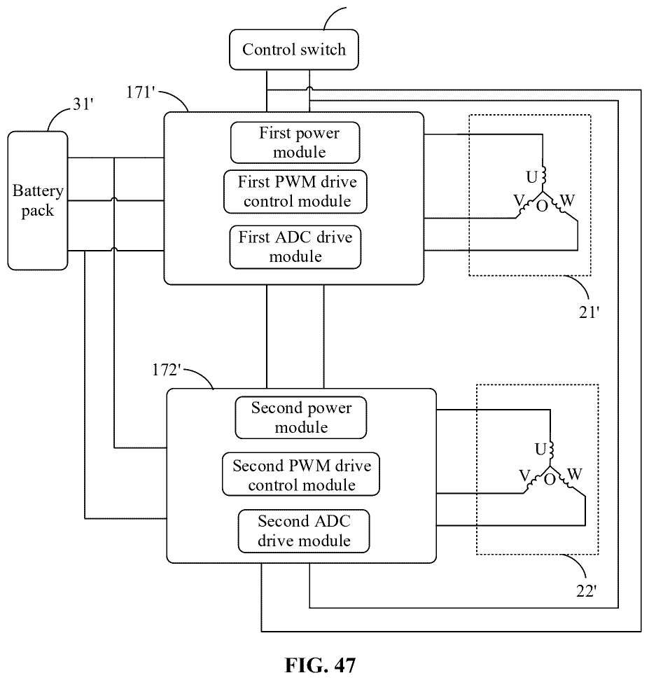

As shown in FIG. 47, the controller 17′ is configured to control the electric motor assembly 20′. The controller 17′ is configured to determine the start-up state of the first electric motor 21′ and the second electric motor 22′ according to a preset condition.

As an example, the controller includes a first controller 171′ and a second controller 172′, that is, dual-MCU control. In this example, the first controller 171′ includes a first power module, a first pulse-width modulation (PWM) drive control module, and a first analog-to-digital converter (ADC) drive module. The second controller 172′ includes a second power module, a second PWM drive control module, and a second ADC drive module. The battery pack 31′ supplies power to the first controller 171′ and the second controller 172′ separately. The first controller 171′ is connected to the first electric motor 21′, and the second controller 172′ is connected to the second electric motor 22′. It is to be understood that the first controller 171′ and the second controller 172′ are connected through serial communication and have relatively independent control modules.

The first controller 171′ collects electrical characteristic parameters such as phase current and bus voltage through the first ADC drive module, and the detected parameters are sent to the first PWM drive control module of the first controller 171′ in a signal mode. The first PWM drive control module controls the start-up and operation of the first electric motor 21′ through a PWM signal. The second controller 172′ collects electrical characteristic parameters such as phase current and bus voltage through the second ADC drive module, and the detected parameters are sent to the second PWM drive control module of the second controller 172′ in a signal mode. The second PWM drive control module controls the start-up and operation of the second electric motor 22′ through a PWM signal. It is equivalent to providing two independent control circuits to control the first electric motor 21′ and the second electric motor 22′. The electrical characteristic parameters may further include bus current, freewheeling time, demagnetization time, and other parameters.

In this example, the first electric motor 21′ and the second electric motor 22′ are each a three-phase brushless motor. The three-phase brushless motor includes electronically commutated three-phase stator windings U, V, and W. In some examples, the three-phase stator windings U, V, and W adopt a star connection. In some other examples, the three-phase stator windings U, V, and W adopt a delta connection. However, it is to be understood that other types of brushless motors are also within the scope of the present disclosure. The brushless motor may include less than or more than three phases. A driver circuit is electrically connected to the stator windings U, V, and W of the electric motor and configured to transmit the current from the battery pack 31′ to the stator windings U, V, and W to drive the electric motor to rotate.

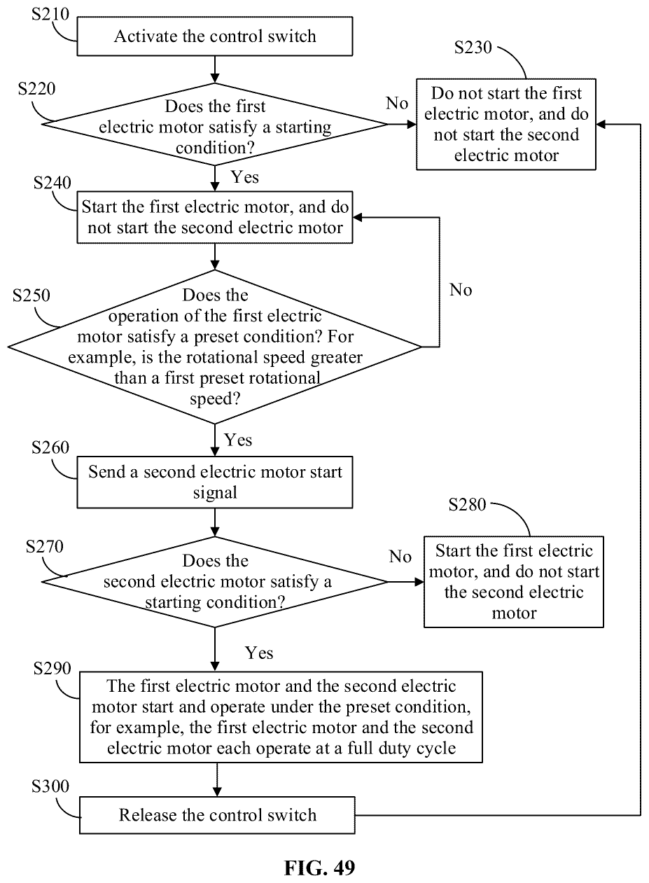

As shown in FIG. 49, the specific control process is described below.

In S210, the control switch 81′ is activated.

During operation, the first controller 171′ detects that the control switch 81′ is activated, that is, a start signal is received.

In S220, whether the first electric motor satisfies a starting condition is determined. If so, S240 is performed; if not, S230 is performed.

In S230, the first electric motor is not started, and the second electric motor is not started.

In S240, the first electric motor is started, and the second electric motor is not started.

The first controller 171′ controls the first electric motor 21′ to start with a first preset step size.

In S250, whether the operation of the first electric motor satisfies a preset condition is determined, for example, whether the rotational speed is greater than a first preset rotational speed is determined. If so, S260 is performed. If not, S240 is performed.

In S260, a second electric motor start signal is sent.

In S270, whether the second electric motor satisfies a starting condition is determined. If so, S290 is performed; if not, S280 is performed.

In S280, the first electric motor is started, and the second electric motor is not started.

In S290, the first electric motor and the second electric motor start and operate under the preset condition, for example, the first electric motor and the second electric motor each operate at a full duty cycle.

The first controller 171′ sends a signal to the second controller that controls the second electric motor 22′ so that the second controller starts the second electric motor 22′. The second controller 172′ controls the second electric motor 22′ to start with a second preset step size. The second preset step size is greater than or equal to the first preset step size, thereby shortening the start-up duration of the two electric motors. In this example, after the first electric motor 21′ starts and stabilizes, the first electric motor 21′ operates at a full duty cycle. After the second electric motor 22′ starts and stabilizes, the first electric motor 21′ and the second electric motor 22′ each operate at a full duty cycle. It is to be understood that the change in the rotational speed of the electric motor can be obtained through modulation and calculation of the electrical characteristic parameters of the electric motor such as phase current. The full duty cycle does not necessarily mean a duty cycle of 100%. The full duty cycle refers to the maximum duty cycle in the product performance specifications and may be a duty cycle of 90%, a duty cycle of 80%, or the like.

In S300, the control switch is released. S230 in which the first electric motor is not started and the second electric motor is not started is performed.

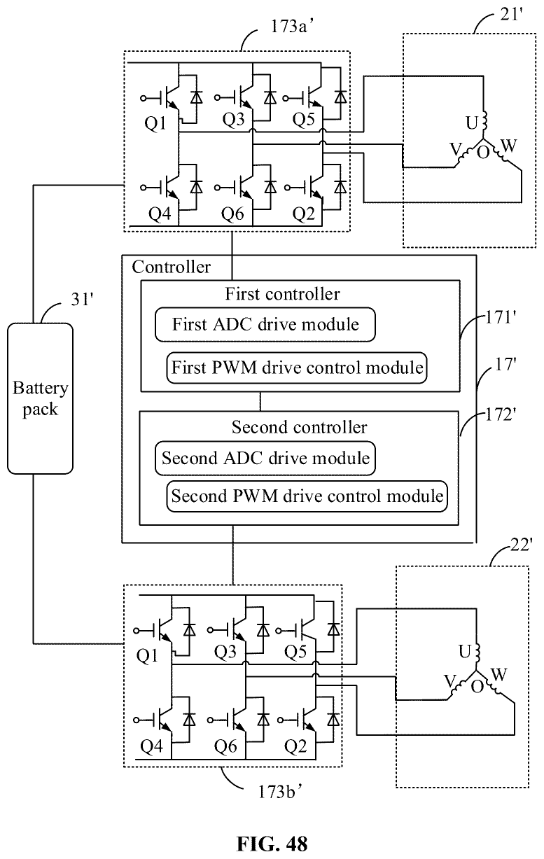

As an example, as shown in FIG. 48, the controller 17′ includes the first controller 171′ and the second controller 172′. The first controller 171′ and the second controller 172′ are disposed on the same control circuit board 18′. Alternatively, the first controller 171′ and the second controller 172′ are placed on different control circuit boards, respectively, and the two control circuit boards are communicatively connected. The first controller 171′ controls the first electric motor 21′, and the second controller 172′ controls the second electric motor 22′. In this example, serial communication between the first controller 171′ and the second controller 172′ exists. A driver including a first driver circuit 173a′ and a second driver circuit 173b′ is further provided. The first driver circuit 173a′ is connected to the first controller 171′ and the battery pack 31′. The second driver circuit 173b′ is connected to the second controller 172′ and the battery pack 31′. That is to say, the battery pack 31′ is connected to the driver circuits and supplies power to the controllers through the driver circuits.

In this example, the first electric motor 21′ and the second electric motor 22′ are each a three-phase brushless motor. The three-phase brushless motor includes electronically commutated three-phase stator windings U, V, and W. In some examples, the three-phase stator windings U, V, and W adopt a star connection. In some other examples, the three-phase stator windings U, V, and W adopt a delta connection. However, it is to be understood that other types of brushless motors are also within the scope of the present disclosure. The brushless motor may include less than or more than three phases.

The first driver circuit 173a′ is used as an example. The driver circuit 173a′ is electrically connected to the stator windings U, V, and W of the electric motor and configured to transmit the current from the battery pack 31′ to the stator windings U, V, and W to drive the electric motor to rotate. The first driver circuit 173a′ includes multiple switching elements Q1, Q2, Q3, Q4, Q5, and Q6. A gate terminal of each switching element is electrically connected to the first controller 171′ and configured to receive a control signal from the first controller 171′. A drain or source of each switching element is connected to the stator windings U, V, and W of the first electric motor 21′. The switching elements Q1 to Q6 receive control signals from the first controller 171′ to change their respective on states, thereby changing the current loaded by the battery pack 31′ to the stator windings U, V, and W of the first electric motor 21′. In an example, the first driver circuit 173a′ may be a three-phase bridge driver circuit including six controllable semiconductor power devices (such as field-effect transistors (FETs), bipolar junction transistors (BJTs), or insulated-gate bipolar transistors (IGBTs)). In some examples, the driver circuit 173a′ may include more than six controllable semiconductor power devices. It is to be understood that the preceding switching elements may be any other types of solid-state switches, such as the IGBTs or the BJTs.

Specifically, the controller controls the on or off states of the switching elements in the driver circuit through the control chip. In some examples, the controller controls the ratio of the on time of a drive switch to the off time of the drive switch based on a PWM signal. In this example, the first controller 171′ includes the first PWM drive control module. The second controller 172′ includes the second PWM drive control module.

The first controller 171′ further includes the first ADC drive module through which electrical characteristic parameters such as phase current and bus voltage are collected. The second controller 172′ further includes the second ADC drive module through which electrical characteristic parameters such as phase current and bus voltage are collected.

When the power circuit between the battery pack 31′ and the driver circuit is turned on, the driver circuit transmits the current from the battery pack 31′ to the controller. That is, the first driver circuit 173a′ transmits the current to the first controller 171′, and the second driver circuit 173b′ transmits the current to the second controller 172′. The first controller 171′ detects preset parameters through the first ADC drive module and sends the detected parameters to the first PWM drive control module of the first controller 171′ in a signal mode. The first PWM drive control module sends a PWM control signal to the first driver circuit 173a′, and the ratio between the on time of the drive switch and the off time of the drive switch is controlled based on the PWM control signal. The second controller 172′ detects preset parameters through the second ADC drive module and sends the detected parameters to the second PWM drive control module of the second controller 172′ in a signal mode. The second PWM drive control module sends a PWM control signal to the second driver circuit 173b′, and the ratio between the on time of the drive switch and the off time of the drive switch is controlled based on the PWM control signal. The preset parameters include phase current, bus voltage, bus current, freewheeling time, demagnetization time, and other parameters. The preset parameters detected by the first controller 171′ and the preset parameters detected by the second controller 172′ may be the same or different.

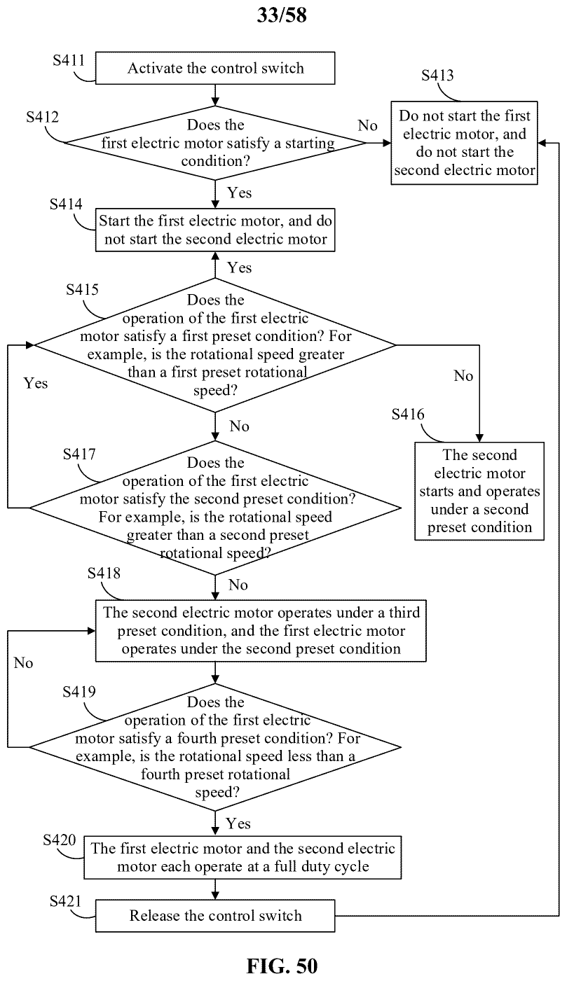

As shown in FIG. 50, the specific control process is described below.

In S411, the control switch 81′ is activated.

During operation, the first controller 171′ detects that the control switch 81′ is activated, that is, a start signal is received.

In S412, whether the first electric motor satisfies a starting condition is determined. If so, S414 is performed. If not, S413 is performed.

In S413, the first electric motor is not started, and the second electric motor is not started.

In S414, the first electric motor is started, and the second electric motor is not started. The first controller 171′ controls the first electric motor 21′ to start.

In S415, whether the operation of the first electric motor satisfies a first preset condition is determined, for example, whether the rotational speed is greater than a first preset rotational speed is determined. If so, S414 is performed; if not, S416 and S417 are performed.

The rotational speed is used as an example. The first controller 171′ first determines the relationship between the rotational speed of the first electric motor 21′ and a first rotational speed threshold. If the rotational speed of the first electric motor 21′ is greater than the first rotational speed threshold, the first electric motor 21′ maintains the current operation state to drive the output shaft 30′, and the second electric motor 22′ does not need to be started. Optionally, the first rotational speed threshold is 5000 RPM.

In S416, the second electric motor starts and operates under a second preset condition.

Optionally, the second electric motor 22′ enters a hot standby state, that is, the second electric motor starts and maintains a ready state for operation under the second preset condition. Optionally, the rotational speed is used as an example. A second preset rotational speed is less than the first rotational speed threshold, and the second preset rotational speed is the rotational speed at which the second electric motor achieves the optimal output efficiency. Optionally, the second preset rotational speed is 4500 RPM.

In S417, whether the operation of the first electric motor satisfies the second preset condition is determined, for example, whether the rotational speed is greater than a second preset rotational speed is determined. If so, S415 is performed; if not, S418 is performed.

In S418, the second electric motor operates under a third preset condition, and the first electric motor operates under the second preset condition.

When the rotational speed of the first electric motor 21′ is less than the second preset rotational speed, the second electric motor 22′ starts and operates under the third preset condition. At the same time, the first electric motor 21′ is controlled to output at the second preset rotational speed. Optionally, the third preset condition is to control the second electric motor 22′ to operate at the maximum duty cycle after the second electric motor 22′ is started. The first electric motor operates at a constant speed, which is the second preset rotational speed. That is to say, in this case, both the first electric motor 21′ and the second electric motor 22′ start to drive the output shaft. The dual-motor mode starts.

In S419, whether the operation of the first electric motor satisfies a fourth preset condition is determined, for example, whether the rotational speed is less than a fourth preset rotational speed is determined. If so, S420 is performed; if not, S418 is performed.

The rotational speed of the first electric motor is continuously detected during the operation process. When the operation of the first electric motor 21′ satisfies the fourth preset condition, optionally, when the rotational speed is less than the fourth preset rotational speed, it is determined that the output torque of the electric motor assembly in this case can satisfy the currently required torque of the output shaft. Optionally, the fourth preset rotational speed is less than the second preset rotational speed. For example, the fourth preset rotational speed is 3500 RPM.

In S420, the first electric motor and the second electric motor each operate at a full duty cycle.

When the rotational speed is less than the fourth preset rotational speed, it is determined that the output torque of the electric motor assembly in this case needs to be increased, and then the first electric motor 21′ and the second electric motor 22′ are controlled to each operate at a full duty cycle. The maximum duty cycle of the first electric motor 21′ and the maximum duty cycle of the second electric motor 22′ may be the same or different.

To avoid frequent switching between the single-motor mode and the dual-motor mode, in actual applications, in the dual-motor mode, only if the rotational speed is greater than 5000 RPM and the current is less than a current threshold for a preset time, single-motor operation starts.

In S421, the control switch is released. S413 in which the first electric motor is not started and the second electric motor is not started is performed.

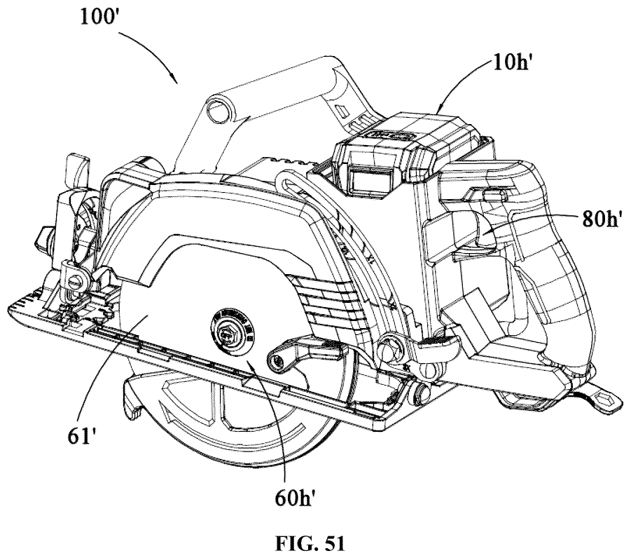

FIGS. 51 to 58 show a power tool according to another example. The power tool is similar to the power tool described above with reference to FIGS. 21 to 50. Therefore, features and elements that correspond to features and elements of the power tool are given similar reference numerals followed by the letter “h”. In addition, the following description mainly focuses on the difference between the control elements and the difference between the control methods of an electric motor assembly 20h′ in the power tool.

Referring to FIG. 51, the power tool includes a housing 10h′, a functional piece 60h′, and an operating member 80h′. The housing 10h′ constitutes a body of the power tool, connects or supports the preceding components, and forms an accommodation space capable of accommodating or partially accommodating other components. The functional piece 60h′ is a component in the power tool that actually performs operations such as cutting, tightening, grinding, and impacting. An electric circular saw 100′ is used as an example, the functional piece 60h′ of the electric circular saw 100′ is the cutting part 61′, and the cutting part 61′ is a circular saw blade. The functional piece 60h′ of another power tool may be a chain, a drill bit, or the like. The operating member 80h′ is operated by the user to switch the on/off state of the power tool and may output a corresponding start signal or a corresponding shutdown signal. For example, the operating member 80h′ may be used by the user to start or shut down an electric motor assembly 20h′ described later and output a start signal indicating that the electric motor assembly 20h′ is expected to start or a shutdown signal indicating that the electric motor assembly 20h′ is expected to shut down to a controller 17h′ described later. In some cases, the operating member 80h′ may have more diverse functions. For example, the operating member 80h′ may be operated by the user to adjust the rotational speed of the electric motor or implement other functions. In some examples, the operating member 80h′ may be a trigger or another mechanical switch, for example, the control switch 81′. It is to be understood that the start-up and shutdown of the power tool may be achieved in other methods besides providing the operating member 80h′ on the tool body. For example, in some examples, the user may transmit signals to the power tool through an external device such as a mobile phone or a tablet computer to start or shut down the power tool.

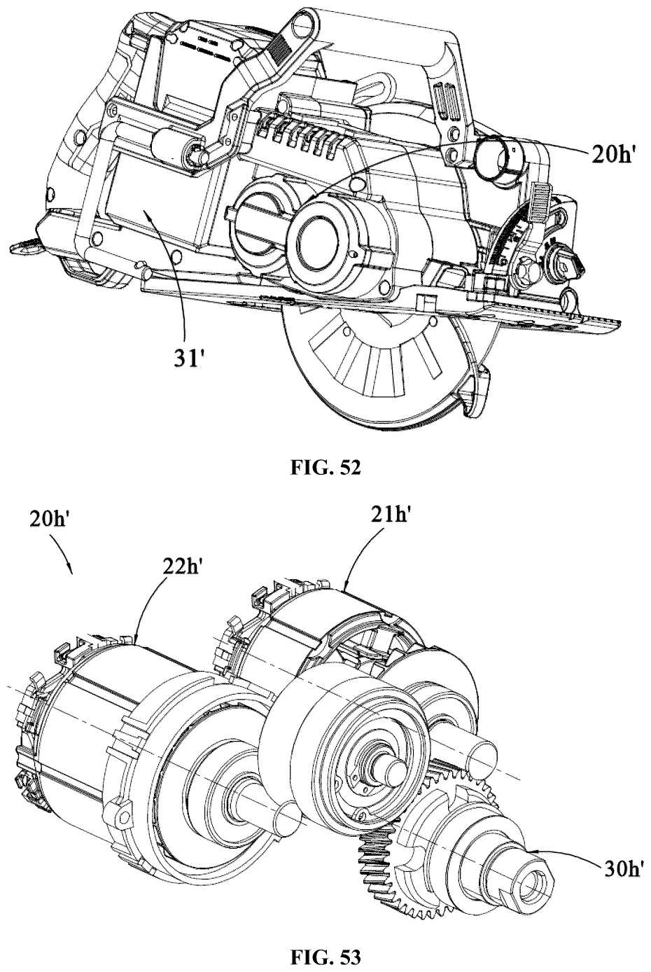

Referring to FIGS. 52 to 55, in addition to the housing 10h′, the functional piece 60h′, and the operating member 80h′, the power tool further includes an electric motor assembly 20h′, the power supply 31′, and a controller 17h′. The electric motor assembly 20h′ is a prime mover of the power tool. When the motor shaft of the electric motor assembly 20h′ rotates, the functional piece 60h′ assembled on an output shaft 30h′ is driven directly or indirectly through a transmission assembly to operate. In the present application, the power tool is provided with at least two electric motors, that is, the electric motor assembly 20h′ includes at least a first electric motor 21h′ and a second electric motor 22h′. The first electric motor 21h′ and the second electric motor 22h′ drive the same output shaft 30h′. A transmission relationship exists between the first electric motor 21h′ and the second electric motor 22h′. In other words, when the first electric motor 21h′ rotates, the first electric motor 21h′ can drive the second electric motor 22h′ to rotate.

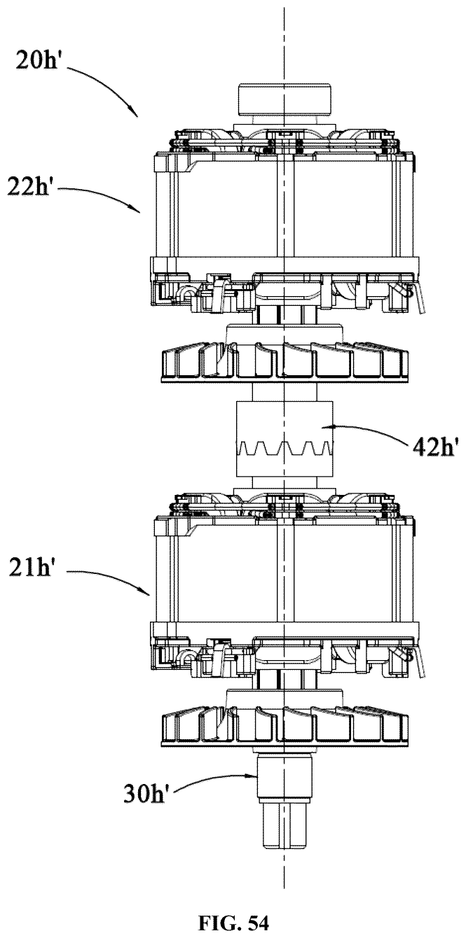

FIG. 53 shows an optional structure of the electric motor assembly 20h′, the first electric motor 21h′ and the second electric motor 22h′ are each an inrunner, the motor shaft of the first electric motor 21h′ and the motor shaft of the second electric motor 22h′ are both parallel to the output shaft 30h′, and a gearset may be used for achieving power transmission between the motor shafts and the output shaft 30h′. FIG. 54 shows another optional structure of the electric motor assembly 20h′, the first electric motor 21h′ and the second electric motor 22h′ are each an inrunner, the motor shaft of the first electric motor 21h′, the motor shaft of the second electric motor 22h′, and the output shaft 30h′ are collinear, a clutch assembly 42h′ may be provided between the first electric motor 21h′ and the second electric motor 22h′, the clutch assembly 42h′ has a first state in which the clutch assembly 42h′ allows power transmission between the first electric motor 21h′ and the second electric motor 22h′ and a second state in which the clutch assembly 42h′ prevents power transmission between the first electric motor 21h′ and the second electric motor 22h′, and the clutch assembly 42h′ may be mechanical or electronic. The following mainly explains the technical solution based on the case where the electric motor assembly 20h′ includes the first electric motor 21h′ and the second electric motor 22h′. At least one of the first electric motor 21h′ and the second electric motor 22h′ can drive the functional piece 60h′ to perform operations such as cutting, tightening, grinding, and impacting. The following mainly describes the scenario where both the first electric motor 21h′ and the second electric motor 22h′ are working. It is to be understood that the structures of the first electric motors 21′, 21e′, 21f′, and 21g′ and the second electric motors 22′, 22e′, 22f′, and 22g′ as described in FIGS. 32′ to 39′ are structures applicable to this example.

The power supply 31′ provides electrical energy for at least the electric motor assembly 20h′ and may also supply power to other related components and assemblies such as the controller 17h′. In some examples, the power supply 31′ is a battery pack detachably connected to the power tool. In some other examples, the power supply 31′ may be implemented using mains power or the alternating current power supply in conjunction with a power adapter and related circuits such as the transformer circuit, the rectifier circuit, and the voltage regulator circuit.

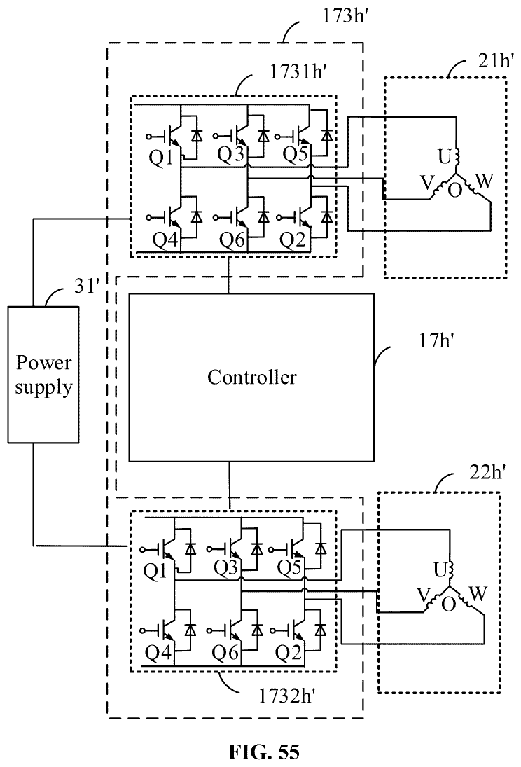

The controller 17h′ may be an MCU, an Advanced reduced instruction set computer (RISC) Machine (ARM), a digital signal processor (DSP), or the like. By running the relevant programs, the controller 17h′ may control the electric motor assembly 20h′ to operate in an intended manner. Referring to FIG. 55, the power tool further includes a driving device 173h′ connected between the controller 17h′ and the electric motor assembly 20h′. After the controller 17h′ runs the control programs for the electric motors, the controller 17h′ may output control signals such as PWM signals to the driving device 173h′. The driving device 173h′ may convert the preceding control signals into drive signals that ultimately drive the electric motors to operate and transmit the electrical energy provided by the power supply 31′ to the electric motor assembly 20h′ through the direct current buses.

In some examples, the driving device 173h′ includes a first driver circuit 1731h′ connected between the controller 17h′ and the first electric motor 21h′ and a second driver circuit 1732h′ connected between the controller 17h′ and the second electric motor 22h′. The first driver circuit 1731h′ and the second driver circuit 1732h′ may each include a three-phase bridge circuit formed by three switching transistors as the upper half bridge and three switching transistors as the lower half bridge. The upper half bridge switching transistors Q1, Q3, and Q5 in the first driver circuit 1731h′ are connected between the power supply terminal of the power supply 31′ and the phase coils of the first electric motor 21h′, respectively, and the lower half bridge switching transistors Q2, Q4, and Q6 are connected between the phase coils of the first electric motor 21h′ and the ground wire, respectively. The same goes for the second driver circuit 1732h′ and the second electric motor 22h′. The switching transistors may be FETs or IGBTs. In some other examples, the driving device 173h′ may be an integrated driver chip or the like.

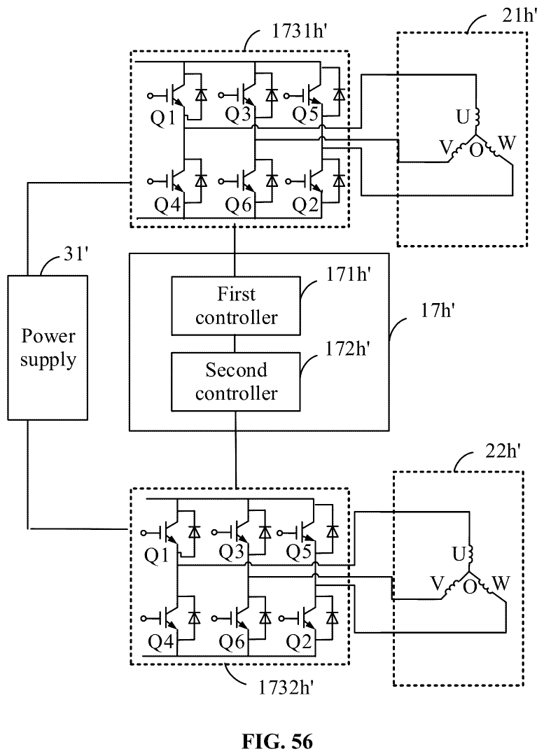

In addition, as shown in FIG. 56, in some examples, hardware includes more than one controller 17h′. For example, the power tool may be provided with a first controller 171h′ and a second controller 172h′ which exchange data through an electrical connection or in other manners. The first controller 171h′ is responsible for the operation control of the first electric motor 21h′ and transmits a first control signal to the first driver circuit 1731h′. The first driver circuit 1731h′ is connected between the first controller 171h′ and the first electric motor 21h′. The second controller 172h′ is responsible for the operation control of the second electric motor 22h′ and transmits a second control signal to the second driver circuit 1732h′. The second driver circuit 1732h′ is connected between the second controller 172h′ and the second electric motor 22h′. In some other examples, the first controller 171h′ and the second controller 172h′ may be two controllers at the software level. For example, the first controller 171h′ and the second controller 172h′ are two virtual central processing units (vCPUs) carried by the same hardware or a first control unit and a second control unit designed in the program including parallel processes or threads.

Based on the above, the controller 17h′ needs to preliminarily determine the initial positions of the rotors of the electric motors when starting the electric motors, and the power tool is provided with the first electric motor 21h′ and the second electric motor 22h′; moreover, in the case where a transmission relationship exists between the first electric motor 21h′ and the second electric motor 22h′, the rotation of any electric motor drives the rotation of the other electric motor. Therefore, a problem in which the positions of the rotors of the two electric motors affect each other when the electric motors are controlled to start exists. To address the preceding problem, in an example, the controller 17h′ may control the first electric motor 21h′ and the second electric motor 22h′ to start simultaneously. In response to the start signal from the operating member 80h′ or other signals for starting the power tool, the controller 17h′ simultaneously outputs corresponding control signals to the first driver circuit 1731h′ corresponding to the first electric motor 21h′ and the second driver circuit 1732h′ corresponding to the second electric motor 22h′. In some examples, the first controller 171h′ outputs the first control signal to the first driver circuit 1731h′ to drive the first electric motor 21h′, the second controller outputs the second control signal to the second driver circuit 1732h′ to drive the second electric motor 22h′, and the first controller 171h′ and the second controller 172h′ synchronize signals before outputting control signals to ensure that the first electric motor 21h′ and the second electric motor 22h′ are started simultaneously. In another example, the controller 17h′ may start the electric motor assembly 20h′ in a time-sharing manner, thereby eliminating the need for signal synchronization; and the electric motors are started in the case where the peak currents do not occur at the same time, thereby ensuring safety.

In response to the start signal from the operating member 80h′ or other signals for starting the power tool, the controller 17h′ first controls the first electric motor 21h′ to start and based on the back electromotive force generated by the second electric motor 22h′ being driven by the first electric motor 21h′ after the first electric motor 21h′ is started, controls the second electric motor 22h′ to start. Specifically, after started by the controller 17h′, the first electric motor 21h′ rotates, the rotation of the rotor of the first electric motor 21h′ drives the rotor of the second electric motor 22h′, which has not yet been started, to rotate, the passive rotation of the rotor of the second electric motor 22h′ leads to electromagnetic induction of the stator windings of the second electric motor 22h′, the second electric motor 22h′ generates the back electromotive force, and based on the back electromotive force of the second electric motor 22h′, the controller 17h′ controls the second electric motor 22h′ to start after the first electric motor 21h′ is started. It is to be noted that in this example, the second electric motor 22h′ may be a sensorless brushless motor and does not have a position sensor such as a Hall sensor that can directly detect the rotor position. In this case, the controller 17h′ controls the start of the second electric motor 22h′ by detecting the back electromotive force of the second electric motor 22h′. Of course, in the case where the second electric motor 22h′ is provided with a position sensor, the controller 17h′ may also use the preceding manner as an alternative solution for starting the second electric motor 22h′.

It is to be understood that the first electric motor 21h′ may be a sensorless brushless motor or a sensored brushless motor. Correspondingly, there are many optional implementation methods for the controller 17h′ to control the first electric motor 21h′ to start first, which is not specifically limited in the present application. In some examples, the controller 17h′ may estimate the initial position of the rotor of the first electric motor 21h′ in a pulse injection method and control the first electric motor 21h′ to start. The controller 17h′ may inject pulses into six electrical angle sectors of the first electric motor 21h′, respectively, that is, transmit corresponding pulse signals to the six switching transistors in the first driver circuit 1731h′; and then the controller 17h′ may detect the current response of the first electric motor 21h′ to the pulse injection, determine the initial position of the rotor of the first electric motor 21h′ based on the current response, and control the start of the first electric motor 21h′ based on the initial position of the rotor. In some other examples, the controller 17h′ may control the start of the first electric motor 21h′ in a high-frequency injection method. In some other examples, the controller 17h′ may control the start of the first electric motor 21h′ by capturing the jumping edge for Hall signals.

In some examples, after controlling the first electric motor 21h′ to start, the controller 17h′ may perform detection after a first preset duration and then based on the back electromotive force of the second electric motor 22h′, control the second electric motor 22h′ to start. Specifically, after the first electric motor 21h′ is started for the first preset duration, the first electric motor 21h′ continues rotating and has a certain rotational speed so that the back electromotive force of the second electric motor 22h′ driven by the first electric motor 21h′ can be detected more accurately and can be used for startup control. In this case, the controller 17h′ can estimate the position of the rotor of the second electric motor 22h′ based on the back electromotive force of the second electric motor 22h′ and control the second electric motor 22h′ to start. If the first preset duration is too short, the first electric motor 21h′ and the second electric motor 22h′ interfere with each other, and both the start of the first electric motor 21h′ and the start of the second electric motor 22h′ are affected. If the first preset duration is too long, the first electric motor 21h′ has a great influence on the passive rotation of the second electric motor 22h′, and the startup control of the second electric motor 22h′ is difficult. Therefore, the first preset duration with an appropriate value needs to be set. In some examples, the first preset duration is greater than or equal to 0.1 s and less than or equal to 2 s.

In some other examples, after controlling the first electric motor 21h′ to start, the controller 17h′ may detect the rotational speed of the first electric motor 21h′, perform detection after the rotational speed of the first electric motor 21h′ reaches the first rotational speed threshold, and based on the back electromotive force of the second electric motor 22h′, control the second electric motor 22h′ to start. Specifically, after the first electric motor 21h′ is started and reaches the first rotational speed threshold, the back electromotive force of the second electric motor 22h′ driven by the first electric motor 21h′ can be detected more accurately and can be used for startup control. In this case, the controller 17h′ can estimate the position of the rotor of the second electric motor 22h′ based on the back electromotive force of the second electric motor 22h′ and control the second electric motor 22h′ to start. In some examples, the first rotational speed threshold is greater than or equal to 10 RPM or greater than or equal to 10% of the no-load rotational speed of the first electric motor 21h′.

There are many optional implementation methods for the controller 17h′ to control the start of the second electric motor 22h′ based on the back electromotive force of the second electric motor 22h′, which is not specifically limited in the present application. In some examples, the controller 17h′ may detect the extreme value of the back electromotive force of the second electric motor 22h′, that is, detect the maximum value or minimum value of the back electromotive force of the second electric motor 22h′; and the controller 17h′ may deduce the rotor position based on the extreme value of the back electromotive force of the second electric motor 22h′ and then perform startup control. In some other examples, the controller 17h′ may detect the relative relationship between the back electromotive force and the zero-point potential of the second electric motor 22h′, deduce the rotor position from the position of the zero-crossing of the back electromotive force of the second electric motor 22h′, and then perform startup control.

Based on the above, the power tool is provided with the first controller 171h′ and the second controller 172h′ that are responsible for starting and controlling the first electric motor 21h′ and the second electric motor 22h′, respectively. In response to the start signal from the operating member 80h′ or other signals for starting the power tool, the first controller 171h′ may control the first electric motor 21h′ to start, and then based on the back electromotive force of the second electric motor 22h′, the second controller 172h′ may control the second electric motor 22h′ to start. In some cases, after the first controller 171h′ executes the startup procedure of the first electric motor 21h′ in response to the relevant start signal, the first controller 171h′ may send a notification to the second controller 172h′ so that the second controller 172h′ starts to execute the startup procedure of the second electric motor 22h′. In some other cases, in response to the relevant start signals, the first controller 171h′ and the second controller 172h′ may spontaneously execute the startup procedures of the first electric motor 21h′ and the second electric motor 22h′ in sequence. In some examples, the first controller 171h′ may control the first electric motor 21h′ to start for the first preset duration and then notify the second controller 172h′. After receiving the notification, based on the back electromotive force of the second electric motor 22h′, the second controller 172h′ may control the second electric motor 22h′ to start. In some other examples, after the first controller 171h′ controls the first electric motor 21h′ to start and detects that the rotational speed of the first electric motor 21h′ reaches the first rotational speed threshold, the first controller 171h′ may notify the second controller 172h′. After receiving the notification, based on the back electromotive force of the second electric motor 22h′, the second controller 172h′ may control the second electric motor 22h′ to start. In some other examples, after controlling the first electric motor 21h′ to start, the first controller 171h′ may notify the second controller 172h′. The second controller 172h′ receives the notification, and then after the first preset duration or after it is detected that the rotational speed of the first electric motor 21h′ reaches the first rotational speed threshold, based on the back electromotive force of the second electric motor 22h′, the second controller 172h′ may control the second electric motor 22h′ to start. In some other examples, after receiving the relevant start signal, the first controller 171h′ may control the first electric motor 21h′ to start. The second controller 172h′ receives the relevant start signal, and then after the first preset duration or after it is detected that the rotational speed of the first electric motor 21h′ reaches the first rotational speed threshold, based on the back electromotive force of the second electric motor 22h′, the second controller 172h′ may control the second electric motor 22h′ to start. It is to be understood that, in the case of two controllers, whether the mutual notification exists between the controllers and which controller 17h′ performs timing statistics or rotational speed detection are not the focus of the solution of the present application and do not affect the scope of the present application.

In addition, the specific control method for the controller 17h′ to drive the electric motor to operate after the electric motor is started is not limited in the present application. The operation of the electric motor assembly 20h′ may be controlled in a six-step commutation method or a field-oriented control (FOC) method. Of course, other methods for controlling the electric motor may be adaptively introduced.

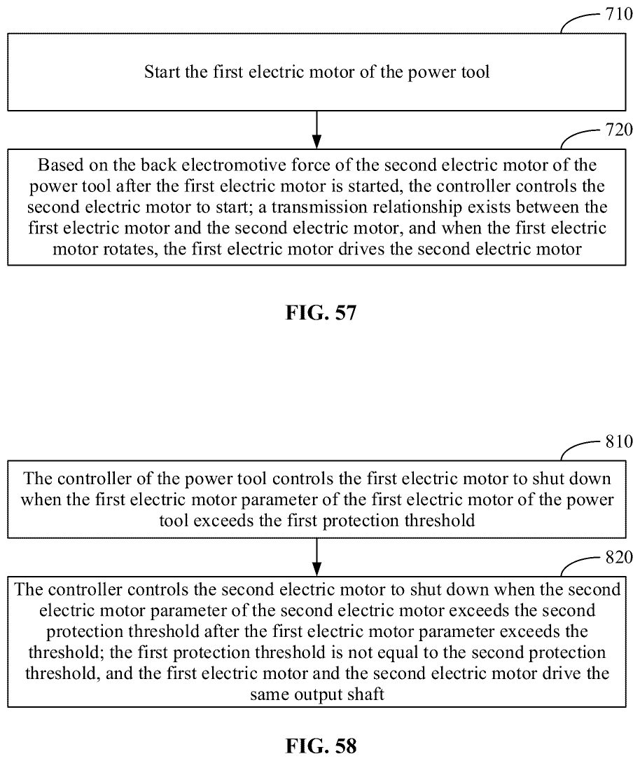

Correspondingly, a control method for a power tool is proposed and applied to the power tool described above. FIG. 57 shows a process flow of the control method for a power tool. The control method may include the steps below.

In S710, the first electric motor 21h′ of the power tool is started.

In S720, based on the back electromotive force of the second electric motor 22h′ of the power tool after the first electric motor 21h′ is started, the controller 17h′ of the power tool controls the second electric motor 22h′ to start; a transmission relationship exists between the first electric motor 21h′ and the second electric motor 22h′, and when the first electric motor 21h′ rotates, the first electric motor 21h′ drives the second electric motor 22h′ to rotate.

Based on the above, since the first electric motor 21h′ and the second electric motor 22h′ share the same power supply 31′ to achieve power supply, if the first electric motor 21h′ and the second electric motor 22h′ are controlled to perform shutdown protection at the same time, the peak currents of the two electric motors during shutdown protection are superimposed in the bus, causing damage to semiconductor components and interfering with the determination of related control logic. To address the preceding problem, the controller 17h′ may set different protection thresholds for different electric motors to achieve time-sharing shutdown protection of the electric motor assembly 20h′, thereby ensuring the safety of the shutdown of the electric motors since the peak currents do not occur at the same time.

The controller 17h′ may control the first electric motor 21h′ to shut down when a first electric motor parameter of the first electric motor 21h′ exceeds a first protection threshold and control the second electric motor 22h′ to shut down when a second electric motor parameter of the second electric motor 22h′ exceeds a second protection threshold. The first protection threshold is not equal to the second protection threshold, and a certain time interval exists between the moment when the first electric motor parameter exceeds the first protection threshold and the moment when the second electric motor parameter exceeds the second protection threshold. It is assumed in the following that the first electric motor parameter exceeds the first protection threshold before the second electric motor parameter exceeds the second protection threshold for exemplary explanation. However, it is to be understood that by adjusting the values of the first protection threshold and the second protection threshold, the first electric motor 21h′ may be shut down first, or the second electric motor 22h′ may be shut down first, which does not affect the scope of the present application.

It is to be noted here that many different parameter types exist for the electric motor parameters of the first electric motor 21h′ and the second electric motor 22h′, many different threshold types exist for the protection thresholds, and a corresponding relationship exists between the electric motor parameter and the protection threshold, that is, the corresponding protection threshold is used for determining whether the corresponding electric motor parameter exceeds the corresponding protection threshold. Moreover, in the preceding solution, the first electric motor parameter and the second electric motor parameter to be compared and determined in sequence should be of the same parameter type, that is, it is not the case where whether the first electric motor parameter of one parameter type exceeds the corresponding first protection threshold is determined and then whether the second electric motor parameter of another parameter type exceeds the corresponding second protection threshold is determined.

In some examples, the first electric motor parameter includes a first locked-rotor parameter, and the first protection threshold includes a first locked-rotor threshold corresponding to the first locked-rotor parameter. Correspondingly, the second electric motor parameter includes a second locked-rotor parameter, and the second protection threshold includes a second locked-rotor threshold corresponding to the second locked-rotor parameter. The first locked-rotor threshold is not equal to the second locked-rotor threshold. The controller 17h′ detects that the first locked-rotor parameter of the first electric motor 21h′ exceeds the first locked-rotor threshold and controls the first electric motor 21h′ to shut down; and then the controller 17h′ detects that the second locked-rotor parameter of the second electric motor 22h′ exceeds the second locked-rotor threshold and controls the second electric motor 22h′ to shut down.

In some examples, the locked-rotor parameter is the commutation duration, the first locked-rotor parameter is the first commutation duration of the first electric motor 21h′, the first locked-rotor threshold is the first duration threshold, the second locked-rotor parameter is the second commutation duration of the second electric motor 22h′, and the second locked-rotor threshold is the second duration threshold. The ratio of the commutation duration of one electric motor to the commutation duration of the other electric motor is related to the rotational speeds of the two electric motors. If the rotational speed ratio of the first electric motor 21h′ and the second electric motor 22h′ that drive the same output shaft 30h′ is n:1, or in other words, the ratio of the gear ratio of the first electric motor 21h′ and the output shaft 30h′ to the gear ratio of the second electric motor 22h′ and the output shaft 30h′ is n:1, then the ratio of the first commutation duration of the first electric motor 21h′ to the second commutation duration of the second electric motor 22h′ should theoretically be 1:n. Assuming that the ratio of the first duration threshold to the second duration threshold is also set to 1:n, then the locked-rotor shutdown protection of the first electric motor 21h′ and the locked-rotor shutdown protection of the second electric motor 22h′ are performed simultaneously, leading to the preceding peak current superposition and component damage problems. Therefore, in the present application, if the rotational speed ratio of the first electric motor 21h′ and the second electric motor 22h′ is n:1, in the controller 17h′, the ratio of the first duration threshold to the second duration threshold is configured to be not equal to 1:n so that the locked-rotor shutdown protection of the first electric motor 21h′ and the locked-rotor shutdown protection of the second electric motor 22h′ are not performed simultaneously, thereby preventing the peak currents from occurring at the same time and avoiding component damage and control interference.

For example, assuming that the rotational speed ratio of the first electric motor 21h′ and the second electric motor 22h′ is n:1, then the ratio of the first duration threshold to the second duration threshold may be set to 0.95*1:1.05*n. When the power tool is in a locked rotor condition, the controller 17h′ first detects that the first commutation duration of the first electric motor 21h′ exceeds the first duration threshold and controls the first electric motor 21h′ to shut down. After a period of time, the controller 17h′ detects that the second commutation duration of the second electric motor 22h′ exceeds the second duration threshold and controls the second electric motor 22h′ to shut down. In other words, the rotational speed ratio of the first electric motor 21h′ and the second electric motor 22h′ is n:1. If the ratio of the first duration threshold to the second duration threshold is less than 1:n, the controller 17h′ controls the first electric motor 21h′ and the second electric motor 22h′ to shut down in sequence for locked rotor protection. If the ratio of the first duration threshold to the second duration threshold is greater than 1:n, the controller 17h′ controls the second electric motor 22h′ and the first electric motor 21h′ to shut down in sequence for locked rotor protection.

In some other examples, the first electric motor parameter further includes a first overcurrent parameter, and the first protection threshold includes a first overcurrent threshold corresponding to the first overcurrent parameter. Correspondingly, the second electric motor parameter further includes a second overcurrent parameter, and the second protection threshold includes a second overcurrent threshold corresponding to the second overcurrent parameter. The first overcurrent threshold is not equal to the second overcurrent threshold. The controller 17h′ detects that the first overcurrent parameter of the first electric motor 21h′ exceeds the first overcurrent threshold and controls the first electric motor 21h′ to shut down; and then the controller 17h′ detects that the second overcurrent parameter of the second electric motor 22h′ exceeds the second overcurrent threshold and controls the second electric motor 22h′ to shut down.

In some examples, the overcurrent parameter is the current of the electric motor, including, but not limited to, the bus current, phase current, quadrature-axis current, or the like of the electric motor, the first overcurrent parameter is the first current of the first electric motor 21h′, the first overcurrent threshold is the first current threshold, the second overcurrent parameter is the second current of the second electric motor 22h′, and the second overcurrent threshold is the second current threshold. The ratio of the current amplitude of one electric motor to the current amplitude of the other electric motor is related to the output torque of the two electric motors. If the torque ratio of the first electric motor 21h′ and the second electric motor 22h′ that drive the same output shaft 30h′ is n:1, then the ratio of the current amplitude of one electric motor to the current amplitude of the other electric motor should theoretically be n:1. Assuming that the ratio of the first current threshold to the second current threshold is also set to n:1, the overcurrent shutdown protection of the first electric motor 21h′ and the overcurrent shutdown protection of the second electric motor 22h′ are performed simultaneously, leading to the preceding peak current superposition and component damage problems. Therefore, in the present application, if the torque ratio of the first electric motor 21h′ and the second electric motor 22h′ is n:1, in the controller 17h′, the ratio of the first current threshold to the second current threshold is configured to be not equal to n:1 so that the overcurrent shutdown protection of the first electric motor 21h′ and the overcurrent shutdown protection of the second electric motor 22h′ are not performed simultaneously, thereby preventing the peak currents from occurring at the same time and avoiding component damage and control interference.

For example, assuming that the torque ratio of the first electric motor 21h′ and the second electric motor 22h′ is n:1, then the ratio of the first current threshold to the second current threshold may be set to 0.95*1:1.05*n. When the power tool is in an overcurrent condition, the controller 17h′ first detects that the first current of the first electric motor 21h′ exceeds the first current threshold and controls the first electric motor 21h′ to shut down. After a period of time, the controller 17h′ detects that the second current of the second electric motor 22h′ exceeds the second current threshold and controls the second electric motor 22h′ to shut down. In other words, the torque ratio of the first electric motor 21h′ and the second electric motor 22h′ is n:1. If the ratio of the first current threshold to the second current threshold is less than n:1, the controller 17h′ controls the first electric motor 21h′ and the second electric motor 22h′ to shut down in sequence for overcurrent protection. If the ratio of the first current threshold to the second current threshold is greater than n:1, the controller 17h′ controls the second electric motor 22h′ and the first electric motor 21h′ to shut down in sequence for overcurrent protection.

In some other examples, the overcurrent parameter may include the calculation value of one or more of the output torque, current, and demagnetization time of the electric motor. For example, the overcurrent parameter may be the output torque of the electric motor, the current of the electric motor, the product of the current of the electric motor and the demagnetization time, or the like. Similar to the above, different forms of overcurrent parameters have corresponding overcurrent thresholds, and the forms of the overcurrent parameters that the controller 17h′ compares and determines successively are consistent.

To sum up, in the case where the first electric motor 21h′ and the second electric motor 22h′ drive the same output shaft, if the first electric motor parameter and the second electric motor parameter that are related to shutdown protection and of the same parameter type theoretically have a proportional relationship, then in the case where the ratio of the first electric motor parameter to the second electric motor parameter is n:1, the ratio of the first protection threshold to the second protection threshold set in the controller 17h′ of the power tool does not conform to the preceding n:1 relationship, where the first protection threshold and the second protection threshold correspond to the first electric motor parameter and the second electric motor parameter, and the ratio of the first protection threshold to the second protection threshold is not equal to n:1, thereby achieving shutdown protection since the peak currents do not occur at the same time.

In some examples, the first protection threshold and the second protection threshold adopted by the controller 17h′ may be adaptively adjusted according to the capacity, voltage, and other parameters of the power supply 31′. Different capacities or voltages of the power supply 31′ correspond to different first protection thresholds and/or different second protection thresholds adopted by the controller 17h′ in the power tool. In some examples, the first protection threshold and the second protection threshold adopted by the controller 17h′ may be negatively correlated to the capacity or voltage of the power supply 31′. For example, if the capacity or voltage of the power supply 31′ assembled on the power tool is higher, the first duration threshold and the second duration threshold adopted by the controller 17h′ are decreased accordingly, thereby more sensitively detecting the locked rotor condition in the case where the power supply 31′ has a stronger power supply capacity. In some other examples, the first protection threshold and the second protection threshold adopted by the controller 17h′ may be positively correlated to the capacity or voltage of the power supply 31′.

In some other examples, the first protection threshold and the second protection threshold adopted by the controller 17h′ may be dynamic thresholds, and the first protection threshold and/or the second protection threshold may be related to the current current and voltage of the electric motor assembly 20h′. The first protection threshold may dynamically change with the current and voltage of the first electric motor 21h′, and the second protection threshold may dynamically change with the current and voltage of the second electric motor 22h′. In some examples, the first duration threshold and the second duration threshold adopted by the controller 17h′ may be negatively correlated to the currents and voltages of the first electric motor 21h′ and the second electric motor 22h′, respectively. As the currents and voltages of the first electric motor 21h′ and the second electric motor 22h′ increase, the first duration threshold and the second duration threshold may dynamically and adaptively decrease.

Based on the above, the power tool is provided with the first controller 171h′ and the second controller 172h′ that are responsible for the shutdown protection of the first electric motor 21h′ and the shutdown protection of the second electric motor 22h′, respectively. The first controller 171h′ may detect the first electric motor parameter of the first electric motor 21h′ and when the first electric motor parameter exceeds the first protection threshold, control the first electric motor 21h′ to shut down. The second controller 172h′ may detect the second electric motor parameter of the second electric motor 22h′ and when the second electric motor parameter exceeds the second protection threshold, control the second electric motor 22h′ to shut down. The first protection threshold is not equal to the second protection threshold, and a certain time interval exists between the moment when the first controller 171h′ controls the first electric motor 21h′ to shut down and the moment when the second controller 172h′ controls the second electric motor 22h′ to shut down.

Correspondingly, a control method for a power tool is proposed and applied to the power tool described above. FIG. 58 shows the control method for a power tool. The control method may include the steps below.

In S810, the controller 17h′ of the power tool controls the first electric motor 21h′ to shut down when the first electric motor parameter of the first electric motor 21h′ of the power tool exceeds the first protection threshold.

In S820, the controller 17h′ controls the second electric motor 22h′ to shut down when the second electric motor parameter of the second electric motor 22h′ of the power tool exceeds the second protection threshold after the first electric motor parameter exceeds the first protection threshold; the first protection threshold is not equal to the second protection threshold, and the first electric motor 21h′ and the second electric motor 22h′ drive the same output shaft 30h′.

Based on the above, to address the preceding problem of peak current superposition during shutdown protection, the controller 17h′ may control the first electric motor 21h′ to shut down when the first electric motor parameter of the first electric motor 21h′ exceeds the first protection threshold and control the second electric motor 22h′ to shut down after the first electric motor parameter exceeds the first protection threshold for a second preset duration, thereby shutting down the first electric motor 21h′ and the second electric motor 22h′ in different periods in a simpler manner. However, in the preceding single-threshold-plus-delay method, once a logical fault occurs in the shutdown protection of the first electric motor 21h′, the logical fault interferes with the shutdown protection of the second electric motor 22h′, causing the problem that the two electric motors cannot be shut down. Optimization needs to be performed in conjunction with other protection logics. Usually, the preceding solution is adopted in which the first protection threshold and the second protection threshold are used for preventing the peak currents from occurring at the same time, thereby achieving protection.

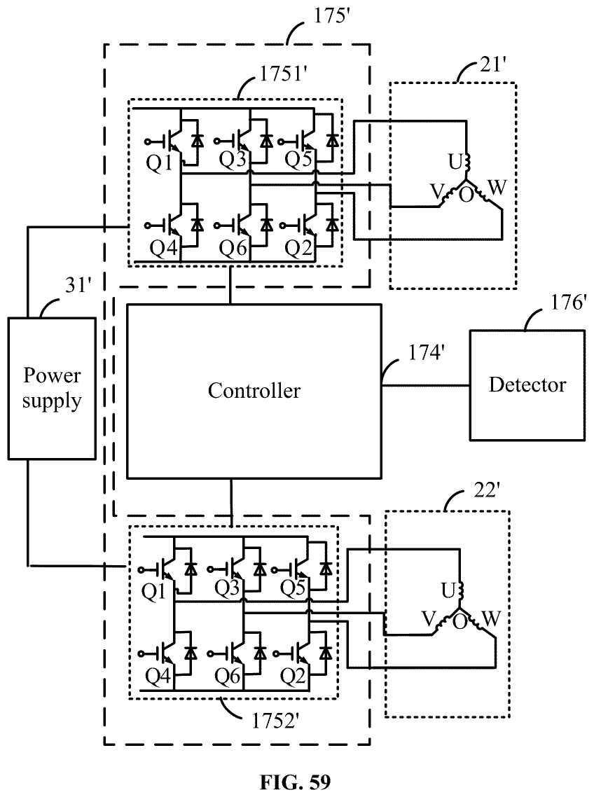

FIGS. 59 to 73 show a control circuit of a power tool. The control circuit includes a controller configured to control operation of an electric motor assembly. For example, the electric motor assembly includes, but is not limited to, one or more of the electric motor assembly 20, the electric motor assembly 20a, the electric motor assembly 20b, the electric motor assembly 20c, the electric motor assembly 20′, or the electric motor assembly 20h′. To facilitate the subsequent description, technical solutions are described using an example in which the power tool is the circular saw 100′ including the electric motor assembly 20′. To maintain consistency and avoid repeated labeling, when the composition of the electric motor assembly 20′ is described, internal structural features (such as a first electric motor and a second electric motor) use the same reference numerals (such as the first electric motor 21′ and the second electric motor 22′) as long as configurations of the internal structural features are essentially the same as structures previously described for features with the same reference numerals (such as 21′ and 22′). This example focuses on the control circuit, and no new or differentiated design is made for the specific structure inside the electric motor assembly 20′.

In some examples, the circular saw 100′ further includes a control circuit including a controller 174′ configured to control operation of the electric motor assembly 20′. The controller 174′ is disposed on a control circuit board 182′, where the control circuit board 182′ includes a PCB and an FPC board. The controller 174′ adopts a dedicated control chip, such as a single-chip microcomputer or an MCU. The controller 174′ includes a processor and a memory, the processor is configured to be programmably controlled to implement respective functions, and the memory may store programs to be executed and related data. It is to be noted that the control chip may be integrated into the controller 174′ or may be disposed independently of the controller 174′. A structural relationship between a driver chip and the controller 174′ is not limited in this example.

As shown in FIG. 59, the control circuit further includes a driver circuit 175′ disposed between a power supply 31′ and the electric motor assembly 20′ and configured to drive the electric motor assembly 20′. The driver circuit 175′ is a three-phase bridge driver circuit including multiple switching elements, for example, controllable semiconductor power devices (such as FETs, BJTs, or IGBTs). It is to be understood that the above switching elements may be any other types of solid-state switches, such as IGBTs or BJTs. In this example, the driver circuit 175′ includes a first driver circuit 1751′ connected between the first electric motor 21′ and the power supply 31′ and a second driver circuit 1752′ connected between the second electric motor 22′ and the power supply 31′.

The electric circular saw 100′ of the present application is used as an example. The first electric motor 21′ and the second electric motor 22′ work in coordination so that an output shaft 30′ drives a cutting part 61′ to perform a cutting operation. It is different from a power tool driven by multiple electric motors in the related art, such as an outdoor traveling device or a wheeled device, which uses multiple electric motors, such as two electric motors, to drive different output shafts or output portions, respectively. For example, in the related art, the first electric motor 21′ and the second electric motor 22′ are used for driving two or more drive gears or drive shafts, respectively. However, in this example, the electric motor assembly 20′ including multiple electric motors is used for driving the same output shaft, that is to say, torque of drive shafts of the multiple electric motors is output through one output shaft. The torque transmission paths of the multiple electric motors have the same endpoint so that the high-efficiency working interval of the entire power tool can be improved, thereby enabling the power tool with only one output shaft to be efficiently driven using the multiple electric motors. Compared with multiple electric motors driving different output portions or output shafts, in the present application, the multiple electric motors are used for driving one output shaft, and more difficulties need to be overcome for the transmission coordination, power distribution, and drive structure of the electric motor assembly 20′ and the power transmission mechanism 40′.

When the power tool of the present application is a traveling device or an agricultural machinery vehicle that does not travel on roads, the electric motor assembly 20′ provides power for one output shaft. For example, when the electric motor assembly 20′ serves as a walking drive, the electric motor assembly 20 drives one walking axle or walking wheel. When the electric motor assembly 20′ serves as a drive for a functional component (such as a mowing blade), the electric motor assembly 20′ drives the mowing blade on one output shaft. This needs to be distinguished from the multiple electric motors driving multiple output shafts or drive axles in the related art.

The circular saw 100′ includes switchable working modes. For the electric motor assembly 20′ with the first electric motor 21′ and the second electric motor 22′, the first electric motor 21′ and the second electric motor 22′ in the electric motor assembly 20′ are configured with different operating parameters or switching parameters in different working modes.

In some examples, the circular saw 100′ includes an adaptive mode and a first working mode. In the adaptive mode, the controller 174′ switches a running state of the electric motor assembly 20′ according to an identification result of a detector 176′, where the running state of the electric motor assembly 20′ includes at least that the first electric motor 21′ or the second electric motor 22′ is driven or that the first electric motor 21′ and the second electric motor 22′ are jointly driven. In the first working mode, the controller 174′ makes the first electric motor 21′ and the second electric motor 22′ jointly driven in response to an input instruction.

In this example, in the adaptive mode, the controller 174′ determines a working condition of the circular saw 100′ and/or a load condition of the output shaft 30′ according to an identification manner of the detector 176′ (such as sensor identification, signal identification, or data estimation identification) and switches to single-motor operation or dual-motor operation and dynamically adjusts the number of driven electric motors in the electric motor assembly 20′ and their respective drive parameters (such as target rotational speeds, target torque, or current limits) according to the working condition of the circular saw 100′ and/or the load condition of the output shaft 30′ so that the output of the electric motor assembly 20′ satisfies the actual working requirement of the circular saw 100′ (for example, maintaining a set rotational speed of the output shaft 30′ or minimizing total input power while satisfying the load requirement), and the electric motor assembly 20′ adapts to the working condition of the power tool. A single-motor or dual-motor working mode is intelligently selected according to the load condition, thereby optimizing the operation efficiency of the electric motors, potentially extending the single-charge usage time of a battery, ensuring the single-battery life of the power tool, and enabling intelligent switching, energy-saving, and high efficiency.

In the first working mode, the first electric motor 21′ and the second electric motor 22′ are jointly driven, that is to say, the controller 174′ always maintains a jointly driven state of the first electric motor 21′ and the second electric motor 22′ in response to a received activation signal of the first working mode, where the jointly driven state is terminated only when the controller 174′ receives an instruction to exit the first working mode or an instruction to switch to another working mode.

Compared with the adaptive mode characterized by dynamic switching between a single electric motor and two electric motors according to the working condition, the first working mode provides a preset peak output capability. When the user activates the first working mode, the controller 174′ ignores a real-time working condition detection signal and forcibly and simultaneously activates the first electric motor 21′ and the second electric motor 22′ so that the power tool provides strong working torque. The mode is applicable to a working condition requiring the continuous output of maximum torque. For example, during cutting of a high-hardness material, the collaborative driving of two electric motors ensures that the output shaft 30′ provides torque higher than maximum output in the adaptive mode.

The power tool of the present application is provided with both the adaptive mode and the first working mode that are switchable between each other and may switch between different working modes according to different working conditions and different requirements. In the adaptive mode, the motor scheduling based on load sensing enables optimized energy efficiency and an extended battery life. In the first working mode, the full-time driving of two electric motors provides predictable maximum mechanical output. The dual-mode architecture enables the power tool equipped with a multi-motor system (such as the electric motor assembly 20′ including the first electric motor 21′ and the second power tool 22′) to dynamically adapt to an energy efficiency priority scenario and a power priority scenario.

In some examples, the working modes further include a second working mode. In the second working mode, the controller 174′ drives the first electric motor 21′ and brakes the second electric motor 22′ in response to an input instruction. That is to say, after a signal for the circular saw 100′ to enter the second working mode is input into the controller 174′, the first electric motor 21′ in the electric motor assembly 20′ is driven to operate and the second electric motor 22′ is braked to output no torque, and the electric motor assembly 20′ is in a single-motor driven state in which only the first electric motor 21′ works. Only when a signal for entering another working mode or a signal for exiting the second working mode is input into the controller 174′, can the electric motor assembly 20′ terminate the single-motor driven state in which the first electric motor 21′ is driven and the second electric motor 22′ is braked in the second working mode. To better extend usage scenarios, when the user requires a special working condition where low output torque is continuously used or another working condition that requires only a single drive, the circular saw 100′ enters the second working mode and provides suitable output torque and lower energy consumption, further increasing the working conditions under which the power tool can be used.

In some examples, the circular saw 100′ is operable in the adaptive mode and a selected mode. In the selected mode, the controller 174′ responds to a received particular input instruction and determines and executes a corresponding predetermined motor drive configuration according to the instruction, where each input instruction is mapped to a particular activation combination of one or more electric motors in the electric motor assembly 20′. For example, a first input instruction corresponds to a configuration in which only the first electric motor 21′ is driven, and a second input instruction corresponds to a configuration in which the first electric motor 21′ and the second electric motor 22′ are driven simultaneously. The controller 174′ maintains the selected drive configuration continuously until the controller 174′ receives a new input instruction to execute a different drive configuration, an instruction to exit the selected mode, or an instruction to switch to another working mode (such as the adaptive mode). The selected mode optionally includes the first working mode (corresponding to a dual-motor drive configuration) and/or the second working mode described above. Additionally, in examples (described in detail later) where the electric motor assembly 20′ may include more electric motors (for example, a third electric motor 23′), the selected mode further provides additional predetermined drive configurations, including, but not limited to, driving only the first electric motor 21′, driving the first electric motor 21′ and the second electric motor 22′, or driving a combination of all the first electric motor 21′, the second electric motor 22′, and the third electric motor 23′.

In some examples, in the adaptive mode, the controller 174′ may also dynamically adjust the running state of the electric motor assembly 20′ according to the identification result of the detector 176′. For example, the controller 174′ may selectively start one of the first electric motor 21′ and the second electric motor 22′ or simultaneously start the first electric motor 21′ and the second electric motor 22′ according to the identification result of the detector 176′. For example, in the adaptive mode, the first electric motor 21′ and/or the second electric motor 22′ have constant drive parameters, and the controller 174′ may selectively start one of the first electric motor 21′ and the second electric motor 22′ or simultaneously start the first electric motor 21′ and the second electric motor 22′ according to the identification result of the detector 176′, where the controller 174′ switches only the started states of the first electric motor 21′ and the second electric motor 22′, but the first electric motor 21′ and the second electric motor 22′ operate with preset drive parameters after being started. For example, after the first electric motor 21′ is started, the first electric motor 21′ performs torque output with output torque at a highest efficiency point of motor efficiency, and after the second electric motor 22′ is started, the second electric motor 22′ performs torque output with output torque at a highest efficiency point of motor efficiency. It is to be interpreted that the “motor efficiency” refers to the ratio of output power (mechanical) to input power (electrical) and is generally expressed as a percentage.

For example, in the adaptive mode, the drive parameters of the first electric motor 21′ and the second electric motor 22′ may be dynamically adjusted, for example, the output torque of the first electric motor 21′ and the output torque of the second electric motor 22′ may be dynamically adjusted. Optionally, the output torque of the first electric motor 21′ and the output torque of the second electric motor 22′ are dynamically adjusted so that the motor efficiency of the first electric motor 21′ is greater than or equal to 70%, and the motor efficiency of the second electric motor 22′ is greater than or equal to 70%. In some examples, an output rotational speed of the first electric motor 21′ and an output rotational speed of the second electric motor 22′ are dynamically adjusted so that output torque of the power tool is required torque for implementing a function, and the output rotational speed of the first electric motor 21′ and/or the output rotational speed of the second electric motor 22′ are adjusted regularly or in real time according to the magnitude of the required torque. It is to be understood that currents, voltages, or other motor control-related parameters of the electric motors may be dynamically adjusted to make the output of the electric motor assembly satisfy a requirement for implementing a function.

In the first working mode, the controller always keeps the first electric motor 21′ and the second electric motor 22′ jointly driven. In this example, when the first electric motor 21′ and the second electric motor 22′ are jointly driven, running states of the first electric motor 21′ and the second electric motor 22′ are dynamically adjusted, and the first electric motor 21′ and the second electric motor 22′ always keep outputting torque to the output shaft. In this mode, the controller 174′ executes any one of the following control strategies: (a) a dynamic adjustment strategy: according to real-time required torque of the power tool, rotational speed instruction values of the first electric motor 21′ and the second electric motor 22′ are adjusted periodically or in real time so that the total output torque of the output shaft 30′ matches the required torque; (b) a parameter switching strategy: according to predefined load grading thresholds of the output shaft, automatic switching is performed between multiple groups of preset drive parameters, where each group of parameters corresponds to a particular motor speed-torque working point; (c) a maximum torque strategy: the two electric motors are driven according to preset constant maximum torque parameters so that the first electric motor 21′ and the second electric motor 22′ continuously output their respective rated maximum torque, and the electric motor assembly 20′ generates peak output torque. When the maximum torque strategy is used, the output torque of the first electric motor 21′ and the output torque of the second electric motor 22′ each fluctuate within a range of +5% of the rated torque value. The controller 174′ optionally implements the joint driving in the first working mode using an FOC algorithm which is also applicable to the adaptive mode. In particular examples, square wave control may be used as an alternative driving scheme in the adaptive mode.

In the second working mode, the controller 174′ drives the first electric motor 21′ to work and brakes the second electric motor 22′. When the second electric motor 22′ is in a braked state, the second driver circuit 1752′ connected to the second electric motor 22′ is in a non-conductive state, and power of the power supply 31′ is not supplied to the second electric motor 22′. When the power tool is in the second working mode, the electric motor assembly 20′ consumes less power. In some examples, the controller 174′ dynamically adjusts the output rotational speed of the first electric motor 21′ so that the output torque of the power tool is required torque for implementing a function, and the output rotational speed of the first electric motor 21′ is adjusted regularly or in real time according to the magnitude of the required torque. In some examples, the controller 174′ drives the first electric motor 21′ according to multiple groups of preset drive parameters. For example, in the first working mode, according to different grades of load states of the output shaft, the switching is performed between the multiple groups of preset drive parameters according to multiple grades so that the first electric motor 21′ has running states adapted to different output. In some examples, the controller 174′ drives the first electric motor 21′ according to one group of preset drive parameters, where types of preset parameters include one or more of a rotational speed of the electric motor, output torque of the electric motor, an output current of the electric motor, or other operating parameters of the electric motor. According to different product requirements, specific values of the preset parameters are not limited. Optionally, the preset parameters are values corresponding to output efficiency of greater than or equal to 70% of the first electric motor 21′. Optionally, the preset parameters are specific values set according to product requirements such as low power consumption and low noise and satisfying the requirements.

In the adaptive mode, when the controller 174′ chooses to drive a single electric motor, the other electric motor is in a standby state. For example, when the first electric motor 21′ is driven, the second electric motor 22′ is in the standby state. When the second electric motor 22′ is in the standby state, the power supply 31′ supplies power to the second electric motor 22′ through the second driver circuit 1752′, but a second drive shaft 221′ outputs no torque. That is to say, when the second electric motor 22′ is in the standby state, the second electric motor 22′ is not offline, the second driver circuit 1752′ for the second electric motor 22′ still receives control signals from the controller 174′, and the second electric motor 22′ is in a “zero”-torque control state. Alternatively, the second driver circuit 1752′ for the second electric motor 22′ continuously receives control signals from the controller 174′ and performs zero-torque closed-loop control, which is embodied as applying a static bias current to maintain a rotor position or outputting a PWM waveform with a duty cycle of 0%. In some examples, the power supply of the second electric motor is directly cut off in a switch on-off manner so that the second electric motor is on standby.

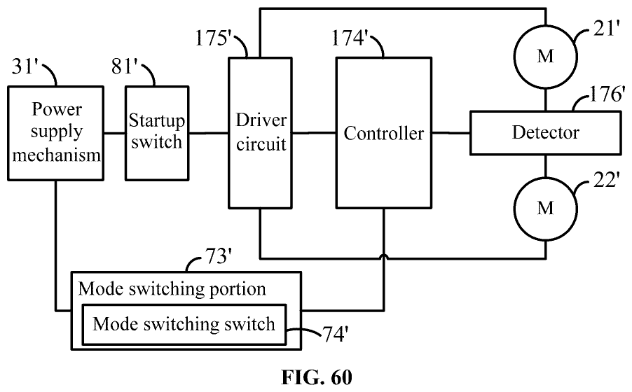

For a manner of switching the power tool between different working modes, as shown in FIG. 60, in some examples, the power tool switches between the working modes in a manual mode. For example, the power tool includes a mode switching portion 73′ configured to receive a switching instruction input by the user and send a signal for executing the adaptive mode, the first working mode, or the second working mode. The mode switching portion 73′ includes a switching element, the switching element is defined as a mode switching switch 74′, and the mode switching portion 73′ is configured to receive the switching instruction input by the user. The mode switching switch 74′ includes at least one of a mechanical switch or an electronic switch. The mechanical switch includes a push switch (such as a button switch, a key switch, a membrane switch, or a rocker switch), a toggle switch (such as a gear switch, a lever switch, or a pull-rod switch), a rotary switch (such as a knob switch or a dial switch), and a microswitch. The electronic switch includes a sensor and a chip. According to different types of sensors, the electronic switch includes a touch switch (capacitive or resistive), a sensing switch (such as infrared sensing, microwave sensing, ultrasonic sensing, piezoelectric sensing, electromagnetic sensing, or capacitive sensing), a voice operated switch, and a wireless switch (connected to an external smart device).

The user inputs a desired working mode, such as the first working mode, the second working mode, or the adaptive working mode, through the mode switching portion 73′. The mode switching portion 73′ outputs an input instruction corresponding to the switching instruction to the controller 174′. The controller 174′ configures the corresponding working mode of the power tool. When the switching instruction received by the mode switching portion 73′ is the first working mode or the second working mode, the controller 174′, in response to a signal output from the mode switching portion 73′, determines that the electric motor assembly 20′ operates in a state corresponding to the first working mode or the second working mode.

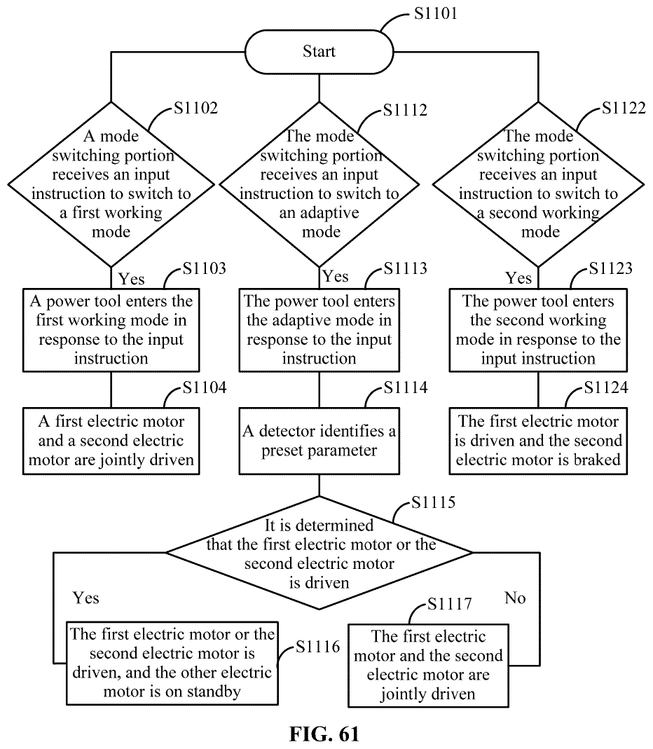

FIG. 61 shows a control method for the power tool, where the power tool switches between the working modes in the manual mode. The method specifically includes the steps below.

In S1101, the flow starts.

In S1102, the mode switching portion 73′ receives an input instruction to switch to the first working mode. If so, S1103 is performed. If not, the flow returns to S1101.

In S1103, the power tool enters the first working mode in response to the input instruction.

In S1104, the first electric motor and the second electric motor are jointly driven.

When the switching instruction received by the mode switching portion 73′ is switching to the first working mode, the controller 174′, in response to a signal output from the mode switching portion 73′, makes the first electric motor and the second electric motor jointly driven and keeps the first electric motor and the second electric motor in the jointly driven state.

In S1112, the mode switching portion 73′ receives an input instruction to switch to the adaptive mode. If so, S1113 is performed. If not, the flow returns to S1101.

In S1113, the power tool enters the adaptive mode in response to the input instruction.

In S1114, the detector identifies a preset parameter.

In S1115, it is determined that the first electric motor or the second electric motor is driven. If so, S1116 is performed. If not, S1117 is performed.

In S1116, the first electric motor or the second electric motor is driven, and the other electric motor is on standby.

In S1117, the first electric motor and the second electric motor are jointly driven.

When the switching instruction received by the mode switching portion 73′ is switching to the adaptive mode, in the adaptive mode, the controller 174′ may determine a load of the power tool according to the identification result of the detector 176′ and dynamically adjusts the running states of the first electric motor 21′ and the second electric motor 22′. When the controller 174′ determines according to data of the detector that the output of the electric motor assembly satisfies the current load requirement of the power tool if the first electric motor or the second electric motor is driven alone, the first electric motor or the second electric motor operates and the other electric motor is on standby. When the controller determines according to the data of the detector that the output of the electric motor assembly cannot satisfy the load requirement of the power tool if the first electric motor or the second electric motor is driven alone, the first electric motor and the second electric motor are driven simultaneously.

In S1122, the mode switching portion 73′ receives an input instruction to switch to the second working mode. If so, S1123 is performed. If not, the flow returns to S1101.

In S1123, the power tool enters the second working mode in response to the input instruction.

In S1124, the first electric motor is driven and the second electric motor is braked.

When the switching instruction received by the mode switching portion 73′ is switching to the second working mode, the controller 174′, in response to a signal output from the mode switching portion 73′, drives the first electric motor, brakes the second electric motor, and always keeps the second electric motor in the braked state.

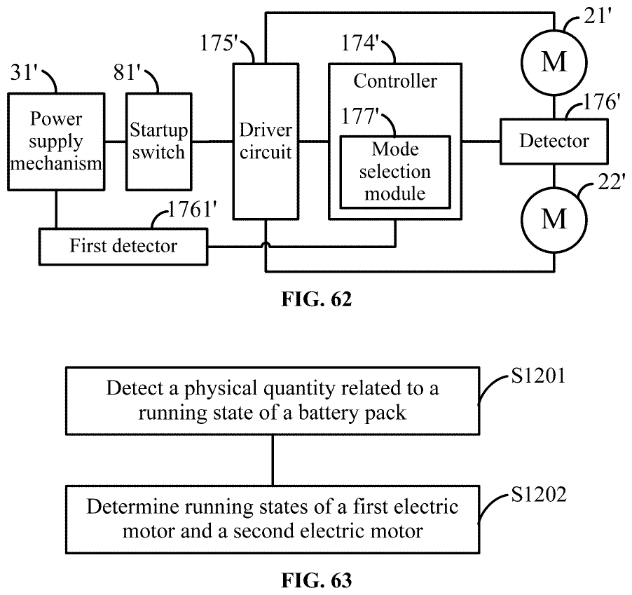

In some examples, the power tool switches between the working modes through electronic identification. As shown in FIGS. 62 and 67, the controller 174′ includes a mode selection module 177′ configured to automatically switch a configured working mode of the power tool according to a parameter identification result.

In some examples, the controller 174′ determines the running states of the first electric motor 21′ and the second electric motor 22′ according to a physical quantity related to a running state of the battery pack 31′. The control circuit includes a first detector 1761′ configured to detect the physical quantity related to the running state of the battery pack 31′. Optionally, the physical quantity related to the running state of the battery pack 31′ includes, but is not limited to, a voltage, a current, a temperature, a state of power (SOP), a state of charge (SOC), internal resistance, and a model of the battery pack 31′. For example, the physical quantity related to the running state of the battery pack 31′ includes a combination of one or more of the physical quantities disclosed above with time.

As shown in FIG. 63, a control method for the power tool specifically includes the steps below.

In S1201, the physical quantity related to the running state of the battery pack is detected.

The first detector 1761′ is configured to detect the physical quantity related to the running state of the battery pack 31′. The physical quantity related to the running state of the battery pack 31′ includes, but is not limited to, the voltage, the current, the temperature, the SOP, the SOC, the internal resistance, and the model of the battery pack 31′. The physical quantity related to the running state of the battery pack 31′ includes a combination of one or more of the physical quantities disclosed above with time.

In S1202, the running states of the first electric motor and the second electric motor are determined.

According to the physical quantity related to the operation of the battery pack, an output capability of the battery pack is determined, and the running states of the first electric motor and the second electric motor are determined.

For example, the mode selection module 177′ determines a working mode of the power tool according to the physical quantity related to the running state of the battery pack 31′. For example, the controller 174′ performs a configuration of the working mode of the power tool through a comparison between a detected value of the first detector 1761′ and a preset threshold. The comparison includes a direct comparison between the detected value and a detected value threshold, a comparison between a detected value variation and a variation threshold, a comparison between a result value after a unary/binary/n-ary calculation on the detected value and a result value threshold, and a comparison between a result value variation and a corresponding threshold.

For example, the controller 174′ determines the output capability of the battery pack 31′ according to a relationship between the detected value of the first detector 1761′ and the preset threshold and determines the configured working mode of the power tool according to the output capability of the battery pack 31′. Optionally, the detected value of the first detector 1761′ is an output current value of the battery pack 31′, and the controller 174′ may determine the configured working mode of the power tool based on a comparison between the current value and a current value threshold. Optionally, the detected value of the first detector 1761′ is the output current value of the battery pack 31′, and the controller 174′ may determine the configured working mode of the power tool based on a comparison between a variation of current values detected twice or multiple times and a current variation threshold. Optionally, the detected value of the first detector 1761′ is the output current value of the battery pack 31′, and the controller 174′ may determine the configured working mode of the power tool based on a comparison between an average of current values detected twice or multiple times and a current average threshold.

In this example, the output capability of the battery pack 31′ includes a low output capability, a medium output capability, and a high output capability. For example, when the SOC of the battery pack 31′ is less than or equal to a first power threshold, for example, 20%, the battery pack 31′ is defined as having the low output capability. When the SOC of the battery pack 31′ is greater than or equal to a second power threshold, for example, 75%, the battery pack 31′ is defined as having the high output capability. When the SOC of the battery pack 31′ is greater than the first power threshold and less than the second power threshold, the battery pack 31′ has the medium output capability. For example, when discharge power of the battery pack 31′ is less than or equal to a first power threshold, the battery pack 31′ is defined as having the low output capability. When the discharge power of the battery pack 31′ is greater than or equal to a second power threshold, the battery pack 31′ is defined as having the high output capability. When the discharge power of the battery pack 31′ is greater than the first power threshold and less than the second power threshold, the battery pack 31′ has the medium output capability, where the first power threshold is less than the second power threshold. It is to be understood that the output capability of the battery pack 31′ may also be defined through the remaining energy, discharge current, and voltage of the battery pack 31′, a cycle life of the battery, and the internal resistance and temperature of the battery pack 31′.

In this example, when the battery pack 31′ is determined to have the high output capability according to the physical quantity related to the running state of the battery pack 31′, the mode selection module 177′ of the controller 174′ determines that the power tool switches to and operates in the first working mode. When the battery pack 31′ is determined to have the medium output capability according to the physical quantity related to the running state of the battery pack 31′, the mode selection module 177′ of the controller 174′ determines that the power tool switches to and operates in the adaptive mode. When the battery pack 31′ is determined to have the low output capability according to the physical quantity related to the running state of the battery pack 31′, the mode selection module 177′ of the controller 174′ determines that the power tool switches to and operates in the second working mode. When the controller 174′ determines that the power tool switches to and operates in the first working mode or the second working mode, a switching signal is used as the input instruction, and the controller 174′, in response to the switching signal, calls drive parameters corresponding to the first working mode or the second working mode and determines that the electric motors operate in states corresponding to the first working mode or the second working mode.

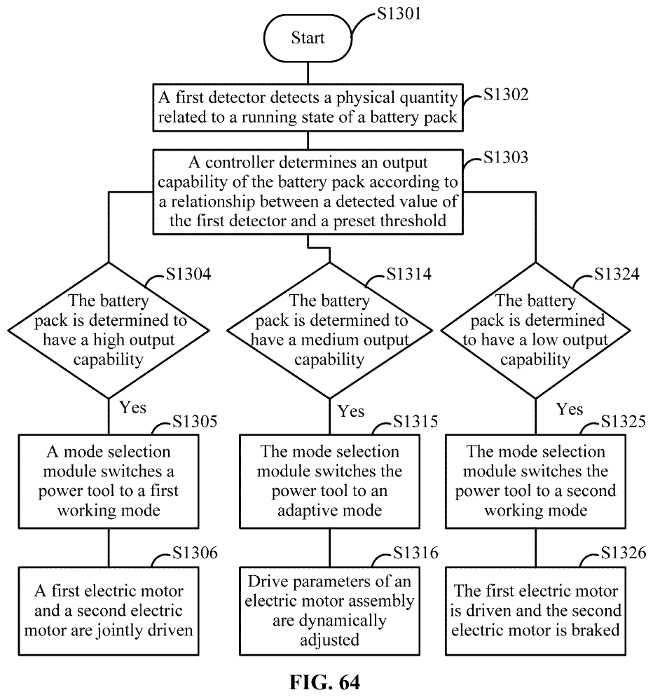

FIG. 64 shows a control method for the power tool, where the power tool switches between the working modes through electronic identification, the controller 174′ includes the mode selection module 177′, and the mode selection module 177′ determines the configured working mode of the power tool according to the physical quantity related to the running state of the battery pack 31′. Specific steps are described below.

In S1301, the flow starts.

In S1302, the first detector 1761′ detects the physical quantity related to the running state of the battery pack 31′.

The first detector 1761′ is configured to detect the physical quantity related to the running state of the battery pack 31′. The physical quantity related to the running state of the battery pack 31′ includes, but is not limited to, the voltage, the current, the temperature, the SOP, the SOC, the internal resistance, and the model of the battery pack 31′. The physical quantity related to the running state of the battery pack 31′ includes a combination of one or more of the physical quantities disclosed above with time.

In S1303, the controller 174′ determines the output capability of the battery pack 31′ according to the relationship between the detected value of the first detector 1761′ and the preset threshold.

When the SOC of the battery pack 31′ is less than or equal to the first power threshold, for example, 20%, the battery pack 31′ is defined as having the low output capability. When the SOC of the battery pack 31′ is greater than or equal to the second power threshold, for example, 75%, the battery pack 31′ is defined as having the high output capability. When the SOC of the battery pack 31′ is greater than the first power threshold and less than the second power threshold, the battery pack 31′ has the medium output capability. For example, when the discharge power of the battery pack 31′ is less than or equal to the first power threshold, the battery pack 31′ is defined as having the low output capability. When the discharge power of the battery pack 31′ is greater than or equal to the second power threshold, the battery pack 31′ is defined as having the high output capability. When the discharge power of the battery pack 31′ is greater than the first power threshold and less than the second power threshold, the battery pack 31′ has the medium output capability, where the first power threshold is less than the second power threshold. It is to be understood that the output capability of the battery pack 31′ may also be defined through the remaining energy, discharge current, and voltage of the battery pack 31′, the cycle life of the battery, and the internal resistance and temperature of the battery pack 31′.

In S1304, the battery pack 31′ is determined to have the high output capability. If so, S1305 is performed. If not, the flow returns to S1303.

In S1305, the mode selection module 177′ determines that the power tool switches to the first working mode.

In S1306, the first electric motor and the second electric motor are jointly driven.

The first electric motor and the second electric motor are jointly driven and kept jointly driven.

In S1314, the battery pack 31′ is determined to have the medium output capability. If so, S1315 is performed. If not, the flow returns to S1303.

In S1315, the mode selection module 177′ determines that the power tool switches to the adaptive mode.

In S1316, the drive parameters of the electric motor assembly are dynamically adjusted.

In S1324, the battery pack 31′ is determined to have the low output capability. If so, S1325 is performed. If not, the flow returns to S1303.

In S1325, the mode selection module 177′ determines that the power tool switches to the second working mode.

In S1326, the first electric motor is driven and the second electric motor is braked.

The first electric motor is driven, the second electric motor is braked, and the state in which only the first electric motor operates is maintained.

In some examples, the controller 174′ determines, according to the physical quantity related to the running state of the battery pack 31′, whether to respond to a configuration signal of the working mode of the power tool. For example, the configuration signal includes a working mode configuration signal generated according to the switching instruction input by the user through the mode switching portion 73′ and a working mode configuration signal determined by the controller 174′ after identification of a preset physical quantity. For example, the working mode configuration signal of the power tool is from the mode switching portion 73′, and the mode switching portion 73′ receives the switching instruction input by the user and sends the signal for executing the adaptive mode, the first working mode, or the second working mode. For example, the working mode configuration signal of the power tool is signal output of the mode selection module 177′ of the controller 174′, and the mode selection module 177′ sends a signal for configuring the power tool in the adaptive mode, the first working mode, or the second working mode according to the parameter identification result, for example, a physical quantity related to the running state of the electric motor assembly 20′, where the details are provided below. In this example, the controller 174′ determines, according to the physical quantity related to the running state of the battery pack 31′, whether to respond to the signal from the mode switching portion 73′ or the mode selection module 177′. That is to say, when the power tool receives the switching or configuration signal of the working mode, the controller 174′ determines, according to the physical quantity related to the running state of the battery pack 31′, whether the working mode can be switched according to the above signal, regardless of manual switching by the user or switching the power tool through automatic identification.

In some examples, when the battery pack 31′ is determined to have the low output capability according to the physical quantity related to the running state of the battery pack 31′, the mode selection module 177′ of the controller 174′ responds only to a configuration signal of the second working mode. That is to say, when the battery pack 31′ has the low output capability, the controller 174′ does not respond even if the controller 174′ receives a signal for switching to the adaptive working mode or the first working mode. When the battery pack 31′ is determined to have the medium output capability according to the physical quantity related to the running state of the battery pack 31′, the mode selection module 177′ of the controller 174′ does not respond to a signal of the first working mode. That is to say, when the battery pack 31′ is determined to have the medium output capability according to the physical quantity related to the running state of the battery pack 31′, the configuration of the first working mode is not responded to, and the electric motor assembly does not continuously maintain a state in which the first electric motor 21′ and the second electric motor 22′ are jointly driven. When the battery pack 31′ is determined to have the medium output capability according to the physical quantity related to the running state of the battery pack 31′, if it is determined in the adaptive mode according to the identification result of the detector that the first electric motor and the second electric motor need to be jointly driven, the controller responds to the above drive signal, and in the adaptive mode, a time for which the electric motor assembly is in the running state in which the first electric motor and the second electric motor are jointly driven is less than or equal to a preset time threshold. For example, the preset time threshold is different according to a different nominal capacity of the battery pack, a different nominal voltage of the battery pack, and different models of the first electric motor and the second electric motor. Comparatively speaking, the greater the nominal capacity of the battery pack, the larger the preset time threshold; the higher the nominal voltage of the battery pack, the larger the preset time threshold; the stronger the output capabilities of the first electric motor and the second electric motor, the larger the preset time threshold. When the battery pack 31′ is determined to have the high output capability according to the physical quantity related to the running state of the battery pack 31′, configuration signals of all the working modes can be responded to.

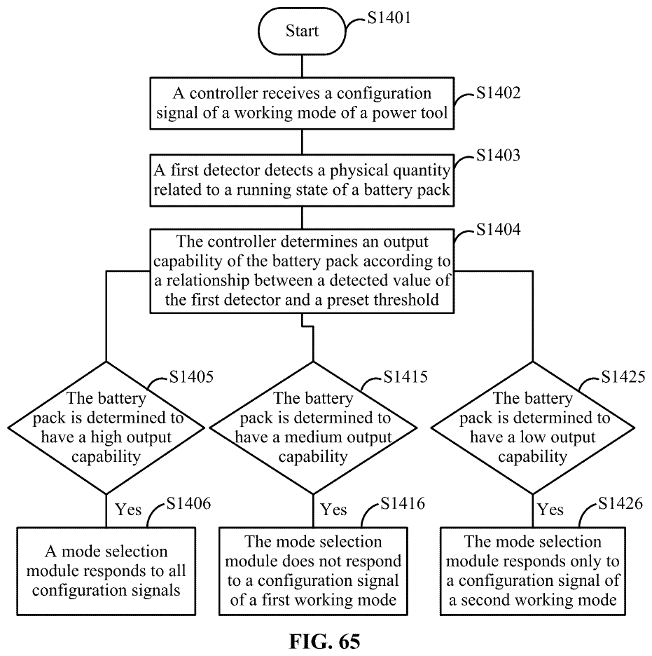

FIG. 65 shows a control method for the power tool, where the controller 174′ determines, according to the physical quantity related to the running state of the battery pack 31′, whether to respond to the configuration signal of the working mode of the power tool. Specific steps are described below.

In S1401, the flow starts.

In S1402, the controller 174′ receives the mode configuration signal of the power tool.

The configuration signal includes the working mode configuration signal generated according to the switching instruction input by the user through the mode switching portion 73′ and the working mode configuration signal determined by the controller 174′ after identification of the preset physical quantity. For example, the working mode configuration signal of the power tool is from the mode switching portion 73′, and the mode switching portion 73′ receives the switching instruction input by the user and sends the signal for executing the adaptive mode, the first working mode, or the second working mode. For example, the working mode configuration signal of the power tool is the signal output of the mode selection module 177′ of the controller 174′, and the mode selection module 177′ sends the signal for configuring the power tool in the adaptive mode, the first working mode, or the second working mode according to the physical quantity related to the running state of the electric motor assembly 20′ and/or the physical quantity related to the running state of the battery pack 31′.

In S1403, the first detector 1761′ detects the physical quantity related to the running state of the battery pack 31′.

In S1404, the controller determines the output capability of the battery pack according to the relationship between the detected value of the first detector 1761′ and the preset threshold.

In S1405, the battery pack is determined to have the high output capability. If so, S1406 is performed. If not, the flow returns to S1404.

In S1406, the mode selection module 177′ responds to all configuration signals.

In S1415, the battery pack is determined to have the medium output capability. If so, S1416 is performed. If not, the flow returns to S1404.

In S1416, the mode selection module 177′ does not respond to the configuration signal of the first working mode.

In S1425, the battery pack is determined to have the low output capability. If so, S1426 is performed. If not, the flow returns to S1404.

In S1426, the mode selection module 177′ responds only to the configuration signal of the second working mode.

In the related art, battery packs 31′ of different types or with different power states have different output capabilities. When the working mode of the power tool is mismatched with the output capability of the battery pack 31′, the output capability of the battery pack 31′ is likely to be insufficient to support the simultaneous working of multiple electric motors, or the high output capability of the battery pack 31′ is limited in a single-motor drive mode, resulting in low matching efficiency between the output capability of the battery pack 31′ and the working mode of the electric motor assembly 20′. In this example, the controller 174′ directly determines the working mode according to the physical quantity related to the running state of the battery pack 31′ or limits a switching operation of the working mode according to the physical quantity, thereby eliminating the problem of mismatching between the output capability and the working mode, improving a matching degree between the output capability and the working mode, and avoiding potential damages and risks caused to the battery pack 31′ and components of the power tool by the forced operation of multiple electric motors in the case of an insufficient output capability.

In some examples, in the adaptive mode, the first detector 1761′ is configured to detect the physical quantity related to the running state of the battery pack 31′, and the controller 174′ dynamically adjusts the running states of the first electric motor 21′ and the second electric motor 22′ according to the physical quantity related to the running state of the battery pack 31′ and detected by the first detector 1761′. Optionally, the physical quantity related to the running state of the battery pack 31′ includes, but is not limited to, the voltage, the current, the temperature, the SOP, the SOC, the internal resistance, and the model of the battery pack 31′. For example, the physical quantity related to the running state of the battery pack 31′ further includes a combination of one or more of the physical quantities disclosed above with time. The controller 174′ determines the output capability of the battery pack 31′ by comparing the detected value of the first detector 1761′ with the preset threshold. The controller 174′ switches the running state of the electric motor assembly 20′ according to the output capability of the battery pack 31′, for example, the first electric motor 21′ or the second electric motor 22′ is driven, or the first electric motor 21′ and the second electric motor 22′ are driven simultaneously. For example, the comparison between the detected value of the first detector 1761′ and the preset threshold includes the direct comparison between the detected value and the detected value threshold, the comparison between the detected value variation and the variation threshold, the comparison between the result value after the unary/binary/n-ary calculation on the detected value and the result value threshold, and the comparison between the result value variation and the corresponding threshold. For example, when the battery pack 31′ has the low output capability, only one of the first electric motor 21′ or the second electric motor 22′ may be driven.

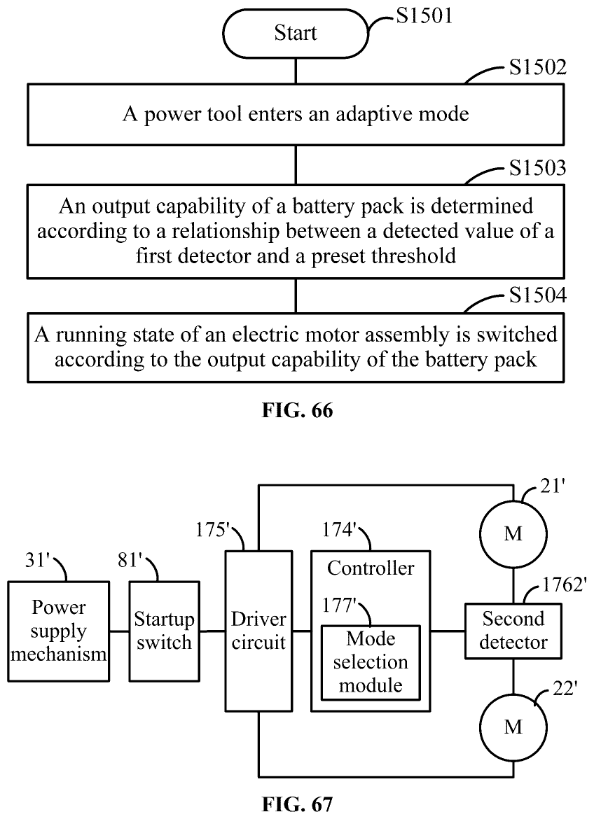

As shown in FIG. 66, a control method for the power tool in the adaptive mode includes the specific steps below.

In S1501, the flow starts.

In S1502, the power tool enters the adaptive mode.

In S1503, the output capability of the battery pack 31′ is determined according to the relationship between the detected value of the first detector 1761′ and the preset threshold.

In S1504, the running state of the electric motor assembly 20′ is switched according to the output capability of the battery pack 31′.

As shown in FIG. 67, as an alternative example, the controller 174′ determines the configured working mode of the power tool according to the physical quantity related to the running state of the electric motor assembly 20′. For example, the control circuit includes a second detector 1762′ configured to detect the physical quantity related to the operation of the electric motor assembly 20′. Optionally, the physical quantity related to the operation of the electric motor assembly 20′ includes electrical parameters of the first electric motor 21′ and/or the second electric motor 22′ and electrical parameters or physical parameters of circuit elements connected to the first electric motor 21′ and/or the second electric motor 22′. Optionally, the physical quantity related to the operation of the electric motor assembly 20′ includes physical quantities of the first electric motor 21′ and/or the second electric motor 22′ that can be detected by sensors or electronic elements, such as bus currents, phase currents, bus voltages, phase voltages, and commutation parameters. Optionally, the physical quantity related to the operation of the electric motor assembly 20′ includes physical quantities of the first electric motor 21′ and/or the second electric motor 22′ and/or the output shaft 30′ that can be detected by sensors or electronic elements, such as rotational speeds, angular velocities, accelerations, and angular accelerations. Optionally, the physical quantity related to the operation of the electric motor assembly 20′ includes temperatures, sounds, vibrations, and the like of the first electric motor 21′ and/or the second electric motor 22′. Optionally, the electrical parameters or physical parameters of the circuit elements connected to the first electric motor 21′ and/or the second electric motor 22′ include currents, voltages, temperatures, and vibrations of the switching elements and other capacitor or resistor elements in the driver circuit 175′. For example, the physical quantity related to the running state of the electric motor assembly 20′ includes a combination of one or more of the physical quantities disclosed above. For example, the physical quantity related to the running state of the electric motor assembly 20′ includes a combination of one or more of the physical quantities disclosed above with time.

For example, the controller 174′ determines the configured working mode of the power tool according to a relationship between a detected value of the second detector 1762′ and a preset threshold. A comparison between the detected value of the second detector 1762′ and the preset threshold includes a direct comparison between the detected value and a detected value threshold, a comparison between a detected value variation and a variation threshold, a comparison between a result value after a unary/binary/n-ary calculation on the detected value and a result value threshold, and a comparison between a result value variation and a corresponding threshold. Optionally, the detected value of the second detector 1762′ is a current, and the controller 174′ may determine the configured working mode of the power tool based on a comparison between a current value and a current value threshold. Optionally, the detected value of the second detector 1762′ is the current, and the controller 174′ may determine the configured working mode of the power tool based on a comparison between a variation of current values detected twice or multiple times and a current variation threshold. Optionally, the detected value of the second detector 1762′ is the current, and the controller 174′ may determine the configured working mode of the power tool based on a comparison between an average of current values detected twice or multiple times and a current average threshold. Optionally, the detected value of the second detector 1762′ is the current, and the controller 174′ may determine the configured working mode of the power tool based on a comparison between a torque value or torque variation of the electric motor calculated using the current and a relevant threshold.

In this example, a load of the output shaft 30′ is determined according to the physical quantity related to the running state of the electric motor assembly 20′. For example, the controller 174′ determines the load of the output shaft 30′ according to a rotational speed and/or a current value of the output shaft 30′ and determines the configured working mode of the power tool according to the load of the output shaft 30′. For example, when the power tool is in an adaptive state, if the rotational speed of the output shaft 30′ is higher than a first set threshold and/or the current of the electric motor (the first electric motor 21′ and/or the second electric motor 22′) is lower than a first set threshold and/or a rotational speed variation of the output shaft 30′ is lower than a first set threshold, the output shaft 30′ is in a low load condition, and the controller 174′ determines that the power tool switches to and operates in the second working mode. If the rotational speed of the output shaft 30′ is lower than a second set threshold and/or the current of the electric motor (the first electric motor 21′ and/or the second electric motor 22′) is higher than a second set threshold and/or the rotational speed variation of the output shaft 30′ is higher than a second set threshold, the output shaft 30′ is in a high load condition, and the controller 174′ determines that the power tool switches to and operates in the first working mode. For the rotational speed, the first set threshold is not less than the second set threshold. For the current, the first set threshold is not greater than the second set threshold. For the rotational speed variation, the first set threshold is not lower than the second set threshold.

When the mode selection module 177′ of the controller 174′ determines that the power tool switches to and operates in the first working mode or the second working mode, the switching signal is used as the input instruction, and the controller 174′, in response to the switching signal, determines that the electric motor assembly 20′ operates in the state corresponding to the first working mode or the second working mode. Optionally, after the electric motor assembly 20′ enters a first working state or a second working state, the running states of the first electric motor and/or the second electric motor may be dynamically adjusted according to a detection result of the second detector 1762′. Optionally, when the mode selection module 177′ of the controller 174′ determines that the power tool switches to and operates in the first working mode or the second working mode, the controller 174′ calls the corresponding input instruction in response to the switching signal and, in response to the called input instruction, determines one or more groups of preset drive parameters corresponding to the input instruction and drives the electric motor assembly 20′ to operate in the state corresponding to the first working mode or the second working mode.

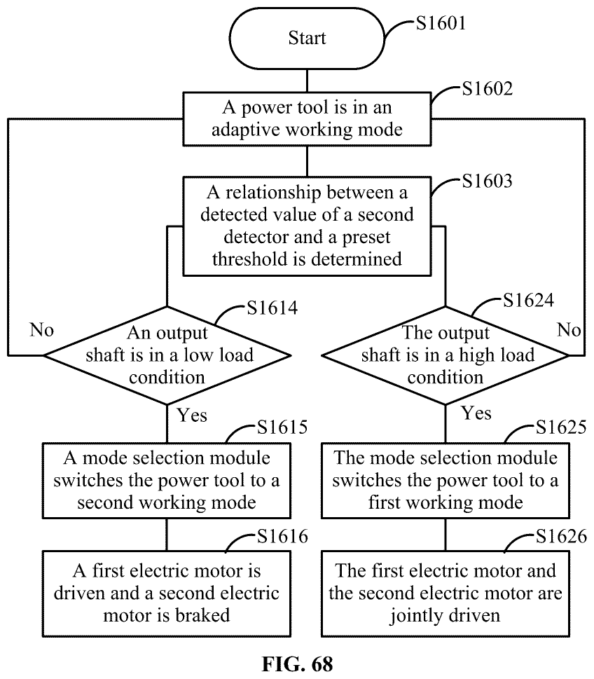

FIG. 68 shows a control method for the power tool, where the power tool switches between the working modes through electronic identification, the controller 174′ includes the mode selection module 177′, and the mode selection module 177′ determines the configured working mode of the power tool according to the physical quantity related to the running state of the electric motor assembly 20′. The method specifically includes the steps below.

In S1601, the flow starts.

In S1602, the power tool enters the adaptive working mode.

In S1603, the relationship between the detected value of the second detector 1762′ and the preset threshold is determined.

The second detector 1762′ detects the physical quantity related to the operation of the electric motor assembly 20′, and the controller 174′ determines the configured working mode of the power tool according to the relationship between the detected value of the second detector 1762′ and the preset threshold. The load of the output shaft 30′ is determined according to the physical quantity related to the running state of the electric motor assembly 20′.

In S1614, the output shaft 30′ is in the low load condition. If so, S1615 is performed. If not, S1602 is performed.

When the rotational speed of the output shaft 30′ is higher than the first set threshold and/or the current of the electric motor (the first electric motor 21′ and/or the second electric motor 22′) is lower than the first set threshold and/or the rotational speed variation of the output shaft 30′ is lower than the first set threshold, the output shaft 30′ is in the low load condition.

In S1615, the mode selection module 177′ switches the power tool to the second working mode.

In S1616, the first electric motor is driven and the second electric motor is braked.

The first electric motor is driven and the second electric motor is braked according to the drive parameters, and the drive parameters may be one or more groups of preset drive parameter data or may be drive parameter data dynamically adjusted according to the detection result of the second detector 1762′.

In S1624, the output shaft is in the high load condition. If so, S1625 is performed. If not, S1602 is performed.

When the rotational speed of the output shaft 30′ is lower than the second set threshold and/or the current of the electric motor (the first electric motor 21′ and/or the second electric motor 22′) is higher than the second set threshold and/or the rotational speed variation of the output shaft 30′ is higher than the second set threshold, the output shaft 30′ is in the high load condition.

In S1625, the mode selection module 177′ switches the power tool to the first working mode.

In S1626, the first electric motor and the second electric motor are jointly driven.

The first electric motor and the second electric motor are jointly driven according to the preset drive parameters, and the drive parameters may be one or more groups of preset drive parameter data or may be drive parameter data dynamically adjusted according to the detection result of the second detector 1762′.

In some examples, in the adaptive mode, the controller 174′ dynamically adjusts the running states of the first electric motor 21′ and the second electric motor 22′ according to the physical quantity related to the running state of the electric motor assembly 20′ and detected by the second detector 1762′. For example, the controller 174′ determines, according to the relationship between the detected value of the second detector 1762′ and the preset threshold, that the second electric motor 22′ is driven or on standby. The comparison between the detected value of the detector 176′ and the preset threshold includes the direct comparison between the detected value and the detected value threshold, the comparison between the detected value variation and the variation threshold, the comparison between the result value after the unary/binary/n-ary calculation on the detected value and the result value threshold, and the comparison between the result value variation and the corresponding threshold. For example, the physical quantity related to the operation of the electric motor assembly 20′ includes the physical quantities of the first electric motor 21′ and/or the second electric motor 22′ that can be detected by the sensors or the electronic elements, such as the bus currents, the phase currents, the bus voltages, the phase voltages, and the commutation parameters. Optionally, the physical quantity related to the operation of the electric motor assembly 20′ includes the physical quantities of the first electric motor 21′ and/or the second electric motor 22′ and/or the output shaft 30′ that can be detected by the sensors or the electronic elements, such as the rotational speeds, the angular velocities, the accelerations, and the angular accelerations. Optionally, the physical quantity related to the operation of the electric motor assembly 20′ includes the temperatures, the sounds, the vibrations, and the like of the first electric motor 21′ and/or the second electric motor 22′. Optionally, the electrical parameters or physical parameters of the circuit elements connected to the first electric motor 21′ and/or the second electric motor 22′ include the currents, the voltages, the temperatures, and the vibrations of the switching elements and other capacitor or resistor elements in the driver circuit 175′. For example, the physical quantity related to the running state of the electric motor assembly 20′ includes a combination of one or more of the physical quantities disclosed above. For example, the physical quantity related to the running state of the electric motor assembly 20′ includes a combination of one or more of the physical quantities disclosed above with time.

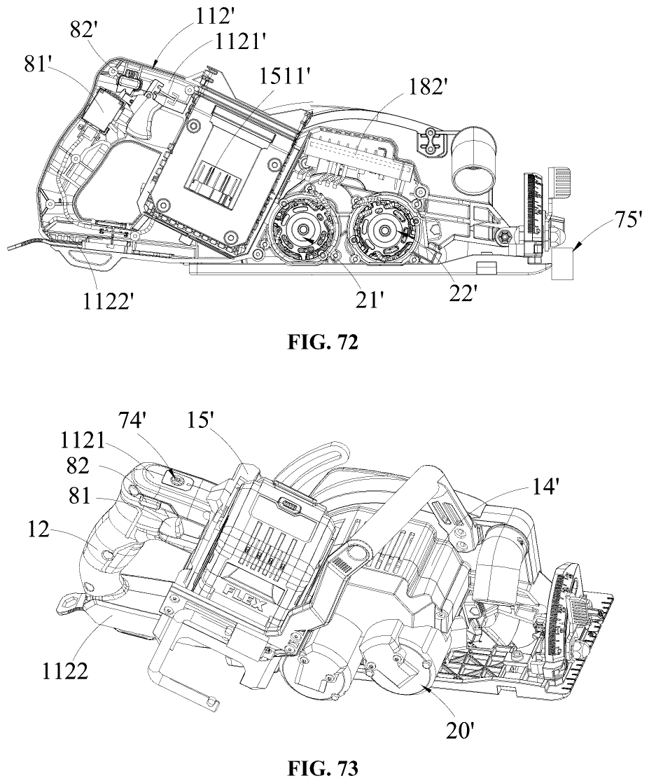

In some examples, as shown in FIG. 72, the power tool further includes a visual control system 75′ connected to the controller 174′. Before the power tool contacts a workpiece to be machined, the visual control system 75′ is configured to determine a working condition matching the workpiece and send a corresponding input instruction to the controller 174′, and the controller 174′ matches a corresponding working mode according to the input instruction. For example, a workpiece to be cut is a wooden board whose thickness exceeds a threshold, and the visual control system 75′ is disposed at a forward end of the power tool. The visual control system 75′ identifies that the thickness of the workpiece to be cut exceeds a standard and sends an input signal for configuring the power tool to work in the first working mode to the controller 174′, and the controller 174′ configures, according to the input signal, the power tool to prepare for working or enter a working state in the first working mode. In some examples, in the adaptive working mode, the controller 174′ dynamically adjusts the running states of the first electric motor 21′ and the second electric motor 22′ according to a condition of the workpiece to be cut that is detected by the visual control system. For example, the workpiece to be cut is the wooden board whose thickness exceeds the threshold. The visual control system identifies that the thickness of the workpiece to be cut exceeds the standard and sends a signal for configuring the electric motor assembly 20′ to work with the first electric motor 21′ and the second electric motor 22′ jointly driven to the controller 174′. For example, the workpiece to be cut is a wooden board whose thickness is less than the threshold. The visual control system 75′ identifies that the thickness of the workpiece to be cut is very thin and sends a signal for configuring the electric motor assembly 20′ to work with the first electric motor 21′ driven alone to the controller 174′.

For example, the visual control system 75′ includes a light source, a lens, a charge-coupled device (CCD) camera, an image processing unit (or image acquisition card), an image processing chip, a monitor, and a communication/input and output unit. The visual control system 75′ is the same as the technical solution disclosed in the related art. The visual control system has been fully disclosed to those skilled in the art, and thus a detailed description is omitted here for the sake of clarity.

As shown in FIGS. 21 to 34, the power transmission mechanism 40′ includes a transmission assembly 41′ disposed between the output shaft 30′ and at least one of the first electric motor 21′ or the second electric motor 22′. The transmission assembly 41′ includes at least a deceleration mechanism. A clutch assembly 42′ is disposed between the first electric motor 21′ and the second electric motor 22′, and the clutch assembly 42′ is configured to allow or not allow at least one of the first drive shaft 211′ or the second drive shaft 221′ to drive the output shaft 30′ under a preset condition. It is to be understood that the clutch assembly 42′ is disposed between the first electric motor 21′ and the second electric motor 22′. In one aspect, in terms of orientations, the clutch assembly 42′ at least partially overlaps any one of the first electric motor 21′ and the second electric motor 22′ in an axial direction of the drive shafts or at least partially overlaps any one of the first electric motor 21′ and the second electric motor 22′ in a radial direction of the drive shafts. In the other aspect, in terms of a connection relationship, the clutch assembly 42′ is directly or indirectly connected to the first electric motor 21′ and the second electric motor 22′ separately; or a direct or indirect power transmission path exists between the clutch assembly 42′ and the first electric motor 21′ and a direct or indirect power transmission path exists between the clutch assembly 42′ and the second electric motor 22′.

In this example, the clutch assembly 42′ includes a one-way clutch 421′. The one-way clutch 421′ is operable to connect the rotation of the first electric motor 21′ to the rotation of the second electric motor 22′ in a first direction of rotation and disconnect the rotation of the first electric motor 21′ from the rotation of the second electric motor 22′ in a second direction of rotation. Optionally, the clutch assembly 42′ is a one-way bearing or an overrunning clutch.

The second electric motor 22′ collaborates with the first electric motor 21′ through the one-way clutch 421′. When the first electric motor 21′ and the second electric motor 22′ rotate in the same direction, if the rotational speed of the second drive shaft 221′ of the second electric motor 22′ is lower than the rotational speed of the first drive shaft 211′ of the first electric motor 21′, the one-way clutch 421′ prevents the second drive shaft 221′ from driving the output shaft 30′. During an increase in the rotational speed of the second drive shaft 221′ of the second electric motor 22′, the one-way clutch is driven by a meshing force of the second electric motor until the one-way clutch meshes to allow the first drive shaft and the second drive shaft to jointly drive the output shaft. When the rotational speed of the second drive shaft 221′ of the second electric motor 22′ is higher than or equal to the rotational speed of the first drive shaft 211′ of the first electric motor 21′, the one-way clutch 421′ allows the second drive shaft 221′ to participate in driving the output shaft 30′. In a process from when the one-way clutch 421′ prevents the second drive shaft 221′ from driving the output shaft 30′ to when the one-way clutch 421′ allows the second drive shaft 221′ to drive the output shaft 30′, the rotational speed of the output shaft 30′ undergoes a process from being lower than the output rotational speed of the first electric motor 21′ to being greater than or equal to the output rotational speed of the first electric motor 21′. When the rotational speed of the first drive shaft 211′ of the first electric motor 21′ is equal to the rotational speed of the second drive shaft 221′ of the second electric motor 22′ for the first time, the one-way clutch 421′ hits to mesh and then outputs torque. However, the greater the meshing force of the second electric motor applied to the one-way clutch before the hit, the stronger the impulse of the hit on the one-way clutch. Moreover, the applicant has found that the meshing force of the second electric motor is affected by a difference between the rotational speed of the first drive shaft 211′ of the first electric motor 21′ and the rotational speed of the second drive shaft 221′ of the second electric motor 22′ when the one-way clutch meshes. The greater the difference between the rotational speed of the first drive shaft 211′ of the first electric motor 21′ and the rotational speed of the second drive shaft 221′ of the second electric motor 22′, that is to say, the faster the second drive shaft 221′ of the second electric motor 22′ rotates, the greater the meshing force of the second drive shaft 221′, the stronger the impulse of the hit on the one-way clutch, and the faster a service life of the clutch decays.

In this example, the controller 174′ is configured to drive the first drive shaft 211′ of the first electric motor 21′ to rotate at a first rotational speed and when a second rotational speed of the second drive shaft 221′ of the second electric motor 22′ is lower than the first rotational speed, adjust a drive force parameter affecting the meshing force of the second electric motor 22′ on the clutch assembly 42′ according to a difference between the second rotational speed and the first rotational speed. In this example, the drive force parameter of the second electric motor 22′ includes the rotational speed of the second drive shaft 221′, the acceleration of the second drive shaft 221′, the angular velocity of the second drive shaft 221′, the angular acceleration of the second drive shaft 221′, the torque of the second drive shaft 221′, the current of the second electric motor 22′, the voltage of the second electric motor 22′, commutation data of the second electric motor 22′, and values after unary/binary/n-ary calculations of the above data.

In this example, the drive force parameter affecting the meshing force of the second electric motor 22′ on the clutch assembly 42′ is adjusted according to the difference between the second rotational speed and the first rotational speed, so as to adjust a hit force when the clutch meshes and increase the service life of the clutch.

In this example, when the difference between the second rotational speed and the first rotational speed is greater than or equal to a preset difference, the second electric motor 22′ increases the rotational speed according to a first drive force parameter corresponding to a first meshing force. When the difference between the second rotational speed and the first rotational speed is less than the preset difference, the second electric motor 22′ increases the rotational speed according to a second drive force parameter corresponding to a second meshing force, where the second meshing force is smaller than the first meshing force. In this example, when the difference between the rotational speed of the first drive shaft 211′ of the first electric motor 21′ and the rotational speed of the second drive shaft 221′ of the second electric motor 22′ is greater than the preset difference, the second electric motor 22′ is driven with the larger first meshing force to rapidly increase the speed and reduce the rotational speed difference between the first electric motor 21′ and the second electric motor 22′. When the difference between the rotational speed of the first drive shaft 211′ of the first electric motor 21′ and the rotational speed of the second drive shaft 221′ of the second electric motor 22′ is less than or equal to the preset difference, the rotational speed of the second electric motor 22′ is close to the rotational speed of the first electric motor 21′, the one-way clutch 421′ is about to mesh, and the meshing force of the second electric motor 22′ is reduced, thereby reducing the hit force on the one-way clutch 421′ during meshing, protecting the one-way clutch 421′, and extending the service life of the one-way clutch 421′. The second electric motor 22′ is gently started so that the instantaneous noise and vibration when the second electric motor 22′ participates in driving can be reduced.

In this example, the drive force parameter is the acceleration of the second drive shaft 221′ of the second electric motor 22′, for example, and the acceleration of the second electric motor 22′ is adjusted according to the difference between the second rotational speed and the first rotational speed. The acceleration of the second electric motor 22′ is adjusted so that the speed increase rate of the second electric motor 22′ is reduced, and the meshing force of the second electric motor 22′ is reduced.

In this example, when the difference between the second rotational speed and the first rotational speed is greater than or equal to the preset difference, the second electric motor 22′ increases the rotational speed according to a first acceleration. When the difference between the second rotational speed and the first rotational speed is less than the preset difference, the second electric motor 22′ increases the rotational speed according to a second acceleration, where the second acceleration is less than the first acceleration. In this example, when the difference between the rotational speed of the first drive shaft 211′ of the first electric motor 21′ and the rotational speed of the second drive shaft 221′ of the second electric motor 22′ is greater than the preset difference, the second electric motor 22′ has the larger acceleration to rapidly increase the speed and reduce the rotational speed difference between the first electric motor 21′ and the second electric motor 22′. When the difference between the rotational speed of the first drive shaft 211′ of the first electric motor 21′ and the rotational speed of the second drive shaft 221′ of the second electric motor 22′ is less than or equal to the preset difference, the rotational speed of the second electric motor 22′ is close to the rotational speed of the first electric motor 21′, the one-way clutch 421′ is about to mesh, and the acceleration of the second electric motor 22′ is reduced so that the speed increase rate of the second electric motor 22′ is reduced, thereby reducing the hit force on the one-way clutch 421′ during meshing, protecting the one-way clutch 421′, and extending the service life of the one-way clutch 421′.

In this example, the second electric motor 22′ increases the rotational speed so that the clutch assembly 42′ allows the first drive shaft 211′ and the second drive shaft 221′ to jointly drive the output shaft 30′. For example, the second electric motor 22′ increases the rotational speed according to the second acceleration so that the second rotational speed is equal to the first rotational speed. When the clutch assembly 42′ allows the first drive shaft 211′ and the second drive shaft 221′ to drive the output shaft 30′, the clutch assembly 42′, such as the one-way clutch 421′, has completed the meshing, and the second rotational speed of the second electric motor 22′ is higher than or equal to the first rotational speed of the first electric motor 21′ according to an actual working condition of the product and a preset parameter setting.

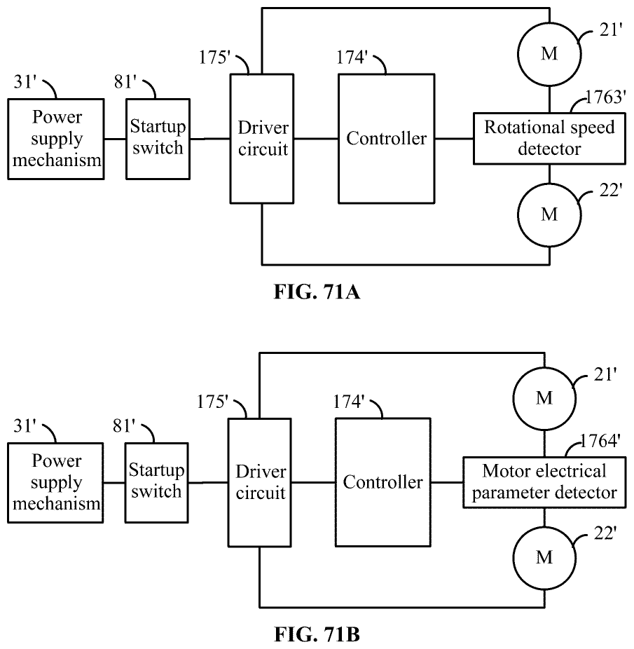

For example, as shown in FIG. 71A, the power tool further includes a rotational speed detector 1763′ configured to detect values related to the rotational speed of the first drive shaft 211′ of the first electric motor 21′ and the rotational speed of the second drive shaft 221′ of the second electric motor 22′. For example, a value related to the rotational speed includes a rotational speed value, a rotational speed variation, a result value after a unary/binary/n-ary calculation of a detected value, or a result value variation. For example, the rotational speed detector 1763′ is a position sensor that detects the rotational speed of the first drive shaft 211′ and/or the rotational speed of the second drive shaft 221′. For example, the rotational speed detector 1763′ detects the angular velocities, accelerations, or angular accelerations of the first drive shaft 211′ and/or the second drive shaft 221′ to calculate the rotational speed of the first drive shaft 211′ and/or the rotational speed of the second drive shaft 221′. Optionally, the rotational speed detector 1763′ includes the position sensor, which may specifically be a photodiode sensor, a magnetic sensor, or a potentiometer. Alternatively, the rotational speed detector 1763′ may be a rotation sensor, which is specifically a gyroscope sensor. The gyroscope sensor may be a single-axis, dual-axis, or three-axis microelectromechanical system (MEMS) sensor or a rotary sensor.

In some examples, as shown in FIG. 71B, the power tool further includes a motor electrical parameter detector 1764′ configured to detect the electrical parameters of the first electric motor 21′ and the second electric motor 22′ to characterize the rotational speed of the first drive shaft 211′ and the rotational speed of the second drive shaft 221′, where the electrical parameters include current-related parameters, voltage-related parameters, and commutation-related parameters. Optionally, the power tool includes the rotational speed detector 1763′ and the motor electrical parameter detector 1764′. That is to say, parameters of the first drive shaft 211′ of the first electric motor 21′ and parameters of the second drive shaft 221′ of the second electric motor 22′ of the power tool may be detected by the rotational speed detector 1763′ and the motor electrical parameter detector 1764′, separately.

In some alternative examples, the clutch assembly 42′ may be another mechanical clutch assembly. For example, the clutch assembly may include a dog clutch, a ratchet clutch, a centrifugal clutch, a differential, a friction clutch, or a hydrodynamic clutch. The preceding mechanical clutches in simple modifications or combinations may be used as the clutch assembly of the present application. On the premise that the function of the clutch assembly of the present application can be implemented, the specific form of structure does not affect the substantive content of the present application.

In some examples, the clutch assembly 42′ further includes an electronic clutch. For example, the clutch assembly includes an electromagnetic clutch. For example, the electromagnetic clutch may be a dry single-plate electromagnetic clutch, a dry multi-plate electromagnetic clutch, a wet multi-plate electromagnetic clutch, a magnetic particle clutch, or a slip electromagnetic clutch.

In some examples, the mechanical clutch assembly and the electronic clutch may be coupled, thereby allowing or not allowing at least one of the first drive shaft 211′ or the second drive shaft 221′ to drive the output shaft 30′ under the preset condition.

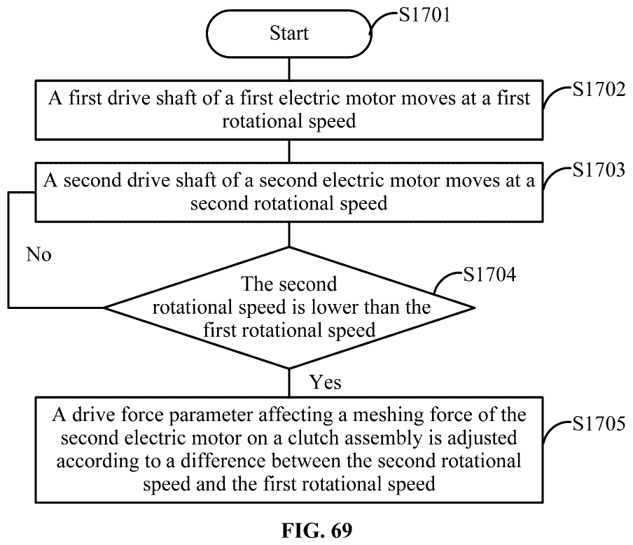

As shown in FIG. 69, a method for controlling the rotational speeds of the first electric motor and the second electric motor of the power tool includes the specific steps below.

In S1701, the flow starts.

In S1702, the first drive shaft 211′ of the first electric motor 21′ rotates at the first rotational speed.

In S1703, the second drive shaft 221′ of the second electric motor 22′ rotates at the second rotational speed.

In S1704, the second rotational speed is lower than the first rotational speed. If so, S1705 is performed. If not, S1703 is performed.

In S1705, the drive force parameter affecting the meshing force of the second electric motor on the clutch assembly is adjusted according to the difference between the second rotational speed and the first rotational speed.

The drive force parameter of the meshing force of the second electric motor 22′ is adjusted so that the hit force during the meshing of the clutch is adjusted to extend the service life of the clutch.

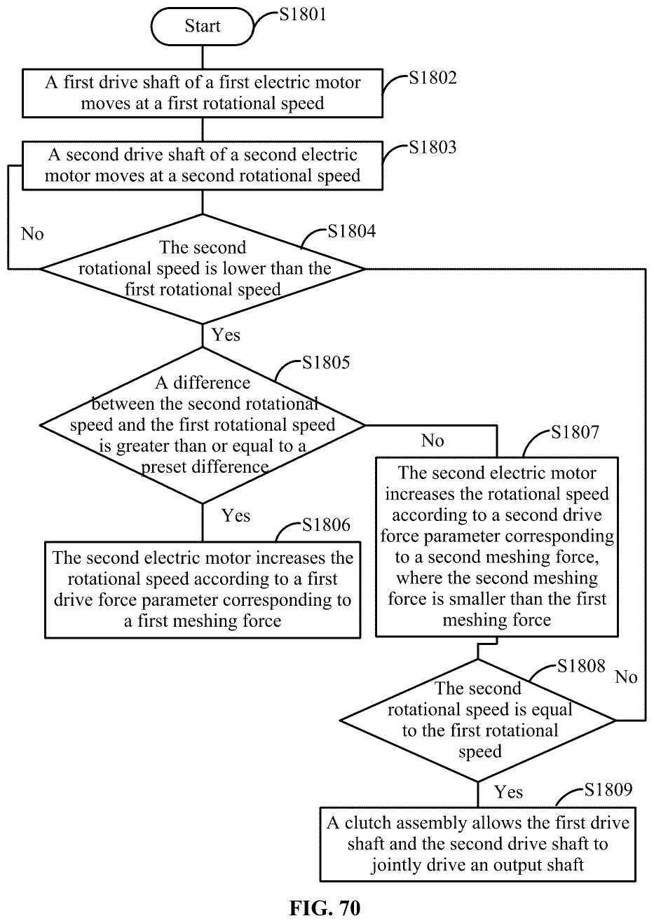

As shown in FIG. 70, another method for controlling the rotational speeds of the first electric motor and the second electric motor of the power tool includes the specific steps below.

In S1801, the flow starts.

In S1802, the first drive shaft 211′ of the first electric motor 21′ rotates at the first rotational speed.

In S1803, the second drive shaft 221′ of the second electric motor 22′ rotates at the second rotational speed.

In S1804, the second rotational speed is lower than the first rotational speed. If so, S1805 is performed. If not, S1803 is performed.

In S1805, the difference between the second rotational speed and the first rotational speed is greater than or equal to the preset difference. If so, S1806 is performed. If not, S1807 is performed.

In S1806, the second electric motor increases the rotational speed according to the first drive force parameter corresponding to the first meshing force.

In S1807, the second electric motor increases the rotational speed according to the second drive force parameter corresponding to the second meshing force, where the second meshing force is smaller than the first meshing force.

When the difference between the rotational speed of the first drive shaft 211′ of the first electric motor 21′ and the rotational speed of the second drive shaft 221′ of the second electric motor 22′ is greater than the preset difference, the second electric motor 22′ is driven with the larger first meshing force to rapidly increase the speed and reduce the rotational speed difference between the first electric motor 21′ and the second electric motor 22′. When the difference between the rotational speed of the first drive shaft 211′ of the first electric motor 21′ and the rotational speed of the second drive shaft 221′ of the second electric motor 22′ is less than or equal to the preset difference, the rotational speed of the second electric motor 22′ is close to the rotational speed of the first electric motor 21′, the one-way clutch 421′ is about to mesh, and the meshing force of the second electric motor 22′ is reduced, thereby reducing the hit force on the one-way clutch 421′ during meshing, protecting the one-way clutch 421′, and extending the service life of the one-way clutch 421′.

In S1808, the second rotational speed is equal to the first rotational speed. If so, S1809 is performed. If not, S1804 is performed.

In S1809, the clutch assembly allows the first drive shaft and the second drive shaft to jointly drive the output shaft.

The second electric motor 22′ increases the rotational speed according to the second acceleration so that the second rotational speed is equal to the first rotational speed. When the clutch assembly 42′ allows the first drive shaft 211′ and the second drive shaft 221′ to drive the output shaft 30′, the clutch assembly 42′, such as the one-way clutch 421′, has completed the meshing.

As shown in FIGS. 73 to 76, when the power tool switches between the working modes in the manual mode, the mode switching portion 73′ includes the switching element defined as the mode switching switch 74′, and the mode switching switch 74′ is connected to the controller 174′ and operated to send a signal for switching the working mode to the controller 174′. The power tool switches between at least the adaptive mode and the first working mode in the manual mode, and the user can actively switch the working mode according to usage habits and specific usage requirements. Compared with the automatic switching between the working modes through electronic identification, the manual switching provides the user with a stronger sense of operation and enables use in special working conditions, thereby making up for a lack of use manners of the product that only has the adaptive mode or that can only switch between single-motor and dual-motor working modes and providing richer working conditions.

In this example, the mode switching switch 74′ and a startup switch 81′ are different switching elements. That is to say, when the power tool switches between the working modes in the manual mode, the power tool is provided with the mode switching switch 74′ disposed separately so that the user can conveniently and intuitively operate the mode switching switch 74′. In some examples, the startup switch 81′ of the circular saw 100′ can be triggered only when a safety switch 82′ is pressed, while the mode switching switch 74′ is disposed separately and is not limited by the safety switch 82′. In some examples, the mode switching switch 74′ and the startup switch 81′ are different switching elements, the mode switching switch 74′ and the startup switch 81′ are disposed at different positions, and the mode switching switch 74′ and the startup switch 81′ are separately connected to the controller 174′.

In some examples, the mode switching switch 74′ is disposed on an outer wall surface of a body housing 11′. The body housing 11′ includes an accommodation housing 14′ configured to accommodate the first electric motor 21′ and the second electric motor 22′. It is to be understood that the accommodation housing 14′ accommodates the electric motor assembly 20′ and the accommodation housing 14′ accommodates the drive shafts of the electric motors.

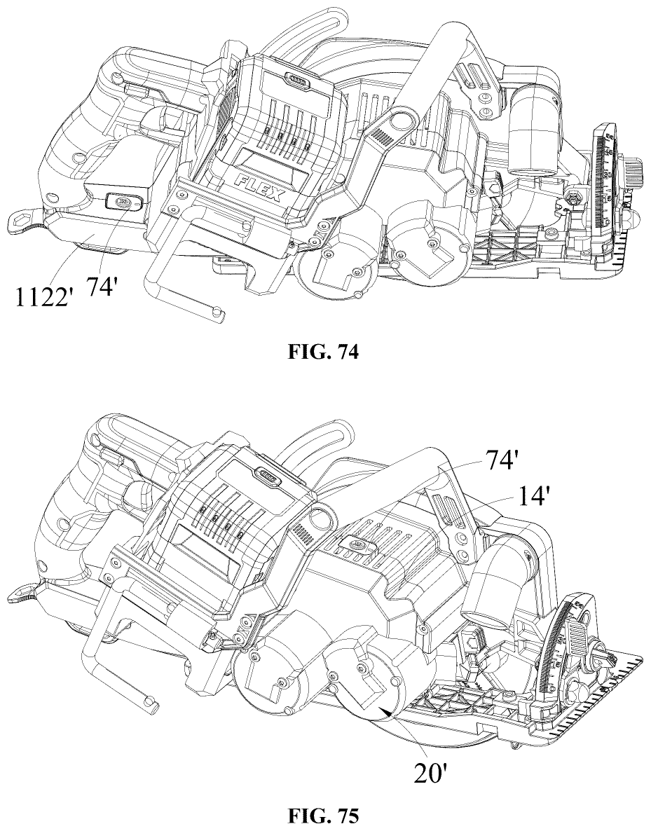

The body housing 11′ further includes a connection portion 112′ for connecting a grip 12′ to the accommodation housing 14′, the startup switch 81′ is located on the grip 12′, and the mode switching switch 74′ is located on the connection portion 112′ or the accommodation housing 14′. For example, as shown in FIG. 73, the connection portion 112′ includes an upper connection portion 1121′ connected between the upper end of the grip 12′ and the accommodation housing 14′, the upper connection portion 1121′ is close to the startup switch 81′, and the mode switching switch 74′ is disposed on the upper connection portion 1121′. Optionally, the mode switching switch 74′ is disposed on an upper surface or a side surface of the upper connection portion 1121′. Optionally, the mode switching switch 74′ is disposed at such a position that the mode switching switch 74′ and the startup switch 81′ can both be operated with a single hand. For example, as shown in FIG. 74, the connection portion 112′ includes a lower connection portion 1122′ connected between the lower end of the grip 12′ and the accommodation housing 14′, the lower connection portion 1122′ is close to a base plate 51′, and the mode switching switch 74′ is disposed on an upper surface or a side surface of the lower connection portion 1122′. This facilitates operations of the user and avoids accidental touch.

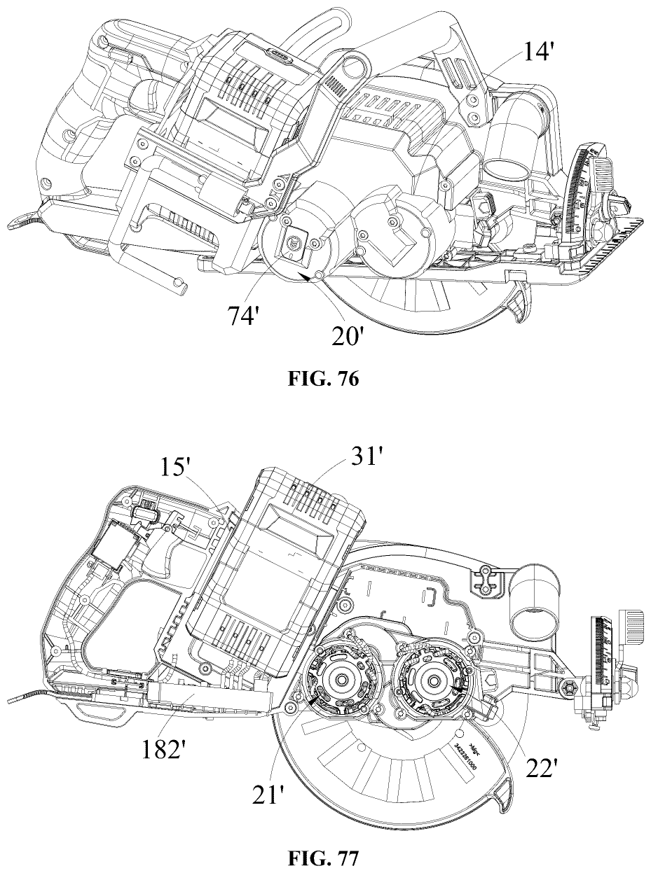

For example, the mode switching switch 74′ is disposed on an outer side surface of the accommodation housing 14′. For example, as shown in FIGS. 75 and 76, the accommodation housing 14′ surrounds the outer perimeter of stators of the electric motors, and the mode switching switch 74′ is disposed on an outer sidewall of the outer perimeter or an end of the stators of the electric motors. For example, the accommodation housing 14′ extends towards a fixed guard 62′ along an extension direction of the drive shafts of the electric motors, and the mode switching switch 74′ is disposed on an outer sidewall of the outer perimeter of the drive shafts of the electric motors 21′ and 22′.

In this example, as shown in FIG. 72, the battery pack 31′ is disposed between the electric motor assembly 20′ and the grip 12′ for holding so that the position of the center of gravity of the circular saw 100′ is in conformity with the operations of the user, and the circular saw 100′ can be stabilized during the operations. The body housing 11′ is provided with a semi-open battery accommodation compartment 15′ which is recessed inward. In this example, the accommodation housing 14′ is connected to the battery accommodation compartment 15′, the battery accommodation compartment 15′ is connected to the connection portion 112′, and the battery accommodation compartment 15′ and the electric motor assembly 20′ are disposed on the same side.

The battery accommodation compartment 15′ includes a coupling portion 1511′ electrically connected to the battery pack 31′, and the coupling portion 1511′ is provided with tool terminals. The tool terminals with the same structures (not shown in the figure) are provided on different power tools. For example, the first electric motor 21′, the second electric motor 22′, the battery pack 31′, and the grip 12′ are disposed on the same side of the cutting part 61′, and after the battery pack 31′ is inserted into the battery accommodation compartment 15′, the battery pack 31′ is at least partially disposed behind the first electric motor 21′ and the second electric motor 22′ and at least partially disposed in front of the grip 12′. Optionally, the battery pack 31′ is inserted obliquely into the battery accommodation compartment 15′. In some examples, the battery pack 31′ is partially located above the first electric motor 21′ and the second electric motor 22′.

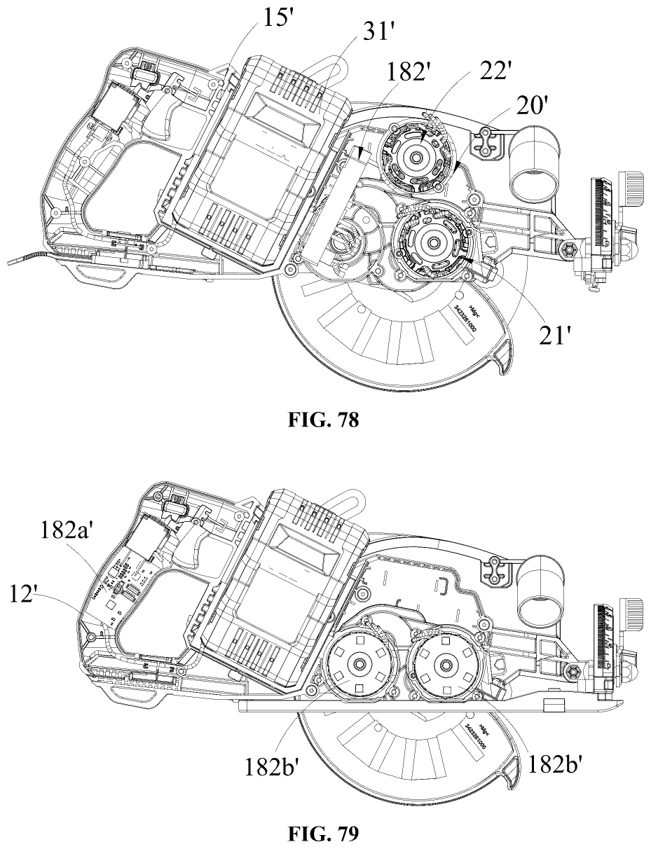

As shown in FIG. 77, the control circuit board 182′ is at least partially disposed below the battery pack 31′. For example, the control circuit board 182′ is at least partially disposed below the battery accommodation compartment 15′. The control circuit board 182′ is at least partially disposed on a radial outer side of the electric motor assembly 20′. Optionally, as shown in FIG. 72, the control circuit board 182′ is at least partially disposed on the upper side of the electric motor assembly 20′. Optionally, as shown in FIG. 78, the control circuit board 182′ is at least partially disposed between the electric motor assembly 20′ and the battery pack 31′. Optionally, the control circuit board 182′ is at least partially located between the electric motor assembly 20′ and the battery accommodation compartment 15′. As shown in FIG. 79, the control circuit board 182′ is at least partially disposed in the grip 12′. For example, multiple control circuit boards 182′ are provided, and at least part of the control circuit boards 182′ are disposed in housings at ends of the electric motors 21′ and 22′. Optionally, multiple control circuit boards 182′ are provided, one control circuit board 182a′ is disposed in the grip 12′, and the remaining control circuit boards 182b′ are disposed at an end of the first drive shaft 211′ of the first electric motor 21′ facing away from the cutting part and an end of the second drive shaft 221′ of the second electric motor 22′ facing away from the cutting part, respectively.

Arrangements of the first electric motor 21′ and the second electric motor 22′ in the electric motor assembly 20′ are described below. In this example, the first drive shaft 211′ of the first electric motor 21′ and the second drive shaft 221′ of the second electric motor 22′ are arranged along a radial direction of the first drive shaft 211′, that is to say, the first electric motor 21′ and the second electric motor 22′ are arranged non-coaxially. In some examples of this example, the first drive shaft 211′ and the second drive shaft 221′ are parallel and do not coincide. In this example, the first drive shaft 211′ and the second drive shaft 221′ are both parallel to the output shaft 30′. In some examples, as shown in FIG. 72, the first drive shaft 211′ and the second drive shaft 221′ are arranged along the front and rear direction.

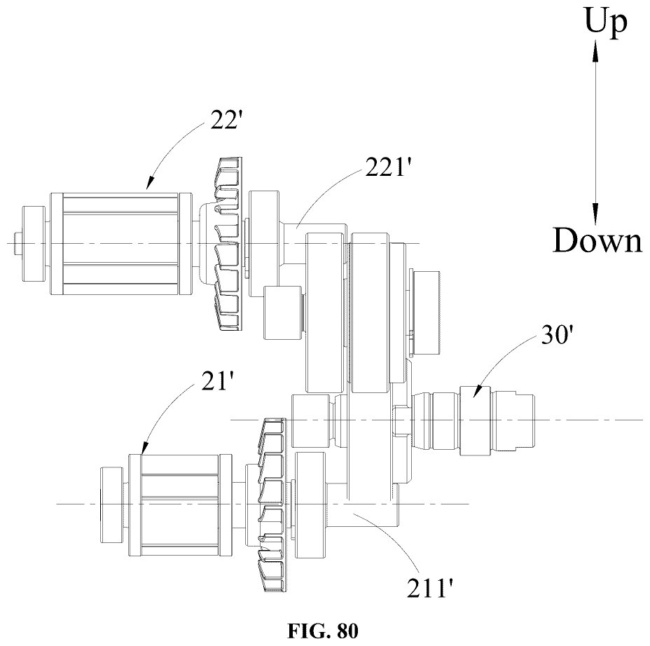

In some examples, as shown in FIGS. 78 and 80, the first drive shaft 211′ and the second drive shaft 221′ are arranged along the up and down direction, that is to say, the first electric motor 21′ is located above the second electric motor 22′ or the second electric motor 22′ is located above the first electric motor 21′.

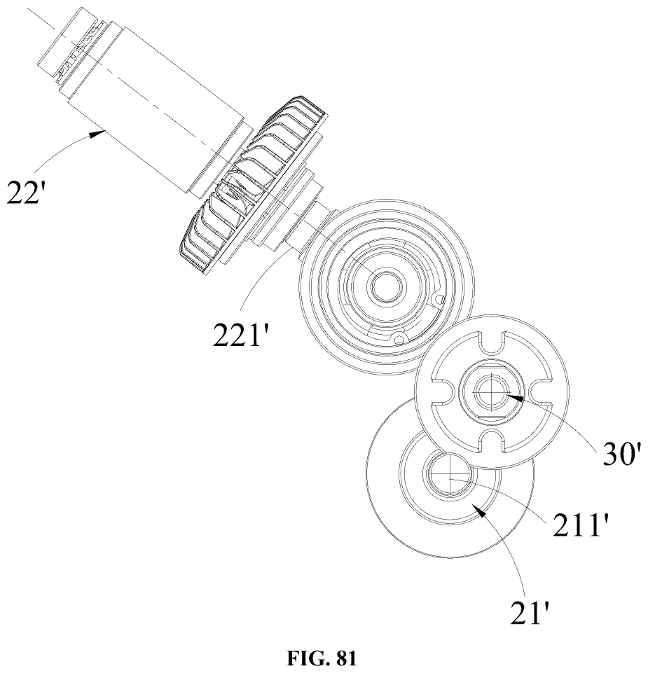

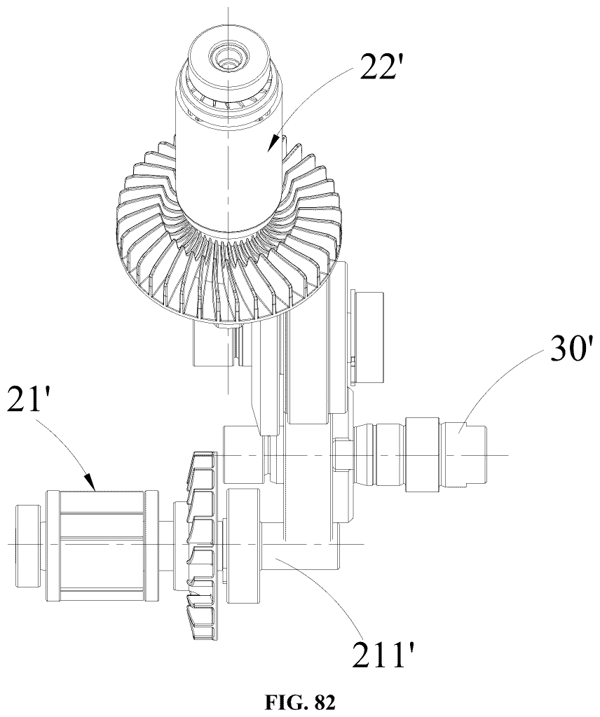

As shown in FIGS. 81 and 82, in some examples, the first drive shaft 211′ and the second drive shaft 221′ intersect or are perpendicular. For example, the first drive shaft 211′ and the second drive shaft 221′ are spatially perpendicular or spatially intersect. For example, when projections of the electric motor assembly 20′ are observed along the up and down direction, a projection of the first drive shaft 211′ intersects or is perpendicular to a projection of the second drive shaft 221′.

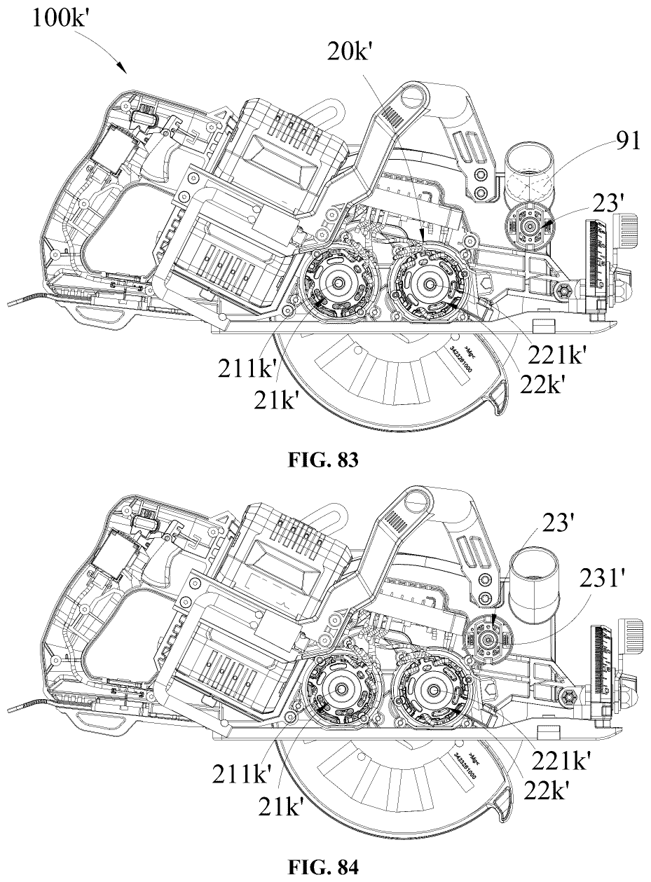

As shown in FIGS. 83 and 84, another example of the present application provides a circular saw 100k′ and differs from the first example in that an electric motor assembly 20k′ includes multiple electric motors. For example, the electric motor assembly 20k′ includes at least a first electric motor 21k′ and a second electric motor 22k′, and torque of a first drive shaft 211k′ and torque of a second drive shaft 221k′ are output through an output shaft 30k′. The electric motor assembly 20k′ further includes the third electric motor 23′ configured to power components other than the output shaft 30k′. In some examples, as shown in FIG. 83, the circular saw 100k′ further includes a dust suction fan 91, and the third electric motor 23′ drives the dust suction fan 91 to rotate, so as to generate a suction force and perform dust collection.

In some examples, the electric motor assembly 20k′ further includes a first fan 216′ and a second fan 226′. The first fan 216′ is supported by the first drive shaft 211k′ and driven by the first electric motor 21k′ to rotate and generate a cooling airflow. The second fan 226′ is supported by the second drive shaft 221k′ and driven by the second electric motor 22k′ to rotate and generate a cooling airflow. An auxiliary cooling fan is further included, and the third electric motor 23′ drives the auxiliary cooling fan (not shown) to rotate to generate a wind for heat dissipation of the electric motor assembly 20k′ and/or the controller 174′, thereby improving the heat dissipation efficiency of the electric motors. In some examples, the first drive shaft 211k′ of the first electric motor 21k′ and a third drive shaft 231 of the third electric motor 23′ are arranged along the radial direction of the first drive shaft 211k′, that is to say, the first electric motor 21k′ and the third electric motor 23′ are arranged non-coaxially. In some examples of this example, the first drive shaft 211k′ and the third drive shaft 231′ are parallel and do not coincide. In this example, the first drive shaft 211k′ and the second drive shaft 221k′ are both parallel to the third drive shaft 231′. In some examples, the first drive shaft 211k′ and the third drive shaft 231′ are arranged along the left and right direction. In some examples, the first drive shaft 211k′ and the third drive shaft 231′ are arranged along the up and down direction, that is to say, the first electric motor 21k′ is located above the third electric motor 23′ or the third electric motor 23′ is located above the first electric motor 21k′. In some examples, the first drive shaft 211k′ and the third drive shaft 231′ intersect or are perpendicular. For example, the first drive shaft 211k′ and the third drive shaft 231′ are spatially perpendicular or spatially intersect. For example, when projections of the electric motor assembly 20k′ are observed along the up and down direction, a projection of the first drive shaft 211k′ intersects or is perpendicular to a projection of the third drive shaft 231′.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A power tool, comprising:
an output shaft configured to output torque and rotating about an output axis;
an electric motor assembly comprising at least a first electric motor and a second electric motor, wherein the first electric motor comprises a first drive shaft rotating about a first axis, the second electric motor comprises a second drive shaft rotating about a second axis, and torque of the first drive shaft and torque of the second drive shaft is output through the output shaft;
a power supply configured to supply operating power to the electric motor assembly; and
a controller configured to control operation of the electric motor assembly;
wherein the power tool comprises switchable working modes, and the working modes comprise:
an adaptive mode, in which the controller switches a running state of the electric motor assembly according to an identification result of a detector, wherein the running state of the electric motor assembly comprises that only the first electric motor or only the second electric motor is driven or that the first electric motor and the second electric motor are jointly driven; and
a first working mode, in which the controller makes the first electric motor and the second electric motor jointly driven in response to an input instruction.

2. The power tool according to claim 1, wherein the working modes further comprise a second working mode, in which the controller drives the first electric motor and brakes the second electric motor in response to an input instruction.

3. The power tool according to claim 2, further comprising a mode switching portion that receives a switching instruction input by a user and sends a signal for executing the adaptive mode, the first working mode, or the second working mode.

4. The power tool according to claim 3, wherein the mode switching portion comprises a switching element that receives the switching instruction input by the user, and the switching element comprises at least one of a mechanical switch or an electronic switch.

5. The power tool according to claim 4, further comprising a startup switch configured to be operated so that the electric motor assembly is energized, wherein the mode switching portion and the startup switch are different switching elements.

6. The power tool according to claim 2, wherein the controller further comprises a mode selection module that automatically switches a configured working mode of the power tool according to a parameter identification result.

7. The power tool according to claim 6, wherein the mode selection module determines a load of the output shaft according to a physical quantity related to the running state of the electric motor assembly, and the controller determines running states of the first electric motor and the second electric motor according to the load of the output shaft.

8. The power tool according to claim 6, wherein the power supply comprises a battery pack, and the mode selection module determines a configured working mode of the power tool according to a physical quantity related to a running state of the battery pack.

9. The power tool according to claim 8, wherein when the battery pack is determined to have a high output capability according to the physical quantity related to the running state of the battery pack, the controller determines that the power tool operates in the first working mode.

10. The power tool according to claim 8, wherein when the battery pack is determined to have a medium output capability according to the physical quantity related to the running state of the battery pack, the controller determines that the power tool operates in the adaptive mode.

11. The power tool according to claim 8, wherein when the battery pack is determined to have a low output capability according to the physical quantity related to the running state of the battery pack, the controller determines that the power tool operates in the second working mode.

12. The power tool according to claim 2, wherein the power supply comprises a battery pack, and the controller determines, according to a physical quantity related to a running state of the battery pack, whether to respond to a configuration signal of a working mode of the power tool.

13. The power tool according to claim 12, wherein when the battery pack is determined to have a low output capability according to the physical quantity related to the running state of the battery pack, the controller responds only to a configuration signal of the second working mode.

14. The power tool according to claim 12, wherein when the battery pack is determined to have a medium output capability according to the physical quantity related to the running state of the battery pack, the controller do not respond to a configuration signal of the first working mode.

15. The power tool according to claim 12, wherein the configuration signal comprises a working mode configuration signal generated according to a switching instruction manually input by a user and a working mode configuration signal determined by the controller after identification of a preset physical quantity.

16. A power tool, comprising:
an output shaft configured to output torque and rotating about an output axis;
an electric motor assembly comprising a plurality of electric motors with drive shafts, wherein torque of a plurality of drive shafts is output through the output shaft; and
a controller configured to control operation of the electric motor assembly;
wherein the power tool comprises different working modes, and the working modes comprise:
an adaptive mode, in which the controller switches a running state of the electric motor assembly according to an identification result of a detector, wherein the running state of the electric motor assembly comprises that one or some of the plurality of electric motors are driven or that all the plurality of electric motors are jointly driven; and
a selected mode, in which the controller responds to an input instruction and determines operation of a selected electric motor corresponding to the input instruction according to the input instruction.

17. A power tool, comprising:
an output shaft configured to output torque and rotating about an output axis;
an electric motor assembly comprising at least a first electric motor and a second electric motor, wherein the first electric motor comprises a first drive shaft rotating about a first axis, the second electric motor comprises a second drive shaft rotating about a second axis, and torque of the first drive shaft and torque of the second drive shaft is output through the output shaft; and
a controller configured to control operation of the electric motor assembly;
wherein the power tool comprises switchable working modes, and the working modes comprise:
an adaptive mode, in which the controller dynamically adjusts a running state of the electric motor assembly according to an identification result of a detector; and
a selected mode, in which the controller responds to an input instruction and determines operation of a selected electric motor corresponding to the input instruction according to the input instruction.

18. The power tool according to claim 17, further comprising a driver circuit disposed between a power supply and the electric motor assembly, configured to drive the electric motor assembly, and comprising a plurality of switching elements.

19. The power tool according to claim 18, wherein the selected mode comprises:
a first working mode, in which the controller makes the first electric motor and the second electric motor jointly driven in response to the input instruction; and
a second working mode, in which the controller drives the first electric motor and brakes the second electric motor in response to the input instruction.

20. The power tool according to claim 19, wherein when the second electric motor is in a braked state, the driver circuit connected to the second electric motor is in a non-conductive state, and power of the power supply is not supplied to the second electric motor.
